(19) United States
(12) Patent Application Publication
(10) Pub. No.: US 2021/0104232 A1
(43) Pub. Date: Apr. 8, 2021

(54) ELECTRONIC DEVICE FOR PROCESSING USER UTTERANCE AND METHOD OF OPERATING SAME

(71) Applicant: Samsung Electronics Co., Ltd., Suwon-si (KR)

(72) Inventors: Yoonju LEE, Suwon-si (KR); Taegu KIM, Suwon-si (KR); Hyeonjae BAK, Suwon-si (KR); Gajin SONG, Suwon-si (KR); Jaeyung YEO, Suwon-si (KR)

(21) Appl. No.: 17/061,532

(22) Filed: Oct. 1, 2020

(30) Foreign Application Priority Data
Oct. 7, 2019 (KR) 10-2019-0124028
Jun. 4, 2020 (KR) 10-2020-0067444

(51) Int. Cl. G10L 15/16; G10L 25/30; G06F 3/16; G06N 3/08

(52) U.S. Cl. CPC G10L 15/16; G06N 3/08; G06F 3/16; G10L 25/30

(57) ABSTRACT

An electronic device for analyzing a user utterance includes a microphone, a communication interface, a processor, and a memory. The processor is configured to acquire a first user utterance through the microphone. The processor is configured to identify a first task, based on analysis information of the first user utterance. The processor is configured to transmit a first request for first context information to at least one external electronic device through the communication interface. The processor is configured to perform the first task, based on the first context information acquired from a first external electronic device among the at least one external electronic device and the analysis information of the first user utterance.

### CROSS-REFERENCE TO RELATED APPLICATIONS

This application is based on and claims priority under 35 U.S.C. 119 to Korean Patent Application No. 10-2019-0124028 filed on Oct. 7, 2019, and Korean Patent Application No. 10-2020-0067444 filed on Jun. 4, 2020 in the Korean Intellectual Property Office, the disclosures of which are herein incorporated by reference in their entirety.

### BACKGROUND

### 1. Field

The disclosure relates to a method and an apparatus for processing a user utterance on the basis of context information acquired from an external electronic device.

### 2. Description of Related Art

Portable digital communication devices have become essential to many people in modern times. Consumers want to receive various desired high-quality services anywhere and at any time through portable digital communication devices.

A voice recognition service is a service that provides consumers with various content services in response to a user voice received on the basis of a voice recognition interface implemented in portable digital communication devices. In order to provide the voice recognition service, the portable digital communication devices realizes technologies of recognizing and analyzing human languages (for example, automatic voice recognition, natural language understanding, natural language creation, machine translation, dialogue system, question and answer, and voice recognition/synthesis).

### SUMMARY

It is required to implement a technology for accurately identifying a user intent and a technology for providing a suitable content service corresponding to the identified user intent on the basis of a user voice in order to provide a high-quality voice recognition service to consumers.

When an electronic device acquires a user utterance from a user, the electronic device performs a task corresponding to the user utterance on the basis of context information associated with the acquired user utterance among context information associated with previous user utterances stored in a memory of the electronic device. Further, when the electronic device acquires a user utterance from the user, the electronic device acquires context information associated with the user utterance from a server that acquires context information from a plurality of electronic devices and manages the same and then performs a task corresponding to the user utterance on the basis of the acquired context information. In the state in which a follow-up user utterance is processed using context information stored in the electronic device, when the user makes a request for processing the follow-up user utterance to another electronic device while the user utterance is processed through the electronic device, another electronic device has difficulty in performing a task corresponding to the follow-up user utterance since there is no context information associated with a previous user utterance. Further, in the state in which a next user utterance is processed using context information acquired from a server, when the user makes a request for processing the follow-up user utterance to another electronic device while the user utterance is processed through the electronic device, the performance of the server should be excellent since the server should search for and analyze, in real time, context information associated with a previous user utterance and transmit the context information to another electronic device.

Various embodiments may provide an electronic device for selecting an external electronic device to make a request for context information on the basis of voice assistant session information acquired from at least one external electronic device, directly acquiring context information from the selected external electronic device, and performing a task corresponding to a user utterance on the basis of the context information.

In accordance with an aspect of the disclosure, an electronic device for analyzing a user utterance is provided. The electronic device includes: a microphone; a communication interface; a processor operatively connected to the microphone and the communication interface; and a memory operatively connected to the processor, wherein the memory stores instructions configured to cause the processor to, when executed, acquire a first user utterance through the microphone, identify a first task, based on analysis information of the first user utterance, transmit a first request for first context information to at least one external electronic device through the communication interface, and perform the first task, based on the first context information acquired from a first external electronic device among the at least one external electronic device and the analysis information of the first user utterance.

In accordance with another aspect of the disclosure, a method of processing a user utterance by an electronic device is provided. The method includes: acquiring a first user utterance through a microphone; identifying a first task, based on analysis information of the first user utterance; transmitting a first request for first context information to at least one external electronic device through the communication interface; and performing the first task, based on the first context information acquired from a first external electronic device among the at least one external electronic device and the analysis information of the first user utterance.

According to various embodiments, each of an electronic device and at least one external electronic device may be provided as a device in the on-device form for processing a user utterance, and the electronic device can process a follow-up user utterance of the user utterance processed by the external electronic device on the basis of context information directly acquired from the external electronic device and perform a task corresponding to the processed user utterance.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an integrated intelligence system according to various embodiments;

FIG. 2 illustrates the form of relationship information between concepts and actions stored in a database according to various embodiments;

FIG. 3 illustrates a user terminal displaying a screen for processing a voice input received through the intelligent app according to various embodiments;

FIG. 4 illustrates a block diagram of a memory included in the user terminal in the on-device form for processing a user utterance according to various embodiments;

FIG. 5 illustrates a flowchart of a method by which the electronic device performs a first task corresponding to a first user utterance according to various embodiments;

FIG. 6 illustrates an embodiment in which the electronic device analyzes a first user utterance on the basis of first context information acquired from a first external electronic device and performs a first task corresponding to the first user utterance according to various embodiments;

FIG. 7A illustrates a flowchart of a method by which the electronic device analyzes a first user utterance on the basis of first context information and performs a first task corresponding to the first user utterance according to various embodiments;

FIG. 7B illustrates a flowchart of a method by which the electronic device transmits second context information to a second external electronic device according to various embodiments;

FIG. 8 illustrates a first embodiment in which the electronic device performs a first task corresponding to a first user utterance according to various embodiments;

FIG. 9 illustrates a second embodiment in which the electronic device performs a first task corresponding to a first user utterance according to various embodiments;

FIG. 10A illustrates a third embodiment in which the electronic device performs a first task corresponding to a first user utterance according to various embodiments;

FIG. 10B illustrates an embodiment in which the electronic device performs a first task corresponding to a first user utterance and an additional task according to various embodiments;

FIG. 11A illustrates a of illustrating a method by which the electronic device analyzes a first user utterance on the basis of context information acquired from a plurality of external electronic devices and performs a first task corresponding to the first user utterance according to various embodiments;

FIG. 11B illustrates an embodiment in which the electronic device transmits a request for context information and acquires context information from a plurality of external electronic devices according to various embodiments;

FIG. 12A illustrates a flowchart of a method by which the electronic device analyzes a first user utterance on the basis of first context information acquired from a first external electronic device and performs a first task corresponding to the first user utterance according to various embodiments;

FIG. 12B illustrates an embodiment in which the electronic device transmits a request for context information and acquires first context information from a first external electronic device;

FIG. 13A illustrates a flowchart of a method by which the electronic device identifies whether first context information associated with a first user utterance exists in the electronic device according to various embodiments;

FIG. 13B illustrates a fourth embodiment in which the electronic device performs a first task corresponding to a first user utterance according to various embodiments;

FIG. 13C illustrates a fifth embodiment in which the electronic device performs a first task corresponding to a first user utterance according to various embodiments;

FIG. 14 illustrates a flowchart of a method by which the electronic device analyzes a user utterance on the basis of context information acquired from an external electronic device establishing a short-range wireless communication connection and performs a task corresponding to the user utterance according to various embodiments;

FIG. 15 illustrates a flowchart of a method by which the electronic device analyzes a first user utterance on the basis of first context information including context history information and performs a first task corresponding to the first user utterance according to various embodiments;

FIG. 16 illustrates an embodiment in which the electronic device analyzes a first user utterance including first context history information and performs a first task corresponding to the first user utterance according to various embodiments;

FIG. 17 illustrates a flowchart of a method by which the electronic device analyzes a first user utterance on the basis of first context information according to various embodiments;

FIG. 18A illustrates a flowchart of a method by which the electronic device performs a first task corresponding to a first user utterance on the basis of a context sharing list of a server according to various embodiments;

FIG. 18B illustrates an embodiment in which the electronic device performs a first task corresponding to a first user utterance on the basis of a context sharing list of a server according to various embodiments;

FIG. 19A illustrates a flowchart of a method by which the electronic device performs a first task corresponding to a first user utterance on the basis of context information of a server according to various embodiments;

FIG. 19B illustrates an embodiment in which the electronic device performs a first task corresponding to a first user utterance on the basis of context information of a server according to various embodiments;

FIG. 20A illustrates a flowchart of a method by which the electronic device performs a first task corresponding to a first user utterance and domain configuration information on the basis of first context information according to various embodiments;

FIG. 20B illustrates an embodiment in which the electronic device performs a first task corresponding to a first user utterance and domain configuration information on the basis of first context information according to various embodiments;

FIG. 20C illustrates an embodiment in which the electronic device performs a first task corresponding to a first user utterance and domain configuration information on the basis of first context information according to various embodiments;

FIG. 21A illustrates a flowchart of a method by which the electronic device performs a first task on the basis of analysis information of a first user utterance and first context information according to various embodiments;

FIG. 21B illustrates an embodiment in which the electronic device performs a first task on the basis of analysis information of a first user utterance and first context information according to various embodiments;

FIG. 21C illustrates an embodiment in which the electronic device performs a first task on the basis of analysis information of a first user utterance and first context information according to various embodiments;

FIG. 22 illustrates a flowchart of a method by which the electronic device provides information on an external electronic device capable of performing a first task corresponding to a first user utterance on the basis of first context information according to various embodiments;

FIG. 23 illustrates a flowchart of a method by which the electronic device performs a plurality of tasks corresponding to a first user utterance on the basis of at least two pieces of first context information according to various embodiments;

FIG. 24A illustrates an embodiment in which the electronic device provides divided information received from external electronic devices according to various embodiments;

FIG. 24B illustrates an embodiment in which the electronic device provides divided information received from external electronic devices according to various embodiments;

FIG. 24C illustrates an embodiment in which the electronic device provides divided information received from external electronic devices according to various embodiments;

FIG. 24D illustrates an embodiment in which the electronic device provides divided information received from external electronic devices according to various embodiments; and

FIG. 25 illustrates a block diagram of an electronic device within a network environment according to various embodiments.

### DETAILED DESCRIPTION

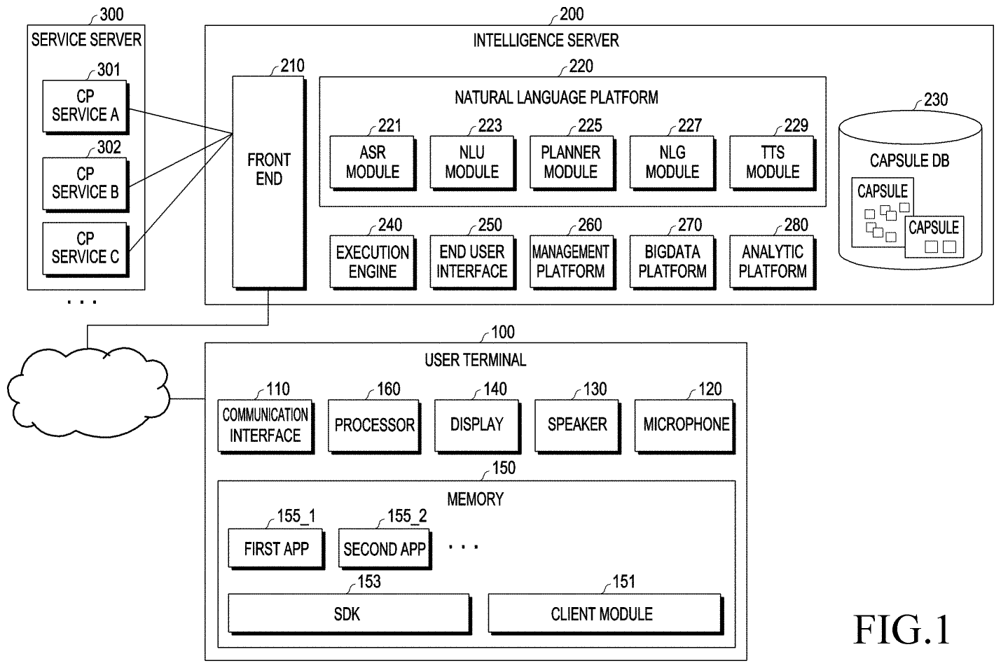

FIGS. 1 through 25, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 illustrates a block diagram of an integrated intelligence system according to an embodiment.

Referring to FIG. 1, an integrated intelligence system 10 according to an embodiment may include a user terminal 100, an intelligent server 200, and a service server 300.

The user terminal 100 according to an embodiment may be a terminal device (or an electronic device) capable of being connected to the Internet, and may include, for example, a mobile phone, a smart phone, a personal digital assistant (PDA), a notebook computer, a TV, white goods, a wearable device, an HMD, or a smart speaker.

According to the embodiment, the user terminal 100 may include a communication interface 110, a microphone 120, a speaker 130, a display 140, a memory 150, or a processor 160. The listed elements may be operatively or electrically connected to each other.

The communication interface 110 according to an embodiment may be connected to an external device and configured to transmit and receive data. The microphone 120 according to an embodiment may receive a sound (for example, a user utterance) and convert the same into an electrical signal. The speaker 130 according to an embodiment may output the electrical signal in the form of a sound (for example, voice). The display 140 according to an embodiment may be configured to display an image or a video. The display 140 according to an embodiment may display a graphic user interface (GUI) of an executed app (or application).

The memory 150 according to an embodiment may store a client module 151, a software development kit (SDK) 153, and a plurality of apps 155. The client module 151 and the SDK 153 may configure a framework (or a solution program) for performing a universal function. Further, the client module 151 or the SDK 153 may configure a framework for processing a voice input.

The plurality of apps 155 according to an embodiment may be programs for performing a predetermined function. According to an embodiment, the plurality of apps 155 may include a first app 155_1 and a second app 155_3. According to an embodiment, each of the plurality of apps 155 may include a plurality of operations for performing predetermined functions. For example, the apps may include an alarm app, a message app, and/or a schedule app. According to an embodiment, the plurality of apps 155 may be executed by the processor 160 so as to sequentially perform at least some of the plurality of operations.

The processor 160 according to an embodiment may control the overall operation of the user terminal 100. For example, the processor 160 may be electrically connected to the communication interface 110, the microphone 120, the speaker 130, and the display 140 and may perform predetermined operations.

The processor 160 according to an embodiment may perform a predetermined function by executing a program stored in the memory 150. For example, the processor 160 may perform the following operation for processing a voice input by executing at least one of the client module 151 or the SDK 153. The processor 160 may control, for example, the operation of the plurality of apps 155 through the SDK 153. The following operation which is the operation of the client module 151 or the SDK 153 may be performed by the processor 160.

The client module 151 according to an embodiment may receive a voice input. For example, the client module 151 may receive a voice signal corresponding to a user speech detected through the microphone 120. The client module 151 may transmit the received voice input to the intelligent server 200. The client module 151 may transmit state information of the user terminal 100 along with the received voice input to the intelligent server 200. The status information may be, for example, execution state information of the app.

The client module 151 according to an embodiment may receive the result corresponding to the received voice input. For example, if the intelligent server 200 obtains the result corresponding to the received voice input, the client module 151 may receive the result corresponding to the received voice input. The client module 151 may display the received result on the display 140.

The client module 151 according to an embodiment may receive a plan corresponding to the received voice input. The client module 151 may display the result obtained by performing the plurality of operations of the app on the display 140 according to the plan. The client module 151 may sequentially display, for example, the execution result of the plurality of operations on the display. In another example, the user terminal 100 may display results of only some of the plurality of operations (for example, the result of only the last operation) on the display.

According to an embodiment, the client module 151 may receive a request for acquiring information required for obtaining the result corresponding to the voice input from the intelligent server 200. According to an embodiment, the client module 151 may transmit the required information to the intelligent server 200 in response to the request.

The client module 151 according to an embodiment may transmit result information of the execution of the plurality of operations to the intelligent server 200 according to the plan. The intelligent server 200 may identify that the received voice input is correctly processed using the result information.

The client module 151 according to an embodiment may include a voice recognition module. According to an embodiment, the client module 151 may recognize a voice input for performing a limited function through the voice recognition module. For example, the client module 151 may perform an intelligent app for processing a voice input to perform an organic operation through a predetermined input (for example, wake up!).

The intelligent server 200 according to an embodiment may receive information related to a user voice input from the user terminal 100 through a communication network. According to an embodiment, the intelligent server 200 may change data related to the received voice input into text data. According to an embodiment, the intelligent server 200 may generate a plan for performing a task corresponding to the user voice input on the basis of the text data.

According to an embodiment, the plan may be generated by an artificial intelligence (AI) system. The intelligence system may be a rule-based system, a neural network-based system (for example, a Feedforward Neural Network (FNN)), or a Recurrent Neural Network (RNN)). Alternatively, the intelligence system may be a combination thereof or an intelligent system different therefrom. According to an embodiment, the plan may be selected from a combination of predefined plans or generated in real time in response to a user request. For example, the intelligence system may select at least one plan among from a plurality of predefined plans.

The intelligent server 200 according to an embodiment may transmit the result of the generated plan to the user terminal 100 or transmit the generated plan to the user terminal 100. According to an embodiment, the user terminal 100 may display the result of the plan on the display. According to an embodiment, the user terminal 100 may display the result of execution of operation according to the plan on the display.

According to an embodiment, the intelligent server 200 may include a front end 210, a natural language platform 220, a capsule database (DB) 230, an execution engine 240, an end user interface 250, a management platform 260, big data platform 270, and an analytic platform 280.

According to an embodiment, the front end 210 may receive the received voice input from the user terminal 100. The front end 210 may transmit a response to the voice input.

According to an embodiment, the natural language platform 220 may include an Automatic Speech Recognition module (ASR module) 221, a Natural Language Understanding module (NLU module) 223, a planner module 225, Natural Language Generator module (NLG module) 227, or a Text To Speech module (TTS module) 229.

The automatic speech recognition module 221 according to an embodiment may convert the voice input received from the user terminal 100 into text data. The natural language understanding module 223 according to an embodiment may detect a user's intention on the basis of text data of the voice input. For example, the natural language understanding module 223 may detect a user's intention by performing syntactic analysis or semantic analysis. The natural language understanding module 223 according to an embodiment may detect a meaning of a word extracted from the voice input on the basis of a linguistic characteristic of a morpheme or a phrase (for example, grammatical element) and match the detected meaning of the word and the intent so as to determine the user intent.

The planner module 225 according to an embodiment may generate a plan on the basis of the intention determined by the natural language understanding module 223 and a parameter. According to an embodiment, the planner module 225 may determine a plurality of domains required for performing a task on the basis of the determined intent. The planner module 225 may determine a plurality of operations included in the plurality of domains determined on the basis of the intent. According to an embodiment, the planner module 225 may determine a parameter required for performing the plurality of determined operations or a result value output by the execution of the plurality of operations. The parameter and the result value may be defined by a concept of a predetermined type (or class). According to an embodiment, the plan may include a plurality of operations determined by the user intent and a plurality of concepts. The planner module 225 may gradually (or hierarchically) determine the relationship between the plurality of operations and the plurality of concepts. For example, the planner module 225 may determine the execution order of the plurality of operations determined on the basis of the user intent based on the plurality of concepts. In other words, the planner module 225 may determine the execution order of the plurality of operations on the basis of the parameter required for performing the plurality of operations and the result output by the execution of the plurality of operations. Accordingly, the planner module 225 may generate a plan including information on the relationship (for example, ontology) between the plurality of operations and the plurality of concepts. The planner module 225 may generate a plan on the basis of information stored in the capsule database 230 corresponding to a set of relationships between concepts and operations.

The natural language generator module 227 according to an embodiment may change predetermined information in the form of text. The information converted into the form of text may be the form of a natural language speech. The text to speech module 229 may convert information in the form of text into information in the form of voice.

According to an embodiment, some or all of the functions of the natural language platform 220 may be performed by the user terminal 100.

The capsule database 230 may store information on the relationship between a plurality of concepts and operations corresponding to a plurality of domains. The capsule according to an embodiment may include a plurality of operation objects (action objects or action information) and concept objects (or concept information) included in the plan. According to an embodiment, the capsule database 230 may store a plurality of capsules in the form of a Concept Action Network (CAN). According to an embodiment, the plurality of capsules may be stored in a function registry included in the capsule DB 230.

The capsule database 230 may include a strategy registry storing strategy information required when a plan corresponding to a voice input is determined. When there are a plurality of plans corresponding to the voice input, the strategy information may include reference information for determining one plan. According to an embodiment, the capsule database 230 may include a follow up registry storing the following operation to suggest the following operation to the user in a predetermined situation. The following operation may include, for example, the following speech. According to an embodiment, the capsule database 230 may include a layout registry storing layout information which is information output through the user terminal 100. According to an embodiment, the capsule database 230 may include a vocabulary registry storing vocabulary information included in the capsule information. According to an embodiment, the capsule database 230 may include a dialogue registry storing information on dialogue (or interaction) with the user. The capsule database 230 may update the stored object through a developer tool. The developer tool may include a function editor for updating, for example, the operation object or the concept object. The developer tool may include a vocabulary editor for updating a vocabulary. The developer tool may include a strategy editor for generating and registering a strategy to determine a plan. The developer tool may include a dialogue editor for generating a dialogue with the user. The developer tool may include a follow up editor for activating the following goal and editing the following speech that provides a hint. The follow-up goal may be determined on the basis of the current goal, a user's preference, or an environment condition. According to an embodiment, the capsule database 230 may be implemented within the user terminal 100.

The execution engine 240 according to an embodiment may obtain the result on the basis of the generated plan. The end user interface 250 may transmit the obtained result to the user terminal 100. Accordingly, the user terminal 100 may receive the result and provide the received result to the user. The management platform 260 according to an embodiment may manage information used by the intelligent server 200. The big data platform 270 according to an embodiment may collect user data. The analytic platform 280 according to an embodiment may manage Quality of Service (QoS) of the intelligent server 200. For example, the analytic platform 280 may manage elements and a processing speed (or efficiency) of the intelligent server 200.

The service server 300 according to an embodiment may provide a predetermined service (for example, food order or hotel reservation) to the user terminal 100. According to an embodiment, the service server 300 may be a server operated by a third party. The service server 300 according to an embodiment may provide information for generating a plan corresponding to the received voice input to the intelligent server 200. The provided information may be stored in the capsule database 230. Further, the service server 300 may provide result information of the plan to the intelligent server 200.

In the integrated intelligence system 10, the user terminal 100 may provide various intelligent services to the user in response to a user input. The user input may include, for example, an input through a physical button, a touch input, or a voice input.

According to an embodiment, the user terminal 100 may provide a voice recognition service through an intelligent app (or a voice recognition app) stored in the user terminal 100. In this case, for example, the user terminal 100 may recognize a user speech (utterance) or a voice input received through the microphone and provide a service corresponding to the recognized voice input to the user.

According to an embodiment, the user terminal 100 may perform a predetermined operation on the basis of the received voice input along or together with the intelligent server and/or the service server. For example, the user terminal 100 may execute an app corresponding to the received voice input and perform a predetermined operation through the executed app.

According to an embodiment, when the user terminal 100 provides the service together with the intelligent server 200 and/or the service server, the user terminal may detect a user speech through the microphone 120 and generate a signal (or voice data) corresponding to the detected user speech. The user terminal may transmit the voice data to the intelligent server 200 through the communication interface 110.

The intelligent server 200 according to an embodiment may generate a plan for performing a task corresponding to the voice input or the result of the operation according to the plan in response to the voice input received from the user terminal 100. The plan may include, for example, a plurality of operations for performing a task corresponding to the voice input of the user and a plurality of concepts related to the plurality of operations. The concepts may be parameters input to execution of the plurality of operations or may be defined for result values output by the execution of the plurality of operations. The plan may include the relationship between the plurality of operations and the plurality of concepts.

The user terminal 100 according to an embodiment may receive the response through the communication interface 110. The user terminal 100 may output a voice signal generated within the user terminal 100 to the outside through the speaker 130 or output an image generated within the user terminal 100 to the outside through the display 140.

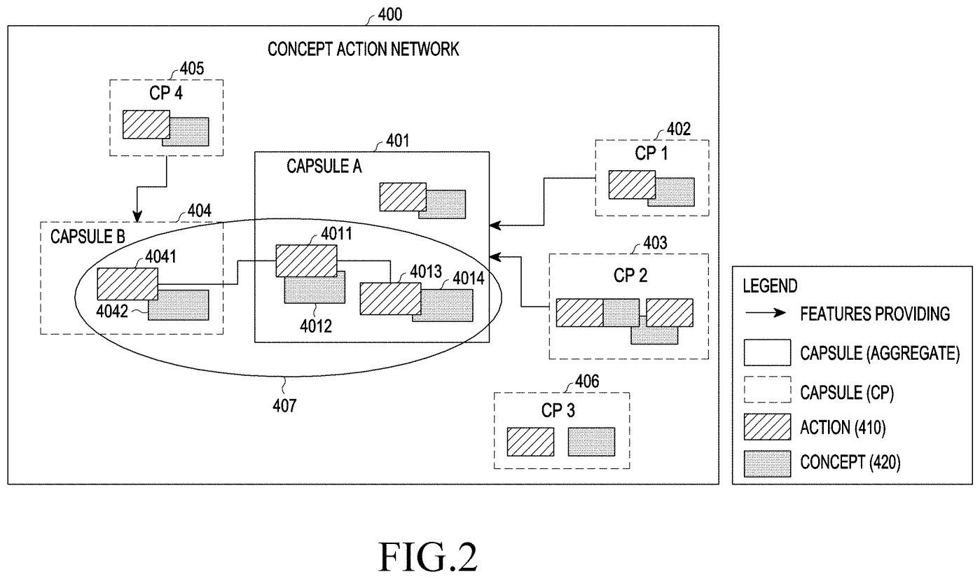

FIG. 2 illustrates the form of relationship information between concepts and actions stored in a database according to various embodiments.

A capsule database (for example, the capsule database 230) of the intelligent server 200 may store capsules in the form of a Concept Action Network (CAN) 400. The capsule database may store an operation for processing a task corresponding to a user voice input and a parameter required for the operation in the form of a Concept Action Network (CAN) 400.

The capsule database may store a plurality of capsules (capsule A 401 and capsule B 404) corresponding to a plurality of domains (for example, applications). According to an embodiment, one capsule (for example, capsule A 401) may correspond to one domain (for example, location (geo) or application). Further, one capsule may correspond to at least one service provider (for example, CP1 402, CP2 403, CP3 406, or CP4 405) for performing a function of the domain related to the capsule. According to an embodiment, one capsule may include one or more actions and one or more concepts for performing a predetermined function.

The natural language platform 220 may generate a plan for performing a task corresponding to the received voice input through the capsules stored in the capsule database. For example, the planner module 225 of the natural language platform may generate a plan through capsules stored in the capsule database. For example, a plan 407 may be generated using actions 4011 and 4013 and concepts 4012 and 4014 of capsule A 401 and an action 4041 and a concept 4042 of capsule B 404.

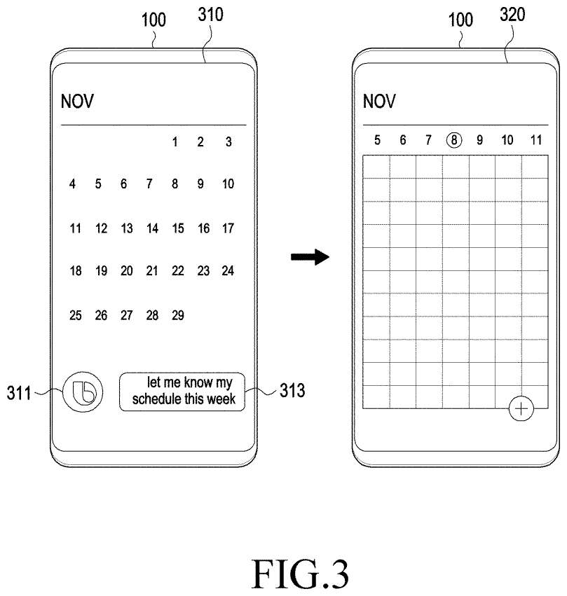

FIG. 3 illustrates screens for processing a user voice received by a user terminal through an intelligent app according to various embodiments.

The user terminal 100 may execute an intelligent app in order to process a user input through the intelligent server 200.

According to an embodiment, when the user terminal 100 recognizes a predetermined voice input (for example, wake up!) or receives an input through a hardware key (for example, a dedicated hardware key) in the screen 310, the user terminal 100 may execute an intelligent app for processing the voice input. The user terminal 100 may execute the intelligent app in the state in which, for example, a schedule app is executed. According to an embodiment, the user terminal 100 may display an object 311 (for example, an icon) corresponding to the intelligent app on the display 140. According to an embodiment, the user terminal 100 may receive the voice input by a user utterance. For example, the user terminal 100 may receive a voice input “Let me know my schedule this week”. According to an embodiment, the user terminal 100 may display a User Interface (UI) 313 (for example, an input window) of the intelligent app displaying text data of the received voice input on the display.

According to an embodiment, in a screen 320, the user terminal 100 may display the result corresponding to the received voice input on the display. For example, the user terminal 100 may receive a plan corresponding to the received user input and display the “this week's schedule” on the display according to the plan.

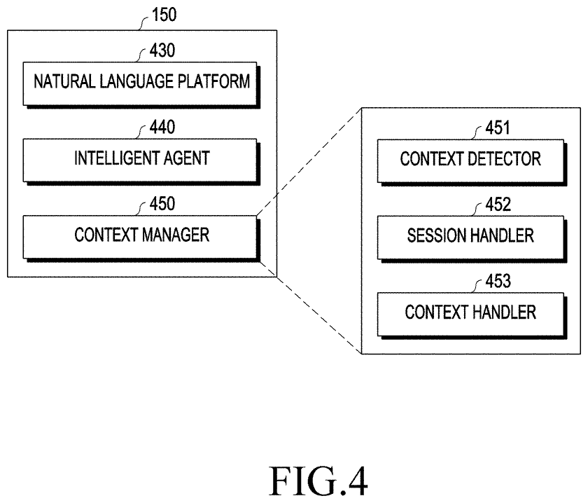

FIG. 4 illustrates a block diagram of a user terminal (for example, the user terminal 100 of FIG. 1) in the on-device form for processing a user utterance according to various embodiments. The user terminal in the on-device form may include the memory 150, the processor 160, the communication interface 110, and the input module (for example, the microphone 120) included in the user terminal 100 of FIG. 1.

According to various embodiments, in order to process a user utterance acquired through the input module by the user terminal 100, the processor 106 may store a natural language platform 430, an intelligent agent 440, and a context manager 450 in the memory 150. According to an embodiment, the natural language platform 430, the intelligent agent 440, and the context manager 450 stored in the memory 150 may be executed by a processor (for example, the processor 160 of FIG. 1). According to an embodiment, the natural language platform 430, the intelligent agent 440, and the context manager 450 stored in the memory 150 may be implemented as hardware as well as software.

According to various embodiments, the processor 160 may execute the natural language platform 430 to perform the function of the natural language platform 220 included in the intelligent server 200 of FIG. 1. For example, the natural language platform 430 may include an automatic speech recognition module (for example, the automatic speech recognition module 221 of FIG. 1), a natural language understanding module (for example, the natural language understanding module 223 of FIG. 1), a planner module (for example, the planner module 225 of FIG. 1), a natural language generator module (for example, the natural language generator module 227 of FIG. 1), or a text to speech module (for example, the text to speech module 229 of FIG. 1), and the function of the natural language platform 220 performed by the intelligent server 200 may be performed by the user terminal 100.

According to an embodiment, the natural language understanding module (not shown) (for example, the natural language understanding module 223 of FIG. 1) included in the natural language platform 430 may detect user intent by performing syntactic analysis or semantic analysis. The syntactic analysis may divide the user input into syntactic units (for example, words, phrases, or morphemes) and may detect which syntactic element belongs to the divided units. The semantic analysis may be performed using semantic matching, rule matching, or formula matching. Accordingly, the natural language understanding module (not shown) included in the natural language platform 430 may acquire a domain, an intent, or a parameter (or a slot) required for expressing the intent from the user utterance. According to an embodiment, the domain for the user utterance may be a specific category or a specific program (for example, an application or a function) for the user utterance.

According to an embodiment, the natural language understanding module (not shown) included in the natural language platform 430 may determine a user intent and a parameter using a matching rule divided into the domain, the intent, and the parameter (or slot) required for detecting the intent. For example, one domain (for example, an “alarm” as a category or an “alarm app or alarm function” as a program) may include a plurality of intents (for example, setting or releasing an alarm), and one intent may include a plurality of parameters (for example, time, the number of repetitions, and an alarm sound). A plurality of rules may include, for example, one or more necessary element parameters. The matching rule may be stored in a Natural Language Understanding Database (NLU DB) (not shown).

According to an embodiment, the natural language understanding module (not shown) included in the natural language platform 430 may detect a meaning of a word extracted from the user input on the basis of linguistic features of morphemes or phrases (for example, syntactic elements) and determine a user intent by matching the detected meaning of the word with a domain and an intent. For example, the natural language understanding module (not shown) included in the natural language platform 430 may calculate how many words extracted from the user input are included in each domain and each intent and determine the user intent. According to an embodiment, the natural language understanding module (not shown) included in the natural language platform 430 may determine a parameter of the user input on the basis of the words that are the base of detecting the intent. According to an embodiment, the natural language understanding module (not shown) included in the natural language platform 430 may determine the user intent through a natural language recognition database (not shown) storing linguistic features for detecting the intent of the user input. According to another embodiment, the natural language understanding module (not shown) included in the natural language platform 430 may determine the user intent through a Personal Language Model (PLM). For example, the natural language understanding module (not shown) included in the natural language platform 430 may determine the user intent on the basis of personalized information (for example, a contact list or a music list). The personal language model may be stored in, for example, a natural language recognition database. According to an embodiment, not only the natural language understanding module (not shown) included in the natural language platform 430 but also the automatic speech recognition module (not shown) may also recognize user speech with reference to the personal language model stored in the natural language recognition database (not shown).

According to various embodiments, the processor 160 may execute the intelligent agent 440 linked to the intelligent app (for example, a voice recognition app). The intelligent agent 440 linked to the intelligent app may receive a user utterance and process the same in the form of a voice signal. According to an embodiment, the intelligent agent 440 linked to the intelligent app may operate by a specific input (for example, an input through a hardware key, an input through a touch screen, or a specific voice input) acquired through an input module (not shown) included in the user terminal 100. According to an embodiment, the processor 160 may preprocess a user input (for example, a user utterance) by executing the intelligent agent 440. According to an embodiment, in order to preprocess the user input, the intelligent agent 440 may include an Adaptive Echo Canceller (AEC) module, a Noise Suppression (NS) module, an End-Point Detection (EPD) module, or an Automatic Gain Control (AGC) module. The AEC may remove an echo from the user input. The NS module may suppress background noise included in the user input. The EPD module may detect an end point of the user voice included in the user input and discover a part having the user voice on the basis of the detected end point. The AGC module may recognize the user input and control a volume of the user input to properly process the recognized user input. According to an embodiment, the processor 160 may execute all of the preprocessing configurations for the performance according to an embodiment, but the processor 160 may execute only some of the preprocessing configurations to operate with low power according to another embodiment.

According to various embodiments, the processor 160 may identify voice assistant session information and context information by executing the context manager 450. According to various embodiments, the context manager 450 may include a context detector 451, a session handler 452, and a context handler 453. The context detector 451 may perform a function of identifying whether there is required context information in the user terminal 100. The session handler 452 may perform a function of acquiring voice assistant session information from an external electronic device in the on-device form capable of processing a user utterance, selecting an external electronic device to which a request for context information is made, and identifying voice assistance session information to be transmitted to the external electronic device. The context handler 453 may perform a function of generating context information and transmitting and receiving the context information to and from the external electronic device.

According to various embodiments, the voice assistance session information may be information indicating a voice assistant session and may include at least one piece of the information that may be transmitted to the external electronic device or received from the external electronic device and is shown in [Table 1] below. The voice assistance session may refer to dialogues exchanged between a voice assistance and a user, provided by an intelligent app, and various tasks may be performed by a user request while the voice assistance session is executed. According to various embodiments, the voice assistant session information is not limited to the following example and may include information on various entities for processing a user utterance.

TABLE 1

| Voice assistant | |
|---|---|
| session information | Description |
| Voice assistant | Identifier (conversation ID or session ID) for identifying voice |
| session identifier | assistant session |
| Information on | Information indicating whether voice assistant session is |
| whether to activate | activated or deactivated in device |
| voice assistant | |
| session | |
| Domain information | Domain information corresponding to domain for user utterance |
| of voice assistant | in device |
| session | |
| Domain state | Domain state information of domain corresponding to final user |
| information of voice | utterance processed in voice assistant session (for example, |
| assistant session | specific state information of domain after user utterance is made |
| | in specific domain) |
| Information on | Information on whether information indicating result of task |
| whether information | corresponding to final user utterance processed in voice assistant |
| indicating result of | session is possessed |
| task of voice | |
| assistant session is | |
| possessed | |
| Duration time of | Duration time of voice assistant session |
| voice assistant | |
| session | |
| Information on | Information on whether at least one of domain, intent, or |
| whether final | parameter for final user utterance processed in voice assistant |
| utterance information | session is possessed |
| is possessed | |
| Final utterance time | Time at which final user utterance processed in voice assistant |
| | session is made |
| Device location | Information on location of device executing voice assistant |
| | session |
| Information on | Information on whether user personal information or user interest |
| whether user | information is possessed |
| information is | |
| possessed | |
| Information on | Information on whether context history information of at least |
| whether context | one user utterance processed in voice assistant session is |
| history information is | possessed |
| possessed | |

According to an embodiment, in connection with “information on whether to activate the voice assistant session” shown in [Table 1] above, the user terminal 100 may recognize a predetermined voice input (for example, Hi, BIXBY!) or executing an intelligent app in response to a user input of selecting an icon or a dedicated hardware key configured to execute the intelligent app, so as to generate the voice assistant session. In this case, the state in which acquisition of user utterance is waited for through execution of the intelligent app may be the state in which the voice assistant session is activated. According to an embodiment, after generating the voice assistant session, the user terminal 100 may call a specific domain while the corresponding voice assistant session is executed, and the state in which acquisition of user utterance is waited for while the specific domain is called may be the state in which the voice assistant session is activated. For example, when a first user utterance (for example, “Order coffee”) is acquired in the state in which a specific coffee domain is called while the voice assistant session is executed, the user terminal 100 may output a response (for example, “which coffee do want to order?”) inquiring about a parameter for the first user utterance through the intelligent app and wait to acquire an additional user utterance. In this case, the state in which acquisition of the additional user utterance is waited for may be the state in which the voice assistant session is activated. According to an embodiment, the user terminal 100 may end the called specific domain while the voice assistant session is executed by recognizing a predetermined voice input (for example, “End!”) to end the called domain or in response to a user input of selecting an icon for ending the called domain. In this case, the state in which the called domain does not end may be the state in which the voice assistant session is activated. According to an embodiment, after generating the voice assistant session, the user terminal 100 may call the specific domain while the corresponding voice assistant session is executed, and the state in which the user input for ending the called domain is not acquired may be the state in which the voice assistant session is activated. According to an embodiment, the predetermined voice input (for example, “End!”) to end the called domain may be applied to all domains regardless of the domain type, or the predetermined voice input configured to end the corresponding domain may be different for each domain. According to an embodiment, in the state in which the voice assistant session is executed, when 1) a predetermined first time passes from a time point at which user utterance is acquired, 2) when a predetermined second time passes from a time point at which an intelligent app makes a request for additional user utterance, or 3) when a user input designated to end the voice assistant session (for example, a voice input, a touch input, or a hardware key input) is acquired, the user terminal 100 may end the currently executed voice assistant session. In this case, the state in which the currently executed voice assistant session does not end may be the state in which the voice assistant session is activated. According to an embodiment, information on whether context history information is possessed may indicate whether context history information of all user utterance processed in the corresponding voice assistant session is possessed. According to an embodiment, the information on whether the context history information is possessed may indicate whether history information of user utterances selected on the basis of a domain is possessed (for example, whether domain history information is possessed). For example, the information on whether the context history information is possessed may indicate whether context history information of at least some of user utterances processed by a domain (for example, app A) for the final user utterance is possessed. In another example, the information on whether the context history information is possessed may indicate whether context history information of at least some of user utterances processed by a specific domain is possessed. In this case, the specific domain may correspond to a domain (for example, a domain for the user utterance acquired by an external electronic device) included in a request for voice assistant session information acquired from the external electronic device. According to an embodiment, user utterances may be processed by at least one domain while one voice assistant session (for example, dialogue) is executed. According to an embodiment, the voice assistant session may be identified on the basis of a time point at which the intelligent app ends from execution of the intelligent app. According to an embodiment, the voice assistant session may be identified for each domain, for each user utterance, or each specific time. According to an embodiment, the voice assistant session may be identified on the basis of a time point at which a predetermined time passes from a time point at which a user utterance is acquired. The reference for identifying the voice assistant session is not limited to the example and may be identified according to settings by a user, a manufacturer, or an app developer. According to an embodiment, when the voice assistant session is identified on the basis of the time point at which the predetermined time passes from the time point at which the user utterance is acquired, the voice assistant session may be identified on the basis of the time point at which the predetermined time passes from the time point at which an initial user utterance is acquired after the intelligent app is executed or the voice assistant session may be identified on the basis of the time point at which the predetermined time passes from the time point at which a final user utterance is acquired after the intelligent app is executed.

According to an embodiment, the voice assistant session identifier (for example, conversation ID) may have the same ID during one voice assistant session, and the user utterance identifier (for example, request ID) may have different IDs for respective user utterances. For example, an identifier (for example, conversation ID=001, request ID=8) of a first user utterance (for example, “Play the latest song”), an identifier (conversation ID=001, request ID=9) of a second user utterance (for example, “Play the next song”), and an identifier (for example, conversation ID=001, request ID=10) of a third user utterance (for example, “Pause the song”) may be identified while one voice assistant session is executed.

According to various embodiments, context information is information on processing of a user utterance, and may be transmitted to an external electronic device or received from an external electronic device. According to an embodiment, the context information may include (1) user utterance text information of the user utterance. The user utterance text information may be user utterance information converted into text data by the automatic speech recognition module (not shown) included in the natural language platform 430. According to an embodiment, the context information may include at least one of (2) a domain, an intent, or a parameter (for example, a necessary parameter or an auxiliary parameter) for the user utterance. A necessary parameter for performance of the intent (for example, setting an alarm) may be an element (for example, an alarm time) that should be necessarily configured to accomplish the intent for the user utterance, and the auxiliary parameter may be an element (for example, intensity of an alarm sound) that may be randomly configured by a device. According to an embodiment, the context information may include (3) information on the result of a task corresponding to the user utterance (for example, a specific URL or a specific API). According to an embodiment, the context information may include (4) domain state information corresponding to the user utterance (for example, parameter information for providing specific state information of the domain or a specific state). According to an embodiment, the context information may include (5) information on an executor device (for example, a speaker) indicated by the user utterance (for example, “play A through the speaker) acquired through the user terminal 100 (for example, a smartphone). According to an embodiment, in order to make division of items of the context information easy, an identifier (ID) (for example, a user utterance identifier (request ID), a domain ID, or an intent ID) may be allocated to each item.

According to various embodiments, the context information may include user information associated with a user making an utterance. According to an embodiment, the context information may include at least one piece of information on a user account accessing the user terminal 100, a user service ID, or IoT account information (for example, SmartThings). According to an embodiment, the context information may include information on a specific user utterance designated as an utterance that the user prefers or information on a specific domain designated as a domain that the user prefers. According to an embodiment, the context information may include user personal information or user interest information. The user personal information may include at least one of age of the user, gender, family members, house or office location information, user location information in each time zone, location information that a user prefers, contact list, or schedule. The user interest information may include a usage frequency of an app or information on a preferred app. The user interest information may include interest information identified on the basis of at least one of a web search history, a web access record, or an app use record. The user interest information may include product information identified on the basis of at least one of a web search history, a web access record, text, messages, or a user purchase history through apps. The user interest information may include content information identified on the basis of at least one of a web search history, a web access record, or media reproduction information. According to various embodiments, the user information included in the context information is not limited thereto and may include various pieces of information such as information for identifying a user or information preferred by a user.

According to various embodiments, the context information may include device-related information of the user terminal 100 acquiring a user utterance. According to an embodiment, the device-related information may include information on the location of the user terminal 100. According to an embodiment, the device-related information may include information on at least one application installed in the user terminal 100 (for example, an app installation list, an app name, an app attribute, an app version, or an app download address). According to an embodiment, the device-related information may include information acquired through a sensor module (not shown) of the user terminal 100. According to an embodiment, the device-related information may include information designated on the basis of a type of the user terminal 100. According to an embodiment, the context information may include at least one piece of type information, ID information, or version information of the user terminal 100. According to an embodiment, the context information may include information on an executor device.

According to various embodiments, the context information may include context history information. The context history information may be history information of at least one piece of user utterance information that has been completely processed previously. According to an embodiment, the context history information may include at least one piece of (1) user utterance text information of each user utterance, (2) information on at least one of a domain, an intent, or a parameter for each user utterance, (3) the result of a task corresponding to each user utterance, or (4) domain state information corresponding to each user utterance. According to an embodiment, each piece of the user utterance information included in the context history information may be divided on the basis of the voice assistant session, and user utterances divided for each voice assistant session may be arranged in the order of time at which the user utterance is acquired. According to an embodiment, the context history information may be divided on the basis of a domain supported by the user terminal 100, and user utterances divided for each domain may be arranged in the order of time at which the user utterance is acquired. In this case, in the context history information, the form in which user utterance is divided on the basis of the domain may be domain history information. According to an embodiment, specific context history information for a specific user utterance (for example, domain history information) may be history information of previous user utterances processed through a domain for the specific user utterance. According to an embodiment, in connection with user interest information included in the context information, the user terminal 100 may analyze context history information (for example, domain history information) and configure user interest information corresponding to a specific domain. For example, the user terminal 100 may analyze context history information of each user utterance processed in a hotel search domain to identify that a room supporting a specific option (for example, a room in which Wi-Fi access is possible and a swimming pool exists) is reserved a predetermined number of times or more, and configure information on the specific option as user interest information corresponding to the hotel search domain. According to various embodiments, the context history information is not limited to the example, and may include history information of all items of the context information described with reference to FIG. 4. According to various embodiments, the context history information may be divided for each item included in context information as well as division based on the voice assistant session or the domain

According to various embodiments, voice assistant session information may include information on some preset items in the context information. For example, the voice assistant session information may include a specific item of the context information in an item of the voice assistant session information by settings of a user, a manufacturer, or an app developer. According to various embodiments, the processor 160 may transmit a request for voice assistant session information to at least one external electronic device or acquire voice assistant session information from each of the at least one external electronic device through the communication interface 110.

According to various embodiments, the processor 160 may transmit a request for context information associated with the voice assistant session information to the external electronic device transmitting the voice assistant session information that satisfies a predetermined condition or receive context information associated with the voice assistant session information from the external electronic device through the communication interface 110.

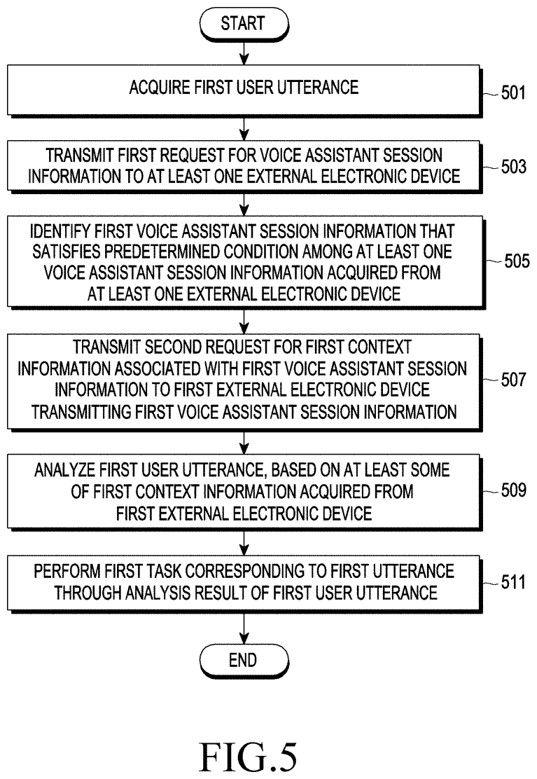

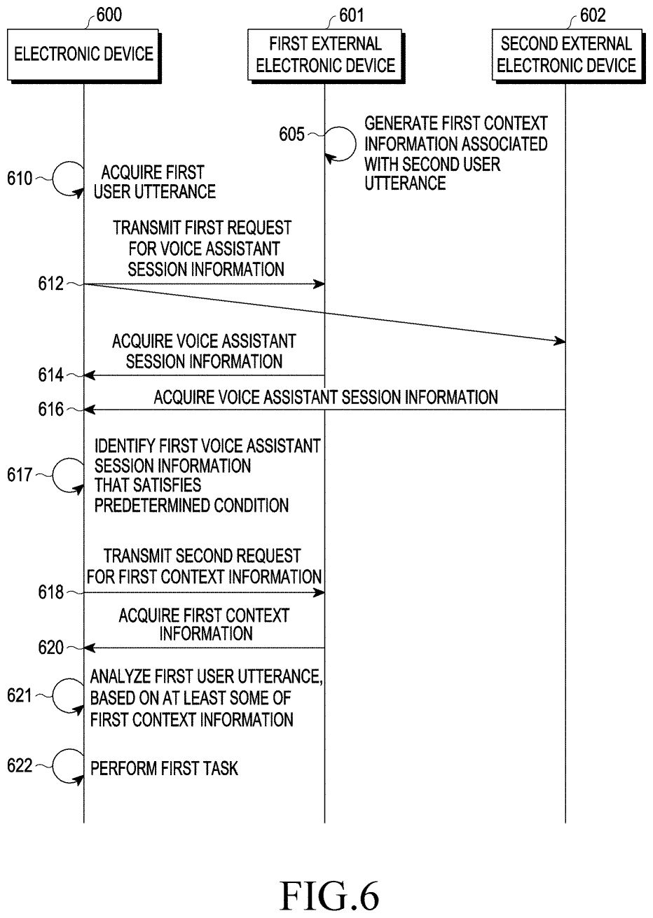

FIG. 5 illustrates a flowchart of a method of performing a first task corresponding to a first user utterance by an electronic device (for example, the electronic device 600 of FIG. 6) according to various embodiments. The electronic device 600 may include the user terminal 100 of FIG. 1.

FIG. 6 illustrates an embodiment in which the electronic device 600 analyzes a first user utterance on the basis of first context information acquired from a first external electronic device 601 and performs a first task corresponding to the first user utterance.

In operation 501, according to various embodiments, the electronic device 600 (for example, the processor 160 of FIG. 1) may acquire the first user utterance. For example, referring to FIG. 6, the electronic device 600 may acquire the first user utterance (for example, “How about Seoul?”) through a microphone (for example, the microphone 120 of FIG. 1) in step 610.

According to various embodiments, the electronic device 600 (for example, the processor 160 of FIG. 1) may analyze the first user utterance in response to acquisition of the first user utterance. According to an embodiment, the electronic device 600 may identify at least one of a domain, an intent, or a parameter for the first user utterance by analyzing the first user utterance through a natural language platform (for example, the natural language platform 430 of FIG. 4).

According to various embodiments, the electronic device 600 (for example, the processor 160 of FIG. 1) may identify attributes of the first user utterance. According to an embodiment, the electronic device 600 may identify whether the attributes of the first user utterance correspond to an incomplete utterance or a complete utterance as the analysis result of the first user utterance. The incomplete utterance may be a user utterance of which the task corresponding thereto cannot be performed using only the analysis result of the acquired user utterance and which needs additional information. The complete utterance may be a user utterance of which the task corresponding thereto can be performed using only the analysis result of the acquired user utterance. According to an embodiment, the electronic device 600 may identify that the attributes of the first user utterance correspond to an incomplete utterance as the analysis result of the first user utterance on the basis of non-identification of at least one of a domain, an intent, or a mandatory parameter for the first user utterance. According to an embodiment, the electronic device 600 may identify that the attributes of the first user utterance correspond to an incomplete utterance as the analysis result of the first user utterance on the basis of at least some of the first user utterance corresponding to a predetermined expression indicating the incomplete utterance. According to an embodiment, when the electronic device 600 identifies that an additional parameter is not needed and a first task corresponding to the first user utterance can be performed using only the first user utterance, the electronic device 600 may identify that the attributes of the first user utterance correspond to a complete utterance as the analysis of the first user utterance. According to an embodiment, the electronic device 600 may identify that an utterance that is not an incomplete utterance is a complete utterance. According to an embodiment, the electronic device 600 may identify whether the attributes of the first user utterance correspond to a complete utterance or an incomplete utterance on the basis of a deep-learning model.

According to various embodiments, the electronic device 600 (for example, the processor 160 of FIG. 1) may perform the first task corresponding to the first user utterance on the basis of the analysis result of the first user utterance in response to the attributes of the first user utterance corresponding to a complete utterance.

According to various embodiments, the electronic device 600 (for example, the processor 160 of FIG. 1) may identify a type of the first user utterance. According to an embodiment, the electronic device 600 may identify whether the type of the first user utterance corresponds to a root utterance or a follow-up utterance as the analysis result of the first user utterance. According to an embodiment, the root utterance may be a user utterance first acquired by the electronic device 600 after the voice assistant session is generated in order to perform a specific action required by the user. For example, the electronic device 600 may acquire a user utterance (for example, “Play music”) making a request for a specific action after acquiring a user utterance (for example, “Hi, BIXBY”) making a request for generating a voice assistant session in the state in which the voice assistant session is not generated. In this case, the utterance making the request for the specific action may be the root utterance. According to an embodiment, the root utterance may be a user utterance for first calling a domain after the voice assistant session is generated or a user utterance for calling a second domain while the first domain is called and a user utterance is processed within the voice assistant session. According to an embodiment, the follow-up utterance is a user utterance associated with the root utterance and may be a series of user utterances additionally acquired after the root utterance is acquired. For example, after acquiring a user utterance (for example, “Hi, BIXBY, Play music”) from the user, the intelligent app of the electronic device 600 may output a message making a request for additional information (for example, “What song do you want to hear?”) through a speaker and acquire an additional user utterance (for example, “Play the latest music”) for the message from the user. In this case, the additional user utterance associated with the root utterance may be the follow-up utterance. After acquiring the root utterance, the electronic device 600 may acquire a first follow-up utterance continuous to the root utterance, and acquire a second follow-up utterance continuous to the first follow-up utterance after acquiring the first follow-up utterance. In this case, the root utterance may be a preceding utterance of the first follow-up utterance, and the first follow-up utterance may be a preceding utterance of the second follow-up utterance.

In operation 503, according to various embodiments, the electronic device 600 (for example, the processor 160 of FIG. 1) may transmit a first request for voice assistant session information to at least one external electronic device (for example, a first external electronic device 601 of FIG. 6 or/and a second external electronic device 602 of FIG. 6) through a communication interface (for example, the communication interface 110 of FIG. 1). For example, referring to FIG. 6, the electronic device 600 may transmit the first request for the voice assistant session information to the first external electronic device 601 and the second external electronic device 602 in step 612. According to an embodiment, the electronic device 600 may transmit the first request to at least one of the external electronic devices 601 and/or 602 in a broadcast type, a multicast type, or a unicast type.

According to various embodiments, at least one external electronic device 601 and/or 602 may perform functions of the elements included in the user terminal 100 of FIG. 1. According to an embodiment, each of the at least one external electronic device 601 and/or 602 may analyze a user utterance like the user terminal 100 or the electronic device 600, and may be a device in the on-device form for performing a task corresponding to a user utterance on the basis of the analysis result of the user utterance. According to an embodiment, at least one external electronic device 601 and/or 602 may include devices for establishing a short-range wireless communication connection (for example, Bluetooth, Wi-Fi direct, or IrDA) with the electronic device 600 and/or devices associated with a user account of the electronic device 600. According to an embodiment, the electronic device 600 may register at least one external electronic device 601 and/or 602 in the electronic device 600 in order to establish the short-range wireless communication connection with the at least one external electronic device 601 and/or 602. According to an embodiment, the electronic device 600 may transmit the first request to at least one external electronic device 601 and/or 602 for establishing the short-range wireless communication connection. According to an embodiment, the electronic device 600 may transmit the first request to at least one external electronic device 601 and/or 602 that is accessed with a specific user account. According to an embodiment, the electronic device 600 may transmit the first request to at least one external electronic device 601 and/or 602 that transmits a signal having strength higher than or equal to a threshold value. According to an embodiment, at least one external electronic device 601 and/or 602 is an IoT device and may be a device managed along with the electronic device 600 by a central control unit in a specific cloud (for example, a smart home cloud).

According to various embodiments, the electronic device 600 (for example, the processor 160 of FIG. 1) may transmit the first request for the voice assistant session information to at least one external electronic device 601 and/or 602 in response to acquisition of a first user utterance.

According to various embodiments, the electronic device 600 (for example, the processor 160 of FIG. 1) may transmit the first request to at least one external electronic device 601 and/or 602 in response to identification that attributes of the first user utterance correspond to an incomplete utterance.

According to various embodiments, the electronic device 600 (for example, the processor 160 of FIG. 1) may identify whether first context information associated with the first user utterance exists in the electronic device 600 among at least one piece of context information associated with at least one user utterance processed by the electronic device 600 before acquisition of the first user utterance on the basis of the attributes of the first user utterance corresponding to an incomplete utterance. According to an embodiment, the electronic device 600 may perform a first task corresponding to the first user utterance on the basis of at least some of the first context information in response to identification that the first context information exists in the electronic device 600 before acquisition of the first user utterance. According to an embodiment, the electronic device 600 may transmit a first request for the first context information to at least one external electronic device 601 and/or 602 in response to identification that the first context information does not exist in the electronic device 600 before acquisition of the first user utterance.

According to various embodiments, the electronic device 600 (for example, the processor 160 of FIG. 1) may transmit a first request including a message inquiring about whether the voice assistant session information satisfies a predetermined condition to at least one external electronic device 601 and/or 602. The predetermined condition will be described in detail with reference to operation 505 described below. According to an embodiment, the electronic device 600 may transmit a first request including a message inquiring about whether the voice assistant session of at least one external electronic device 601 and/or 602 is activated. According to an embodiment, the electronic device 600 may transmit a first request including a message inquiring about whether final utterance information of at least one external electronic device 601 and/or 602 corresponds to at least one of a domain or an intent for the first user utterance analyzed by the electronic device 600.

In operation 505, according to various embodiments, the electronic device 600 (for example, the processor 160 of FIG. 1) may identify first voice assistant session information that satisfies a predetermined condition among at least one piece of voice assistance session information acquired from at least one external electronic device 601 and/or 602.

According to various embodiments, the electronic device 600 (for example, the processor 160 of FIG. 1) may acquire voice assistant session information from each of at least one external electronic device 601 and/or 602. For example, referring to FIG. 6, the electronic device 600 may acquire voice assistant session information from the first external electronic device 601 in step 614 and acquire voice assistant session information from the second external electronic device 602 in step 616. The voice assistant session information is, for example, information indicating at least one piece of the voice assistant session information of [Table 1] and may be transmitted and received by the electronic device 600 or at least one external electronic device 601 and/or 602.

According to various embodiments, the electronic device 600 (for example, the processor 160 of FIG. 1) may identify first voice assistant session information that satisfies a predetermined condition among at least one piece of the acquired voice assistant session information. For example, referring to FIG. 6, the electronic device 600 may identify first voice assistant session information that satisfies a predetermined condition among voice assistant session information acquired from the first external electronic device 601 and voice assistant session information acquired from the second external electronic device 602 in step 617. According to an embodiment, the electronic device 600 may acquire voice assistant session information indicating that the voice assistant session is activated as the first voice assistant session information that satisfies the predetermined condition. For example, referring to FIG. 6, the electronic device 600 may acquire voice assistant session information indicating that the voice assistant session is activated from the first external electronic device 601 among the first external electronic device 601 and the second external electronic device 602 and may identify the voice assistant session information acquired from the first external electronic device 601 as the first voice assistant session information that satisfies the predetermined condition in step 617. According to an embodiment, the state in which the voice assistant session is activated may include a state in which a domain for a user utterance is being executed in a foreground or a background or is activated. According to an embodiment, the electronic device 600 may identify voice assistant session information including final user utterance information corresponding to at least one of a domain, an intent, or a mandatory parameter for the first user utterance as the first voice assistant session information that satisfies the predetermined condition. According to an embodiment, the electronic device 600 may identify voice assistant session information indicating that context history information is possessed as the first voice assistant information that satisfies the predetermined condition.

According to various embodiments, the electronic device 600 (for example, the processor 160 of FIG. 1) may identify the first voice assistant information that satisfies the predetermined condition on the basis of voice assistant session information acquired from at least one external electronic device 601 and/or 602. According to an embodiment, the electronic device 600 may identify voice assistant session information including a final utterance time within a predetermined threshold time from a time at which the first user utterance is acquired or a time at which each piece of the voice assistant session information is acquired as the first voice assistant session information that satisfies the predetermined condition. For example, referring to FIG. 6, when the final utterance time included in the voice assistant session information acquired from the first external electronic device 601 is 12:00:30 on 2019/01/01, the final utterance time included in the voice assistant session information acquired from the second external electronic device 602 is 11:50:00 on 2019/01/01, the time at which the first user utterance is acquired is 12:01:30 on 2019/01/01, and the predetermined threshold time is 5 minutes, the electronic device 600 may identify the voice assistant session information acquired from the first external electronic device 601 as the first voice assistant session information that satisfies the predetermined condition. The aforementioned example is only an example, and the electronic device 600 may identify voice assistant session information including the final utterance time within the predetermined threshold time from a time configured by a user or a manufacturer or a time at which a predetermined operation is performed by the electronic device 600 (for example, a time at which the first request is transmitted) as the first voice assistant session information that satisfies the predetermined condition. According to an embodiment, the electronic device 600 may identify voice assistant session information including domain state information corresponding to the domain for the first user utterance as the first voice assistant session information that satisfies the predetermined condition. For example, referring to FIG. 6, when the domain state information included in the voice assistant session information acquired from the first external electronic device 601 is provided by domain A, the domain state information included in the voice assistant session information acquired from the second external electronic device 602 is provided by domain B, and the domain for the first user utterance corresponds to domain A, the electronic device 600 may identify that the voice assistant session information acquired from the first external electronic device 601 is the first voice assistant session information that satisfies the predetermined condition. According to an embodiment, the electronic device 600 may identify voice assistant session information including information on a domain corresponding to the domain for the first user utterance as the first voice assistant session information that satisfies the predetermined condition. According to various embodiments, the electronic device 600 may identify voice assistant session information that satisfies two or more of the aforementioned conditions as the first voice assistant session information that satisfies the predetermined condition.

According to various embodiments, the electronic device 600 (for example, the processor 160 of FIG. 1) may output a message making a request for additional information on the basis of non-identification of the first voice assistant session information that satisfies the predetermined condition among at least one piece of the acquired voice assistant session information. According to an embodiment, the electronic device 600 may output a message making a request for additional information through a display (for example, the display 140 of FIG. 1) or a speaker (for example, the speaker 130 of FIG. 1). According to various embodiments, the electronic device 600 (for example, the processor 160 of FIG. 1) may perform a first task corresponding to the first user utterance on the basis of the additional information acquired from the user and the analysis result of the first user utterance. According to an embodiment, the electronic device 600 may acquire an additional user utterance through the microphone 120 or an additional touch input through the display 140 as the additional information.

In operation 507, according to various embodiments, the electronic device 600 (for example, the processor 160 of FIG. 1) may transmit a second request for first context information associated with the first voice assistant session information to the first external electronic device 601 transmitting the first voice assistant session information through the communication interface 110. For example, referring to FIG. 6, the electronic device 600 may transmit the second request for the first context information associated with the first voice assistant session information to the first external electronic device 601 transmitting the first voice assistant session information that satisfies the predetermined condition in step 618. According to an embodiment, the second request for the first context information transmitted to the first external electronic device 601 by the electronic device 600 may include at least one of a domain, an intent, or a mandatory parameter for the first user utterance analyzed by the electronic device 600.

In operation 509, according to various embodiments, the electronic device 600 (for example, the processor 160 of FIG. 1) may analyze the first user utterance on the basis of at least some of the first context information acquired from the first external electronic device 601. For example, referring to FIG. 6, the electronic device 600 may omit the operation of analyzing the first user utterance described in operation 501 or may additionally analyze the first user utterance on the basis of at least some of the first context information after performing the operation of analyzing the first user utterance in step 621.

According to various embodiments, the electronic device 600 (for example, the processor 160 of FIG. 1) may acquire the first context information from the first external electronic device 601. For example, referring to FIG. 6, the electronic device 600 may acquire the first context information from the first external electronic device 601 in step 620. According to an embodiment, the first external electronic device 601 may acquire a second user utterance during a specific voice assistant session (for example, a voice assistant session indicated by the voice assistant session information transmitted by the first external electronic device 601), analyze the acquired second user utterance, and perform a second task corresponding to the second user utterance on the basis of the analysis result of the second user utterance. According to an embodiment, the second user utterance may be a specific user utterance for executing the second task in a specific domain (for example, application) of at least one external electronic device by the user. According to an embodiment, the second user utterance may be a final user utterance among at least one user utterance processed by the first external electronic device 601, and the first user utterance may be the follow-up utterance of the second user utterance.

According to an embodiment, the first external electronic device 601 may generate the first context information associated with the second user utterance. For example, referring to FIG. 6, the first external electronic device 601 may generate the first context information including at least one of (1) user utterance text information of the second user utterance, (2) information on at least one of a domain, an intent, or a parameter for the second user utterance, (3) information on the result of the second task corresponding to the second user utterance, (4) domain state information corresponding to the second user utterance, or (5) domain history information of the domain for the second user utterance in step 605.

According to various embodiments, the electronic device 600 (for example, the processor 160 of FIG. 1) may process the first context information acquired from the first external electronic device 601. For example, since versions or file execution formats of a domain (for example, a music application) executed by the first external electronic device 601 and a domain (for example, a music application) executed by the electronic device 600 may be different from each other, the electronic device 600 may process the format of the acquired first context information to a form that can be executed by the electronic device 600. In another example, since a format (for example, voice output) in which the first external electronic device 601 (for example, a smart speaker) performs a task may be different from a format (for example, screen output) in which the electronic device 600 (for example, a smart refrigerator) performs a task, the electronic device 600 may process the format of the first context information to a form that can be executed by the electronic device 600.

According to various embodiments, the electronic device 600 (for example, the processor 160 of FIG. 1) may identify a type of the first user utterance as the analysis result of the first user utterance on the basis of at least some of the first context information. According to an embodiment, the electronic device 600 may identify the analysis result of the second user utterance (for example, final user utterance) included in the first context information and identify whether the type of the first user utterance corresponds to a follow-up utterance of the second user utterance on the basis of the analysis result of the second user utterance. According to an embodiment, the electronic device 600 may identify a specific device corresponding to the type of the first user utterance. For example, when the user makes a final user utterance (for example, “Play the latest music through TV) using the first external electronic device 601 (for example, a smartphone) and makes a first user utterance (for example, “Turn the volume up”) using the electronic device 600 (for example, a smart speaker) while the voice assistant session of the first external electronic device 601 is executed, the electronic device 600 may identify the analysis result of the final user utterance included in the first context information (for example, information on an executor device indicated by the final user utterance) and identify a specific device (for example, a smart TV) corresponding to the first user utterance that is a follow-up utterance of the final user utterance processed by the first external electronic device 601 on the basis of the analysis result.

According to various embodiments, the electronic device 600 (for example, the processor 160 of FIG. 1) may identify a first task corresponding to the first user utterance as the analysis result of the first user utterance on the basis of at least some of the first context information. According to an embodiment, the electronic device 600 may identify the first task corresponding to the first user utterance on the basis of at least some of the first context information in response to the type of the first user utterance corresponding to the follow-up utterance of the second user utterance.

According to an embodiment, the electronic device 600 may identify that the first user utterance is a follow-up utterance of the second user utterance as the analysis result of the first user utterance on the basis of information on at least one of the domain, the intent, or the parameter for the second user utterance included in the first context information and identify the first task corresponding to the first user utterance. For example, referring to FIG. 6, the electronic device 600 may identify the first task (for example, outputting information on weather in Seoul today through a speaker and a display) by applying information on the domain (for example, a weather application) and the intent (for example, a weather search) for the final user utterance included in the first context information to the first user utterance (for example, “Seoul?”).

According to an embodiment, the electronic device 600 may identify that the first user utterance is a follow-up utterance of the second user utterance as the analysis result of the first user utterance on the basis of information on the result of the task corresponding to the second user utterance included in the first context information and identify the first task corresponding to the first user utterance. For example, referring to FIG. 6, the electronic device 600 may identify the first task (for example, outputting all songs within a found music list of a music application through a speaker and a display) by applying information on the result of the task (for example, a music list found by the music application or a search result API) corresponding a final user utterance (for example, “Search for the latest song”) included in the first context information to the domain (for example, the music application) for the first user utterance (for example, “Play all songs”).

According to an embodiment, the electronic device 600 may identify that the first user utterance is a follow-up utterance of the second user utterance as the analysis result of the first user utterance on the basis of domain state information corresponding to the second user utterance included in the first context information and identify the first task corresponding to the first user utterance. For example, referring to FIG. 6, the electronic device 600 may identify the first task (for example, outing recipe A in recipe search app X) by applying domain state information (for example, state information of a screen that outputs recipe A in recipe search app X) corresponding to final user utterance (for example, “Search for recipe A”) included in the first context information to the domain (for example, recipe search app X) for the first user utterance (for example, “Show me previously found food recipe information).

According to an embodiment, the electronic device 600 may identify that the first user utterance is a follow-up utterance of the second user utterance as the analysis result of the first user utterance on the basis of context history information or domain history information for the second user utterance included in the first context information and identify the first task corresponding to the first user utterance. For example, referring to FIG. 6, the electronic device 600 may identify the first task (for example, outputting an economic news screen in a news application, outputting an entertainment news screen, and then outputting a social news screen) by applying domain state information (for example, the economy news screen, the entertainment news screen, and the social news screen) corresponding to user utterances (for example, “Show me economy news”, “Show me entertainment news”, and “Show me Social news”) processed by domain history information (for example, the news application) for a final user utterance (for example, “Show me economy news”) to the first user utterance (for example, “Show me news”, “Show me previous news”, and “Show me more previous news”). In this case, it is premised that the domain (for example, the news application installed in the first external electronic device 601) for the final user utterance corresponds to the domain (for example, the news application installed in the electronic device 600) for the first user utterance. According to an embodiment, the domain for the second user utterance corresponding to the domain for the first user utterance may be a domain which is the same as the domain for the first user utterance, a domain which is compatible with the domain for the first user utterance, or a domain capable of processing the first task corresponding to the first user utterance acquired by the electronic device 600, but is not limited thereto.

According to various embodiments, the electronic device 600 (for example, the processor 160 of FIG. 1) may identify an additional task corresponding to the first user utterance using first context information and second context information on the basis of identification of predetermined information on the second user utterance from the first context information. The predetermined information on the user utterance is information preset in the electronic device 600 to perform an additional task and may include, for example, user utterance text information or may include at least one of a domain, an intent, or a parameter for the user utterance. The first context information may include information on processing of the second user utterance (for example, a final user utterance), and the second context information may include device-related information of the electronic device 600. In this case, it is premised that the first user utterance is a follow-up utterance of the second user utterance. According to an embodiment, the electronic device 600 may identify the additional task corresponding to the first user utterance using information on the result of a second task corresponding to a second user utterance and device-related information of the electronic device 600 on the basis of a specific domain for the second user utterance corresponding to a predetermined domain. For example, the electronic device 600 (for example, a smart refrigerator) may identify the additional task (for example, displaying prepared ingredients and unprepared ingredients of a recipe) corresponding to the first user utterance using information on the result of the task corresponding to a final user utterance (for example, a recipe found by a recipe search app) and device-related information of the electronic device 600 (for example, ingredient information within the electronic device 600) on the basis of the domain (for example, the recipe app) for the final user utterance corresponding to the predetermined domain (for example, the recipe app).

In operation 511, according to various embodiments, the electronic device 600 (for example, the processor 160 of FIG. 1) may perform the first task corresponding to the first user utterance on the basis of the analysis result of the first user utterance. According to an embodiment, the electronic device 600 may perform the identified first task by applying at least some of the first context information to the first user utterance. For example, referring to FIG. 6, the electronic device 600 may perform the identified first task (for example, outputting information on weather in Seoul today through a speaker and a display) by applying information on the domain (for example, a weather application) and the intent (for example, a weather search) for the final user utterance included in the first context information to the first user utterance (for example, “Seoul?”) in step 622. According to an embodiment, the electronic device 600 may perform the first task and the additional task corresponding to the first user utterance on the basis of the analysis result of the first user utterance.

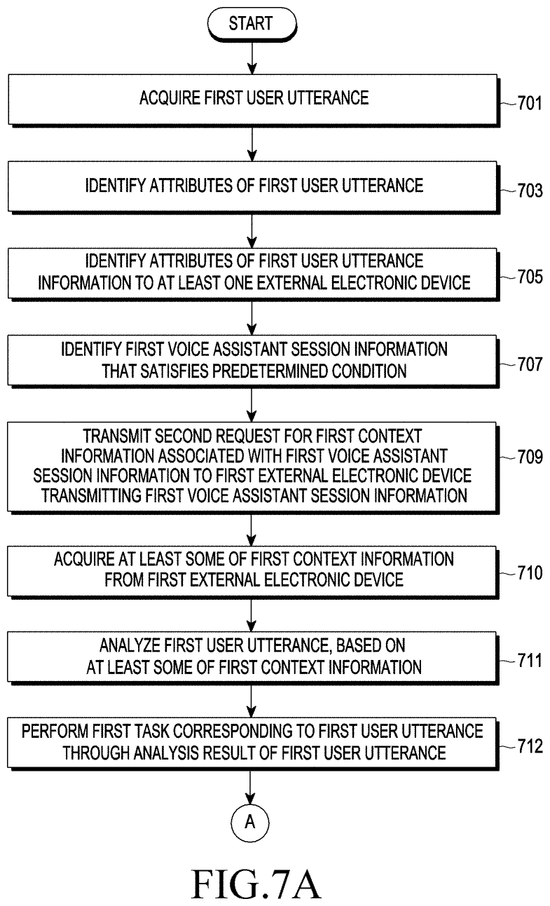

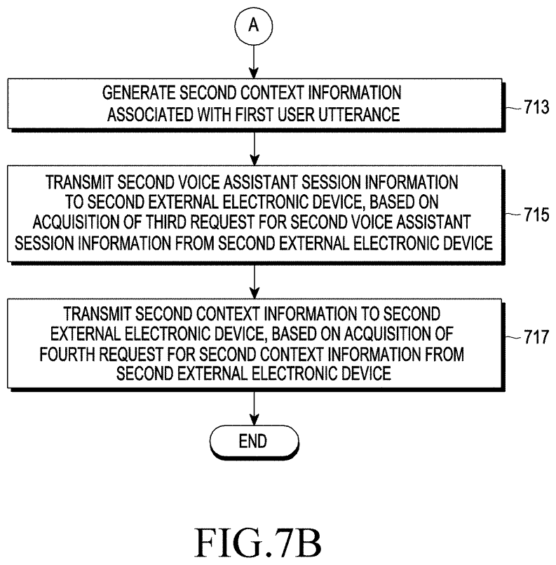

FIG. 7A illustrates a flowchart of a method by which an electronic device (for example, the electronic device 600 of FIG. 6) analyzes a first user utterance on the basis of first context information and performs a first task corresponding to the first user utterance.

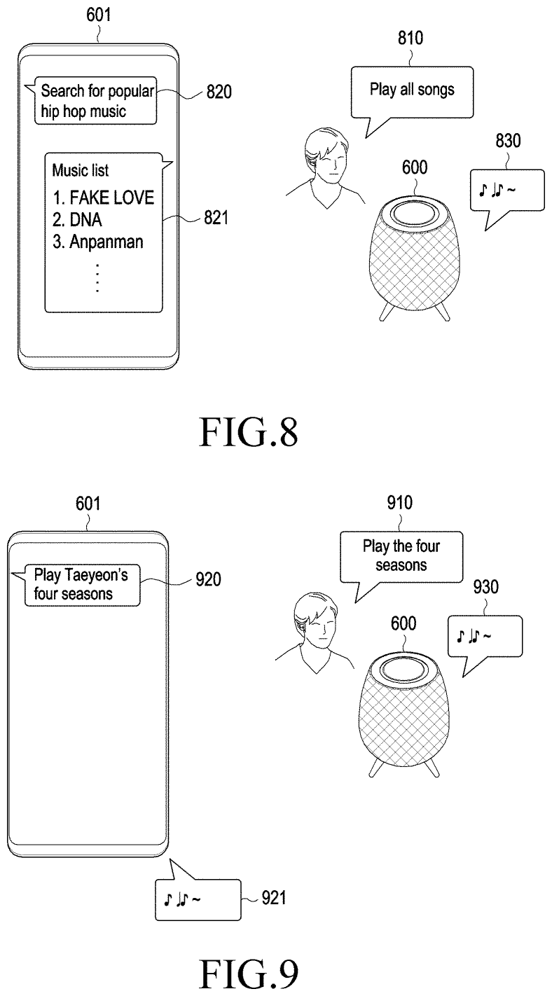

FIG. 8 illustrates a first embodiment in which the electronic device 600 performs a first task corresponding to a first user utterance according to various embodiments.

FIG. 9 illustrates a second embodiment in which the electronic device 600 performs a first task corresponding to a first user utterance according to various embodiments.

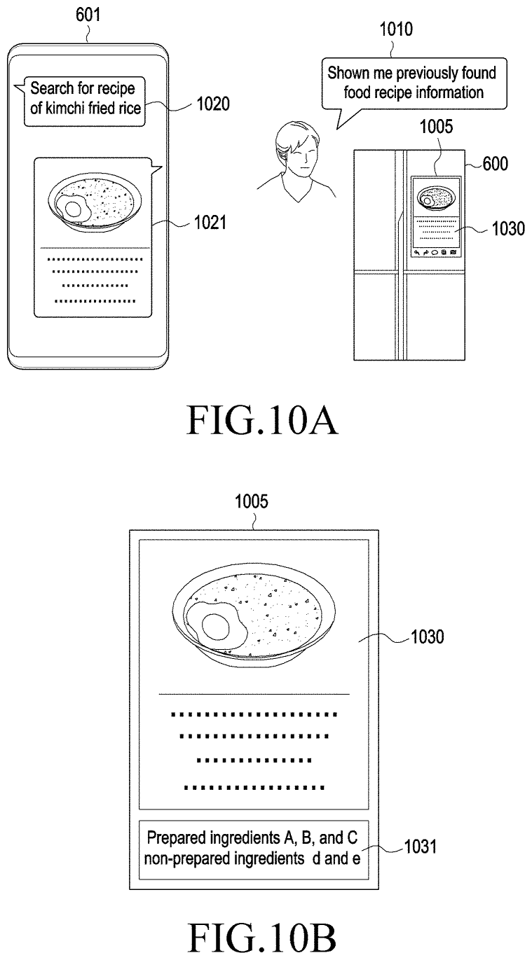

FIG. 10A illustrates a third embodiment in which the electronic device 600 performs a first task corresponding to a first user utterance according to various embodiments.

FIG. 10B illustrates an embodiment in which the electronic device 600 performs a first task and an additional task corresponding to a first user utterance according to various embodiments.

In operation 701, according to various embodiments, the electronic device 600 (for example, the processor 160 of FIG. 1) may acquire a first user utterance through a microphone (for example, the microphone 120 of FIG. 1) after executing an intelligent agent (for example, the intelligent agent 440 of FIG. 4). For example, referring to FIG. 8, the electronic device 600 may acquire a first user utterance 810 (for example, “Play all songs”). In another example, referring to FIG. 9, the electronic device 600 may acquire a first user utterance 910 (for example, “Play the four seasons”). In another example, referring to FIG. 10A, the electronic device 600 may acquire a first user utterance 1010 (for example, “Show me previously found food recipe information”).

According to various embodiments, the electronic device 600 (for example, the processor 160 of FIG. 1) may analyze the first user utterance in response to acquisition of the first user utterance. According to an embodiment, the electronic device 600 may identify at least one of a domain, an intent, or a parameter for the first user utterance by analyzing the first user utterance through a natural language platform (for example, the natural language platform 430 of FIG. 4).

In operation 703, according to various embodiments, the electronic device 600 (for example, the processor 160 of FIG. 1) may identify attributes of the first user utterance. According to an embodiment, the electronic device 600 may identify whether the attributes of the first user utterance correspond to an incomplete utterance as the analysis result of the first user utterance. According to an embodiment, the electronic device 600 may identify that the attributes of the first user utterance correspond to an incomplete utterance as the analysis result of the first user utterance on the basis of non-identification of at least one of a domain, an intent, or a mandatory parameter for the first user utterance.

For example, referring to FIG. 8, the electronic device 600 may identify a domain (for example, a music application) and an intent (for example, music playback) for the first user utterance 810 by analyzing the first user utterance 810 (for example, “Play all songs”) and may know that a mandatory parameter (for example, a music list to be played) for the first user utterance 810 is not identified. In this case, the electronic device 600 may identify that the attributes of the first user utterance 810 correspond to an incomplete utterance.

In another example, referring to FIG. 9, the electronic device 600 may identify a domain (for example, a music application) and an intent (for example, music playback) for the first user utterance 910 by analyzing the first user utterance 910 (for example, “Play the four seasons”) and may know that the mandatory parameter (for example, a singer) for the first user utterance 910 is not identified. In this case, the electronic device 600 may identify that the attributes of the first user utterance 910 correspond to an incomplete utterance.

In another example, referring to FIG. 10A, the electronic device 600 may identify a domain (for example, a “recipe” as a category or a “recipe search application or function” as a program) and an intent (for example, a recipe search) for the first user utterance 1010 by analyzing the first user utterance 1010 (for example, “Show me previously found food recipe information”) and may know that a mandatory parameter (for example, a recipe menu) for the first user utterance 1010 is not identified. In this case, the electronic device 600 may identify that the attributes of the first user utterance 1010 correspond to an incomplete utterance.

According to an embodiment, the electronic device 600 may identify that the attributes of the first user utterance correspond to an incomplete utterance on the basis of the analysis result of the first user utterance in response to at least some of the first user utterance corresponding to a predetermined expression indicating an incomplete utterance. For example, referring to FIG. 10A, the electronic device 600 may identify that the attributes of the first user utterance 1010 correspond to an incomplete utterance on the basis of the first user utterance 1010 including a predetermined expression (for example, “previously found”) by analyzing the first user utterance 1010 (for example, “Show me previously found food recipe information”).

According to various embodiments, the electronic device 600 (for example, the processor 160 of FIG. 1) may omit operation 703 corresponding to the operation of identifying the attributes of the first user utterance or perform operation 703 after performing another operation. For example, the electronic device 600 may complete operation 703 before performing operation 711 or may perform operation 703 while the first user utterance is analyzed in operation 711.

In operation 705, according to various embodiments, the electronic device 600 (for example, the processor 160 of FIG. 1) may transmit a first request for voice assistant session information to at least one external electronic device through a communication interface (for example, the communication interface 110 of FIG. 1). For example, referring to FIGS. 8, 9, and 10A, the electronic device 600 may transmit the first request for the voice assistant session information to the first external electronic device 601 and a second external electronic device (not shown) (for example, the second external electronic device 602 of FIG. 6).

The electronic device 600 (for example, the processor 160 of FIG. 1) according to various embodiments may acquire voice assistant session information from each of at least one external electronic device through the communication interface 110. For example, referring to FIGS. 8, 9, and 10A, the electronic device 600 may acquire voice assistant session information indicating a voice assistant session executed by the first external electronic device 601 from the first external electronic device 601 and acquire voice assistant session information indicating a voice assistant session executed by the second external electronic device (not shown) from the second external electronic device (not shown).

According to various embodiments, the electronic device 600 (for example, the processor 160 of FIG. 1) may perform operation 703 of identifying the attributes of the first user utterance after acquiring the voice assistant session information. According to an embodiment, the electronic device 600 may identify whether the attributes of the first user utterance correspond to an incomplete utterance on the basis of the voice assistant session information acquired from the first external electronic device 601.

In operation 707, according to various embodiments, the electronic device 600 (for example, the processor 160 of FIG. 1) may identify first voice assistant session information that satisfies a predetermined condition.

According to various embodiments, the electronic device 600 (for example, the processor 160 of FIG. 1) may identify voice assistant session information indicating that the voice assistant session is activated as the first voice assistant session information that satisfies the predetermined condition. For example, referring to FIG. 8, the electronic device 600 may identify that voice assistant session information acquired from the first external electronic device 601 indicates that the voice assistant session is activated and identify the voice assistant session information acquired from the first external electronic device 601 as the first voice assistant session information that satisfies the predetermined condition.

According to various embodiments, the electronic device 600 (for example, the processor 160 of FIG. 1) may identify voice assistant session information including final user utterance information corresponding to at least one of a domain, an intent, or a mandatory parameter for the first user utterance as the first voice assistant session information that satisfies the predetermined condition. According to an embodiment, the electronic device 600 may identify the voice assistant session information including the corresponding final user utterance as the first voice assistant session information that satisfies the predetermined condition on the basis of at least one of the domain, the intent, or the parameter for the first user utterance corresponding to at least one of the domain, the intent, or the parameter for the final user utterance. The domain or the intent for the final user utterance corresponding to the domain or the intent for the first user utterance may be a domain or an intent that is the same as the domain or the intent for the first user utterance, a domain or an intent that is compatible with the domain or the intent for the first user utterance, or a domain or an intent capable of processing a task corresponding to the first user utterance acquired by the electronic device 600, but is not limited thereto. For example, referring to FIG. 9, when the domain and the intent for the first user utterance 910 (for example, “Play the four seasons”) analyzed by the electronic device 600 indicate a “music application” and “music playback” and voice assistant session information indicating that the domain and the intent for the final user utterance 920 (for example, “Play Taeyeon's four seasons”) are the “music application” and the “music playback” is acquired from the first external electronic device 601, the electronic device 600 may identify the voice assistant session information acquired from the first external electronic device 601 as the first voice assistant session information that satisfies the predetermined condition. According to an embodiment, a second domain for the final user utterance corresponding to the first domain for the first user utterance may have a version that is the same as a version of the first domain, a version of a domain compatible with the version of the first domain, or a version of a domain capable of performing a task corresponding to the first user utterance acquired by the electronic device 600, but is not limited thereto.

According to various embodiments, the electronic device 600 (for example, the processor 160 of FIG. 1) may identify voice assistant session information indicating that context history information is possessed as the first voice assistant session information that satisfies the predetermined condition. For example, referring to FIG. 9, when the electronic device 600 acquires the voice assistant session information indicating that the context history information is possessed from the first external electronic device 601, the electronic device 600 may identify the voice assistant session information acquired from the first external electronic device 601 as the first voice assistant session information that satisfies the predetermined condition.

According to various embodiments, the electronic device 600 (for example, the processor 160 of FIG. 1) may identify the first voice assistant session information that satisfies the predetermined condition on the basis of the voice assistant session information acquired from the external electronic device. According to an embodiment, the electronic device 600 may identify voice assistant session information acquired from at least one external electronic device 601 and/or 602 as the first voice assistant session information that satisfies the predetermined condition on the basis of at least one piece of information indicating that the voice assistant session is activated, information on whether a final utterance time corresponds to a predetermined time, domain state information of the voice assistant session, or result information of a task of the voice assistant session. For example, referring to FIG. 8, when the voice assistant session information acquired from the first external electronic device 601 indicates that the voice assistant session is activated, indicates that a time associated with the second user utterance 820 (for example, a final user utterance) is within a predetermined time from a time at which the electronic device 600 acquires the first user utterance 810, and indicates that the voice assistant session displays a current music list search result 821, the electronic device 600 may identify the voice assistant session information acquired from the first external electronic device 601 as the first voice assistant session information that satisfies the predetermined condition. In another example, referring to FIG. 10A, when the voice assistant session information acquired from the first external electronic device 601 indicates that the voice assistant session is activated and indicates that the voice assistant session displays a current recipe search result 1021, the electronic device 600 may identify the voice assistant session information acquired from the first external electronic device 601 as the first voice assistant session information that satisfies the predetermined condition. A method of identifying the first voice assistant session information that satisfies the predetermined condition on the basis of the voice assistant session information is not limited to the above-described example and may identify voice assistant session information acquired from the external electronic device as the first voice assistant session information that satisfies the predetermined condition on the basis of a condition setting scheme of a user or a manufacturer for at least one element included in the voice assistant session information of [Table 1].

In operation 709, according to various embodiments, the electronic device 600 (for example, the processor 160 of FIG. 1) may transmit a second request for first context information associated with the first voice assistant session information to the first external electronic device 601 transmitting the first voice assistant session information that satisfies the predetermined condition through the communication interface 110.

According to an embodiment, the second request for first context information transmitted to the first external electronic device 601 may include an entity that is not identified in the domain, the intent, or the mandatory parameter for the first user utterance. For example, referring to FIG. 9, the electronic device 600 may transmit the second request for the mandatory parameter (for example, a singer) that is not identified for the first user utterance 910 to the first external electronic device 601.

According to an embodiment, the second request for the first context information which the electronic device 600 transmits to the first external electronic device 601 may include an entity that is identified in the domain, the intent, or the mandatory parameter for the first user utterance. For example, referring to FIG. 9, the electronic device 600 may transmit the second request including the domain (for example, a music application), the intent (for example, music playback), and the mandatory parameter (for example, a song title (four seasons)) for the first user utterance 910 to the first external electronic device 601.

In operation 710, according to various embodiments, the electronic device 600 (for example, the processor 160 of FIG. 1) may acquire at least some of the first context information from the first external electronic device 601.

According to various embodiments, at least some of the first context information may include information associated with a second user utterance processed by the first external electronic device 601 during a voice assistant session indicated by the voice assistant session information acquired from the first external electronic device. The second user utterance may be a final user utterance among at least one user utterance processed by the first external electronic device 601, and the first user utterance may be a follow-up utterance of the second user utterance. According to an embodiment, the information associated with the second user utterance may include at least one piece of (1) the user utterance text information for the context information of FIG. 4, (2) information on at least one of the domain, the intent, or the parameter, (3) information on the result of a task, (4) domain state information, or (5) domain history information. For example, referring to FIG. 8, the electronic device 600 may acquire first context information including information on the result (for example, a music list found by a music application or a search result API) of the found music list by a second task 821 (for example, outputting the music list found by the music application) corresponding to the second user utterance 820 (for example, “Search for popular hip hop music”) or domain state information (for example, screen state information of the music application displaying the found music list) corresponding to the second user utterance 820 from the first external electronic device 601. In another example, referring to FIG. 9, the electronic device 600 may acquire first context information including information on the result (for example, a media ULR found by a music application) of media data found by a second task 921 (for example, outputting media data found by the music application through a speaker and a display) corresponding to the second user utterance 920 (for example, “Play Taeyeon's four seasons”) or domain state information (for example, screen state information of the music application displaying the found media data) corresponding to the second user utterance 920 from the first external electronic device 601. In another example, referring to FIG. 10A, the electronic device 600 may acquire first context information including information on the result (for example, a recipe found by a recipe search application, a search result API, or a search recipe URL) of a second task 1021 (for example, outputting a recipe for kimchi fried rice found by the recipe search application) corresponding to the second user utterance 1020 (for example, “Search for a recipe for kimchi fried rice”) or domain state information (for example, screen state information of the recipe search application displaying the found recipe) corresponding to the second user utterance 1020 from the first external electronic device 601.

According to an embodiment, at least some of the first context information may include at least one of the domain, the intent, or the mandatory parameter for the second user utterance processed by the first external electronic device 601. For example, referring to FIG. 9, the electronic device 600 may acquire first context information including a mandatory parameter (for example, a singer (Taeyeon)) for the second user utterance 920 from the first external electronic device 601. In this case, the first external electronic device 601 may transmit the first context information to the electronic device 600 on the basis of information included in the second request acquired from the electronic device 600. For example, referring to FIG. 9, when the first external electronic device 601 transmits voice assistant session information including information on the final user utterance 920 (for example, the second user utterance) to the electronic device 600 and acquires the second request for a mandatory parameter (for example, a singer) for the first user utterance 910 from the electronic device 600, the first external electronic device 601 may transmit the mandatory parameter (for example, the singer (Taeyeon)) identified from the final user utterance 920 to the electronic device 600. In another example, referring to FIG. 9, when the first external electronic device 601 transmits voice assistant session information indicating that context history information is possessed to the electronic device 600 and acquires the second request including the domain (for example, the music application), the intent (for example, music playback), and the mandatory parameter (for example, the song title (four seasons)) identified for the first user utterance 910 from the electronic device 600, the first external electronic device 601 may transmit the mandatory parameter (for example, the singer (Taeyeon)) for the second user utterance 920 corresponding to the first user utterance 910 in the context history information to the electronic device 600.

In operation 711, according to various embodiments, the electronic device 600 (for example, the processor 160 of FIG. 1) may analyze the first user utterance on the basis of at least some of the first context information.

According to an embodiment, the electronic device 600 may identify a first task corresponding to the first user utterance as the analysis result of the first user utterance on the basis of at least some of the first context information. For example, referring to FIG. 8, the electronic device 600 may identify a first task 830 (for example, playing all songs in a found music list) corresponding to the first user utterance 810 by applying the result of the task (for example, the music list found by the music application or a search result API) that corresponds to at least some of the first context information acquired from the first external electronic device to the first user utterance 810 or identify the first task 830 (for example, playing all songs in the list after displaying a screen for the found music list through execution of the music application) corresponding to the first user utterance 810 by applying domain state information (for example, screen state information of the music application displaying the found music list) that corresponds to at least some of the first context information to the first user utterance 810. In another example, referring to FIG. 9, the electronic device 600 may identify a first task 930 (for example, playing Taeyeon's four seasons) corresponding to the first user utterance 910 by applying the parameter (for example, the singer (Taeyeon)) for the second user utterance 920 that corresponds to at least some of the first context information acquired from the first external electronic device 601 to the first user utterance 910 or identify the first task 930 (for example, playing Taeyeon's four seasons) corresponding to the first user utterance 910 by applying the result of the task (for example, a media URL found by the music application) that corresponds to at least some of the first context information to the first user utterance 910. In another example, referring to FIG. 10A, the electronic device 600 may identify a first task 1030 (for example, outputting a recipe for kimchi fried rice in a recipe search application through a display 1005) corresponding to the first user utterance 1010 by applying the result of the task (for example, a recipe found by the recipe search application, a search result API, or a found recipe URL) that corresponds to at least some of the first context information acquired from the first external electronic device 601 to the first user utterance 1010. According to an embodiment, operation 711 premises that the domain for the second user utterance 820, 920, or 1020 corresponds to the domain for the first user utterance 810, 910, or 1010. According to an embodiment, the domain for the second user utterance 820, 920, or 1020 corresponding to the domain for the first user utterance 810, 910, or 1010 may be a domain that is the same as the domain for the first user utterance 810, 910, or 1010, a domain compatible with the domain for the first user utterance 810, 910, or 1010, or a domain capable of processing the first task 830, 930, or 1030 corresponding to the first user utterance 810, 910, or 1010 acquired from the electronic device 600, but is not limited thereto.

According to various embodiments, the electronic device 600 (for example, the processor 160 of FIG. 1) may identify an additional task 1031 corresponding to the first user utterance 1010 using first context information and second context information on the basis of identification of predetermined information on the second user utterance 1020 from the first context information. The first context information may include information on processing of the second user utterance 1020, and the second context information may include device-related information of the electronic device 600. According to an embodiment, the electronic device 600 may identify the additional task 1031 corresponding to the first user utterance 1010 using information on the result of the task 1021 corresponding to the second user utterance 1020 and device-related information of the electronic device 600 on the basis of the domain for the second user utterance 1020 corresponding to a predetermined domain. For example, referring to FIG. 10B, the electronic device 600 (for example, a smart refrigerator) may identify the additional task 1031 (for example, outputting prepared ingredients and non-prepared ingredients among the ingredients of the recipe through the display 1005) corresponding to the first user utterance 1010 using information on the result of the task 1021 (for example, a recipe found by a recipe search app) corresponding to the second user utterance 1020 and device-related information of the electronic device 600 (for example, ingredient information within the electronic device 600) on the basis of the domain (for example, the recipe app) for the second user utterance 1020 corresponding to a predetermined domain (for example, the recipe app).

In operation 712, according to various embodiments, the electronic device 600 (for example, the processor 160 of FIG. 1) may perform the first task corresponding to the first user utterance on the basis of the analysis result of the first user utterance. According to an embodiment, the electronic device 600 may perform the identified first task by applying at least some of the first context information to the first user utterance. According to an embodiment, the electronic device 600 may perform the first task and the additional task corresponding to the first user utterance on the basis of the analysis result of the first user utterance. For example, referring to FIG. 10B, the electronic device 600 may perform the first task 1030 and the additional task 1031 corresponding to the first user utterance 1010 on the basis of the analysis result of the first user utterance 1010.

FIG. 7B illustrates a flowchart of a method by which the electronic device 600 transmits second context information to the second external electronic device according to various embodiments.

In operation 713, according to various embodiments, the electronic device 600 (for example, the processor 160 of FIG. 1) may generate second context information associated with a first user utterance. According to an embodiment, the electronic device 600 may generate second context information on the basis of the analysis result of the first user utterance and the result of a first task corresponding to the first user utterance. For example, referring to FIG. 8, the electronic device 600 may generate second context information, and the second context information may include the domain (for example, a music application), the intent (for example, music playback), and the mandatory parameter (for example, all songs within a found music list) for the first user utterance 810 (for example, “Play all songs”), and may include information on the result (for example, a music play list or a play API by the music application) of the first task 830 (for example, playing all songs within the found music list). In this case, the music play list or the play API may be a list of songs that have been played and will be played or an API as all music files within the found music list. The second context information generated by the electronic device 600 on the basis of the first user utterance is not limited to the example, and may include at least some of the context information described with reference to FIG. 4.

In operation 715, according to various embodiments, the electronic device 600 (for example, the processor 160 of FIG. 1) may transmit second voice assistant session information to the second external electronic device on the basis of acquisition of a third request for the second voice assistant session information from the second external electronic device. According to an embodiment, the electronic device 600 may transmit second voice assistant session information for a voice assistant session ended by the electronic device 600 or a voice assistant session currently activated by the electronic device 600 to the second external electronic device. The second voice assistant session information transmitted by the electronic device 600 may include the voice assistant session information described in operation 505.

In operation 717, according to various embodiments, the electronic device 600 (for example, the processor 160 of FIG. 1) may transmit at least some of second context information to the second external electronic device on the basis of acquisition of a fourth request for the second context information from the second external electronic device.

According to various embodiments, the electronic device 600 may transmit at least some of the second context information to the second external electronic device on the basis of information included in the fourth request acquired from the second external electronic device. According to an embodiment, when the fourth request for an element of the first user utterance (for example, some of the context information of FIG. 4) processed by the electronic device 600 is acquired from the second external electronic device, the electronic device 600 may transmit the element of the first user utterance to the second external electronic device as the second context information. For example, referring to FIG. 8, when the fourth request for the result of the first task performed by the electronic device 600 is acquired from the second external electronic device (not shown), the electronic device 600 may transmit information on the result of the first task 830 (for example, a music play list or a play API by a music application) corresponding to the first user utterance 810 to the second external electronic device (not shown) as at least some of the second context information. In another example, referring to FIG. 8, when the fourth request for domain state information corresponding to the first user utterance 810 processed by the electronic device 600 is acquired from the second external electronic device (not shown), the electronic device 600 may transmit the domain state information corresponding to the first user utterance 810 (for example, information on a song being played by the music application at a time point at which the second context information is generated or transmitted) to the second external electronic device (not shown) as at least some of the second context information. According to various embodiments, the second context information transmitted to the second external electronic device is not limited to the example and may include at least some of the context information described with reference to FIG. 4. According to an embodiment, the electronic device 600 may determine at least some of the second context information to be transmitted to the second external electronic device on the basis of a transmission scheme preset in the electronic device 600 as well as information included in the request acquired from the second external electronic device.

According to various embodiments, the electronic device 600 (for example, the processor 160 of FIG. 1) may process at least some of the second context information and transmit the same to the second external electronic device. According to an embodiment, the electronic device 600 may process a format of the second context information to be a form that can be executed by the second external electronic device and then transmit at least some of the processed second context information to the second external electronic device.

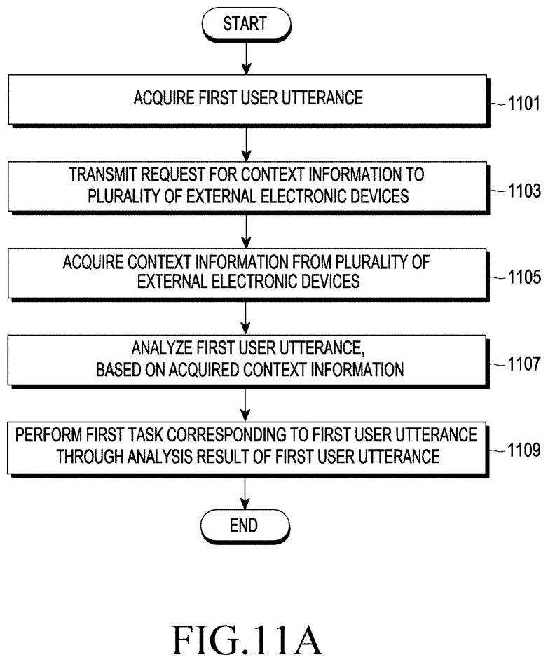

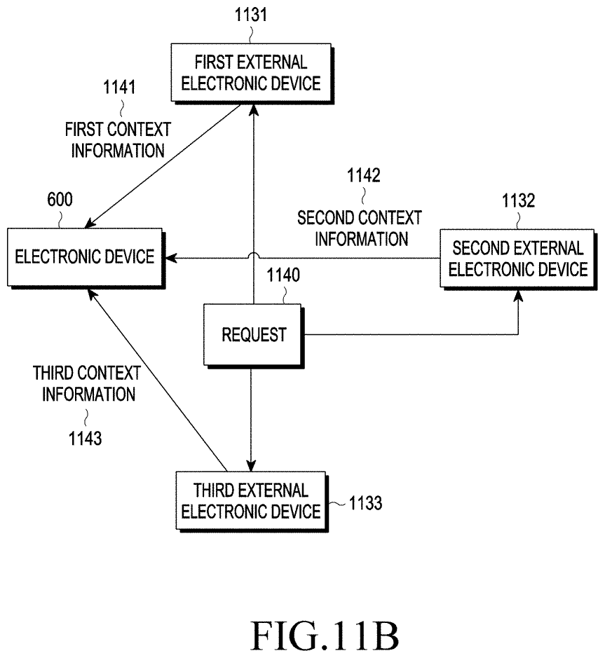

FIG. 11A illustrates a flowchart of a method by which an electronic device (for example, the electronic device 600 of FIG. 6) analyzes a first user utterance on the basis of context information (for example, first context information 1141, second context information 1142, and third context information 1143 of FIG. 11B) acquired from a plurality of external electronic devices (for example, a first external electronic device 1131, a second external electronic device 1132, and a third external electronic device 1133 of FIG. 11B) and performs a first task corresponding to a first user utterance according to various embodiments.

FIG. 11B illustrates an embodiment in which the electronic device 600 transmits a request 1140 for context information and acquires context information 1141, 1142, and 1143 from the plurality of external electronic devices 1131, 1132, and 1133.

In operation 1101, according to various embodiments, the electronic device 600 (for example, the processor 160 of FIG. 1) may acquire a first user utterance through a microphone (for example, the microphone 120 of FIG. 1) after executing an intelligent agent (for example, the intelligent agent 440 of FIG. 4).

In operation 1103, according to various embodiments, the electronic device 600 (for example, the processor 160 of FIG. 1) may transmit the request 1140 for context information to the plurality of external electronic devices 1131, 1132, and 1133. For example, referring to FIG. 11B, the electronic device 600 may transmit the request 1140 for the context information to the plurality of external electronic devices 1131, 1132, and 1133 in a broadcast, multicast, or unicast type.

According to various embodiments, the electronic device 600 (for example, the processor 160 of FIG. 1) may establish a short-range wireless communication connection with the plurality of external electronic devices 1131, 1132, and 1133. According to an embodiment, the electronic device 600 may establish the short-range wireless communication connection (for example, Bluetooth, Wi-Fi direct, or IrDA) with the plurality of external electronic devices 1131, 1132, and 1133 through a communication interface (for example, the communication interface 110 of FIG. 1) including a short-range wireless communication interface. According to an embodiment, the electronic device 600 may acquire a user utterance in the state in which the short-range wireless communication connection is established with the plurality of external electronic devices 1131, 1132, and 1133. According to various embodiments, each of the plurality of external electronic devices 1131, 1132, and 1133 may perform functions of the elements included in the user terminal 100 of FIG. 1. According to an embodiment, each of the plurality of external electronic devices 1131, 1132, and 1133 may analyze a user utterance like the user terminal 100 or the electronic device 600, and may be a device in the on-device form for performing a task corresponding to a user utterance on the basis of the analysis result of the user utterance. According to an embodiment, each of the plurality of external electronic devices 1131, 1132, and 1133 may operate equally to at least one external electronic device (for example, the first external electronic device 601 and/or the second external electronic device 602 of FIG. 6) described in operation 503 of FIG. 5. For example, referring to FIG. 11B, the first external electronic device 1131 may be a device that establishes a short-range wireless communication connection with the electronic device 600, the second external electronic device 1132 may be a device that is accessed with the same user account as the electronic device 600, and the third external electronic device 1133 may be a device that is preregistered in the electronic device 600 on the basis of a specific communication scheme.

According to various embodiments, the electronic device 600 (for example, the processor 160 of FIG. 1) may transmit the request 1140 for context information to the plurality of external electronic devices 1131, 1132, and 1133 in response to acquisition of the first user utterance. According to an embodiment, the electronic device 600 may transmit the request 1140 including messages inquiring about whether a voice assistant session is activated to external electronic devices (not shown) associated with the electronic device 600 in response to acquisition of the first user utterance.

In operation 1105, according to various embodiments, the electronic device 600 (for example, the processor 160 of FIG. 1) may acquire context information 1141, 1142, and 1143 from the plurality of external electronic devices 1131, 1132, and 1133. For example, referring to FIG. 11B, the electronic device 600 may acquire first context information 1141 from the first external electronic device 1131, acquire second context information 1142 from the second external electronic device 1132, and acquire third context information 1143 from the third external electronic device 1133. According to an embodiment, each of the first context information 1141, the second context information 1142, and the third context information 1143 may include information associated with a final user utterance processed by the corresponding external electronic device as the context information described with reference to FIG. 4. According to an embodiment, the electronic device 600 may acquire the context information 1141, 1142, and 1143 from the plurality of external electronic devices 1131, 1132, and 1133 in which the voice assistant session is activated.

In operation 1107, according to various embodiments, the electronic device 600 (for example, the processor 160 of FIG. 1) may analyze a first user utterance on the basis of the acquired context information 1141, 1142, and 1143. According to an embodiment, the electronic device 600 may identify a domain, an intent, and a parameter for the first user utterance by analyzing the first user utterance through a natural language platform (for example, the natural language platform 430 of FIG. 4).

According to various embodiments, the electronic device 600 (for example, the processor 160 of FIG. 1) may identify specific context information associated with the first user utterance as the analysis result of the first user utterance among the acquired context information 1141, 1142, and 1143. According to an embodiment, the electronic device 600 may identify context information indicating the electronic device 600 as an executor device among the acquired context information 1141, 1142, and 1143 as the specific context information associated with the first user utterance. For example, when information on the executor device included in the first context information 1141 indicates the electronic device 600, the electronic device 600 may identify the first context information 1141 as the specific context information associated with the first user utterance. According to an embodiment, the electronic device 600 may identify context information including information on a final user utterance corresponding to at least one of the domain, the intent, or the parameter for the first user utterance among the acquired context information 1141, 1142, and 1143 as the specific context information associated with the first user utterance. For example, when the domain for the final user utterance included in the first context information 1141 corresponds to (for example, is the same as or is compatible with) the domain for the first user utterance, the electronic device 600 may identify the first context information 1141 as the specific context information associated with the first user utterance.

According to various embodiments, the electronic device 600 (for example, the processor 160 of FIG. 1) may identify a type of the first user utterance as the analysis result of the first user utterance on the basis of the specific context information associated with the first user utterance. According to an embodiment, the electronic device 600 may identify the analysis result of the final user utterance included in the specific context information and identify whether the type of the first user utterance is a follow-up utterance of the final user utterance on the basis of the analysis result of the final user utterance.

According to various embodiments, the electronic device 600 (for example, the processor 160 of FIG. 1) may identify a first task corresponding to the first user utterance as the analysis result of the first user utterance on the basis of at least some of the specific context information. According to an embodiment, the electronic device 600 may perform the operation through the method described in operation 509 of FIG. 5 or operation 711 of FIG. 7A.

In operation 1109, according to various embodiments, the electronic device 600 (for example, the processor 160 of FIG. 1) may perform the first task corresponding to the first user utterance on the basis of the analysis result of the first user utterance. According to an embodiment, the electronic device 600 may perform the identified first task by applying at least some of the specific context information to the first user utterance.

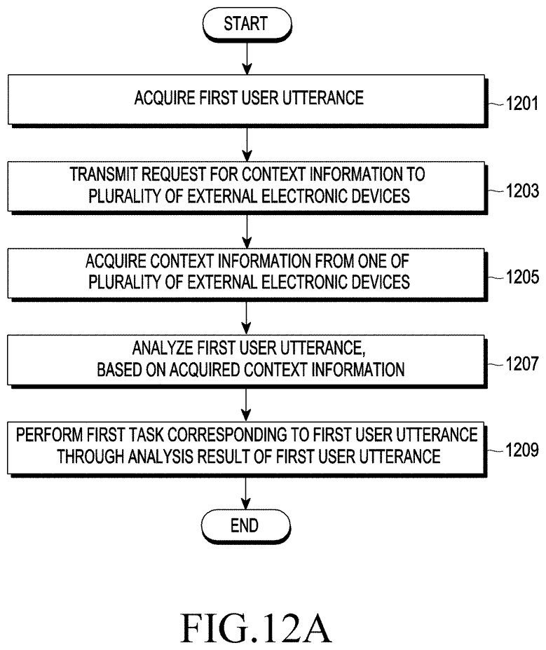

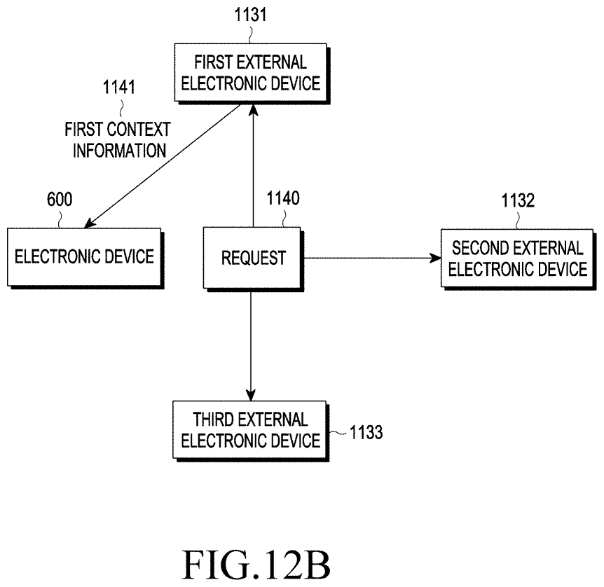

FIG. 12A illustrates a flowchart of a method by which an electronic device (for example, the electronic device 600 of FIG. 6) analyzes a first user utterance on the basis of first context information (for example, the first context information 1141 of FIG. 11B) acquired from a first external electronic device (for example, the first external electronic device 1131 of FIG. 11B) and performs a first task corresponding to the first user utterance according to various embodiments.

FIG. 12B illustrates an embodiment in which the electronic device 600 transmits a request 1140 for context information and acquires the first context information 1141 from the first external electronic device 1131 according to various embodiments.

In operation 1201, according to various embodiments, the electronic device 600 (for example, the processor 160 of FIG. 1) may acquire a first user utterance through a microphone (for example, the microphone 120 of FIG. 1) after executing an intelligent agent (for example, the intelligent agent 440 of FIG. 4).

According to various embodiments, the electronic device 600 (for example, the processor 160 of FIG. 1) may analyze the first user utterance in response to acquisition of the first user utterance. According to an embodiment, the electronic device 600 may identify at least one of a domain or an intent for the first user utterance by analyzing the first user utterance through a natural language platform (for example, the natural language platform 430 of FIG. 4).

In operation 1203, according to various embodiments, the electronic device 600 (for example, the processor 160 of FIG. 1) may transmit the request 1140 for context information to the plurality of external electronic devices 1131, 1132, and 1133. For example, referring to FIG. 12B, the electronic device 600 may transmit the request 1140 for the context information to the plurality of external electronic devices 1131, 1132, and 1133 in a broadcast, multicast, or unicast type. According to an embodiment, the electronic device 600 may transmit the request 1140 including at least one of the domain or the intent for the first user utterance. According to an embodiment, the electronic device 600 may transmit the request 1140 including a message inquiring about whether a voice assistant session is activated. According to an embodiment, each of the electronic device 600 and the plurality of external electronic devices 1131, 1132, and 1133 may perform operation 1203 through the method described in operation 1103 of FIG. 11A.

In operation 1205, according to various embodiments, the electronic device 600 (for example, the processor 160 of FIG. 1) may acquire context information from one of the plurality of external electronic devices 1131, 1132, and 1133.

According to various embodiments, the electronic device 600 (for example, the processor 160 of FIG. 1) may acquire context information from the external electronic device including information on the final user utterance corresponding to at least one of the domain or the intent for the first user utterance. For example, referring to FIG. 12B, the first external electronic device 1131 may identify the domain for the first user utterance included in the request 1140 acquired from the electronic device 600, and when the domain for the final user utterance of the first external electronic device 1131 corresponds to the domain for the first user utterance, transmit the first context information 1141 associated with the final user utterance of the first external electronic device 1131 to the electronic device 600. In another example, referring to FIG. 12B, the second external electronic device 1132 may identify the domain for the first user utterance included in the request 1140 acquired from the electronic device 600 and, when the domain for the final user utterance of the second external electronic device 1132 does not correspond to the domain for the first user utterance, may ignore the acquired request 1140.

According to various embodiments, the electronic device 600 (for example, the processor 160 of FIG. 1) may acquire context information from the external electronic device in which the voice assistant session is activated. For example, referring to FIG. 12B, the first external electronic device 1131 may identify a message inquiring about whether the voice assistants session is activated, included in the request 1140 acquired from the electronic device 600 and, when the voice assistant session of the first external electronic device 1131 is activated, transmit the first context information 1141 associated with a final user utterance of the first external electronic device 1131 to the electronic device 600. In another example, referring to FIG. 12B, the second external electronic device 1132 may identify a message inquiring about whether the voice assistant session is activated, included in the request 1140 acquired from the electronic device 600 and, when the voice assistant session of the second external electronic device 1132 is not activated, ignore the acquired request 1140. According to an embodiment, the electronic device 600 may include information on the final user utterance corresponding to at least one of the domain or the intent for the first user utterance and acquire context information from the external electronic device in which the voice assistant session is activated. According to an embodiment, each of the electronic device 600 and the plurality of external electronic devices 1131, 1132, and 1133 may perform operation 1205 through the method described in operation 1105 of FIG. 11A.

In operation 1207, according to various embodiments, the electronic device 600 (for example, the processor 160 of FIG. 1) may analyze the first user utterance on the basis of the acquired context information. According to an embodiment, the electronic device 600 may analyze the first user utterance and additionally analyze the first user utterance on the basis of the acquired context information in operation 1201 so as to identify the domain, the intent, and the parameter for the first user utterance.

According to various embodiments, the electronic device 600 (for example, the processor 160 of FIG. 1) may identify that the type of the first user utterance corresponds to a follow-up utterance as the analysis result of the first user utterance on the basis of the acquired context information. According to an embodiment, the electronic device 600 may identify the analysis result of the final user utterance included in the acquired context information and identify whether the type of the first user utterance corresponds to a follow-up utterance of the final user utterance on the basis of the analysis result of the final user utterance.

In operation 1209, according to various embodiments, the electronic device 600 (for example, the processor 160 of FIG. 1) may perform the first task corresponding to the first user utterance on the basis of the analysis result of the first user utterance. According to an embodiment, the electronic device 600 may perform the identified first task by applying at least some of the acquired context information to the first user utterance.

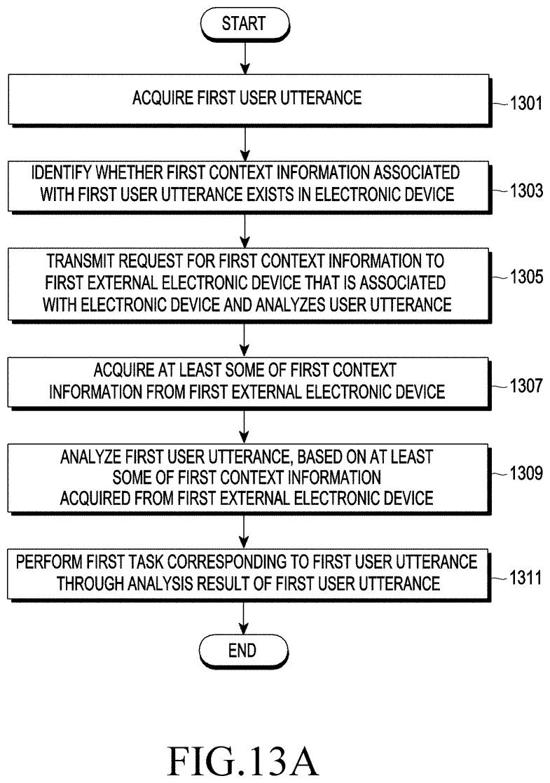

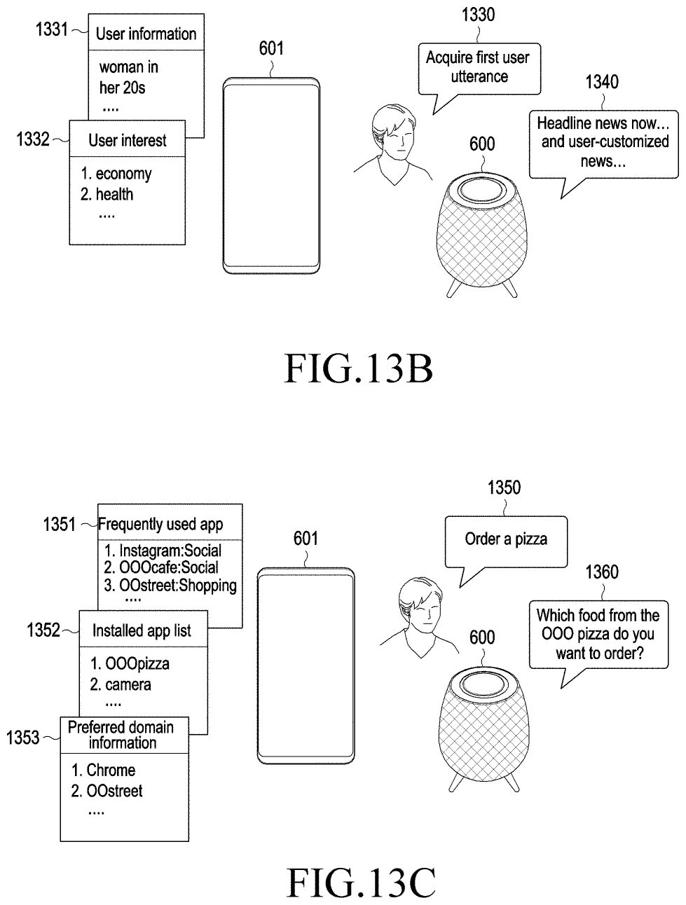

FIG. 13A illustrates a flowchart of a method by which an electronic device (for example, the electronic device 600 of FIG. 6) identifies whether there is first context information associated with first user utterance in the electronic device 600 according to various embodiments.

FIG. 13B illustrates a fourth embodiment in which the electronic device 600 performs a first task corresponding to the first user utterance according to various embodiments.

FIG. 13C illustrates a fifth embodiment in which the electronic device 600 performs the first task corresponding to the first user utterance according to various embodiments.

In operation 1301, according to various embodiments, the electronic device 600 (for example, the processor 160 of FIG. 1) may acquire a first user utterance through a microphone (for example, the microphone 120 of FIG. 1) after executing an intelligent agent (for example, the intelligent agent 440 of FIG. 4). For example, referring to FIG. 13B, the electronic device 600 may acquire a first user utterance 1330 (for example, “Show me the latest news”). In another example, referring to FIG. 13C, the electronic device 600 may acquire a first user utterance 1350 (for example, “Order a pizza”).

According to various embodiments, the electronic device 600 (for example, the processor 160 of FIG. 1) may analyze the first user utterance in response to acquisition of the first user utterance. According to an embodiment, the electronic device 600 may identify at least one of a domain, an intent, or a parameter for the first user utterance by analyzing the first user utterance through a natural language platform (for example, the natural language platform 430).

In operation 1303, according to various embodiments, the electronic device 600 (for example, the processor 160 of FIG. 1) may identify whether first context information associated with the first user utterance exists within the electronic device 600.

According to various embodiments, the electronic device 600 (for example, the processor 160 of FIG. 1) may identify whether first context information associated with the first user utterance exists within the electronic device 600 on the basis of acquisition of the first user utterance. For example, referring to FIG. 13B, the electronic device 600 may identify whether first context information associated with the first user utterance 1330 (for example, user personal information 1331 or user interest information 1332) is pre-stored in the electronic device 600 in response to acquisition of the first user utterance 1330. In another example, referring to FIG. 13C, the electronic device 600 may identify whether first context information (for example, user interest information 1352) associated with the first user utterance 1350 is pre-stored in the electronic device 600.

According to various embodiments, the electronic device 600 (for example, the processor 160 of FIG. 1) may identify whether the first context information associated with the first user utterance exists within the electronic device 600 on the basis of a priority configured in the electronic device 600. According to an embodiment, after first determining attributes of the first user utterance, the electronic device 600 may identify whether the first context information associated with the first user utterance exists within the electronic device 600 among at least one context information associated with at least one user utterance processed by the electronic device 600 before the first user utterance is acquired on the basis of attributes of the first user utterance corresponding to an incomplete utterance. According to an embodiment, after first determining whether the first context information exists within the electronic device 600, the electronic device 600 may identify the attributes of the first user utterance on the basis of identification that the first context information does not exist within the electronic device 600. The electronic device 600 may use operation 703 of FIG. 7 and the following operations in order to identify whether the attributes of the first user utterance correspond to an incomplete utterance.

According to various embodiments, the electronic device 600 (for example, the processor 160 of FIG. 1) may analyze the first user utterance using at least some of the first context information on the basis of identification that the first context information exists within the electronic device 600 before the first user utterance is acquired. The electronic device 600 may perform a first task corresponding to the first user utterance on the basis of the analysis result of the first user utterance. For example, referring to FIG. 13B, the electronic device 600 may perform a first task 1340 (for example, outputting news related to economy or health in the form of a voice) using at least some of the first context information (for example, user interest information 1332) on the basis of identification that the first context information (for example, the user personal information 1331 or the user interest information 1332) associated with the first user utterance 1330 exists within the electronic device 600 (for example, a smart speaker) before the first user utterance 1330 is acquired. In another example, referring to FIG. 13C, the electronic device 600 may perform a first task 1360 (for example, preparing to order a pizza in a pizza shop OOO) using at least some of the first context information (for example, the user interest information 1352) on the basis of identification that the first context information (for example, user interest information 1352) associated with the first user utterance 1350 exists within the electronic device 600 (for example, a smart speaker) before the first user utterance 1350 is acquired. In this case, the electronic device 600 may make a request for inquiring about acquisition of an additional parameter (inquiring about a pizza menu) to the user while performing the first task 1360.

In operation 1305, according to various embodiments, the electronic device 600 (for example, the processor 160 of FIG. 1) may transmit a request for the first context information to the first external electronic device 601 that is associated with the electronic device 600 and analyzes a user utterance. According to an embodiment, the first external electronic device 601 may be a device in the on-device form that analyzes a user utterance and performs a task corresponding to the user utterance on the basis of the analysis result of the user utterance. According to an embodiment, the first external electronic device 601 may include a device for establishing a short-range wireless communication connection (for example, Bluetooth, Wi-Fi direct, or IrDA) with the electronic device 600 or a device associated with a user account of the electronic device 600.

According to various embodiments, the electronic device 600 (for example, the processor 160 of FIG. 1) may transmit a request for first context information to the first external electronic device 601 in response to identification that the first context information does not exist within the electronic device 600 before the first user utterance is acquired. According to an embodiment, the electronic device 600 may identify attributes of the first user utterance in response to identification that the first context information does not exist within the electronic device 600 and transmit the request for the first context information to the first external electronic device 601 in response to the attributes of the first user utterance corresponding to an incomplete utterance. According to an embodiment, the request for the first context information may include information on the first user utterance.

According to various embodiments, the electronic device 600 (for example, the processor 160 of FIG. 1) may perform operation 1305 through the method described in operation 507 of FIG. 5 or operation 709 of FIG. 7.

According to various embodiments, the electronic device 600 (for example, the processor 160 of FIG. 1) may omit operation 1303. In this case, the electronic device 600 may perform an operation of transmitting the request for the first context information to the first external electronic device 601 in operation 1305 in response to acquisition of the first user utterance.

In operation 1307, according to various embodiments, the electronic device 600 (for example, the processor 160 of FIG. 1) may acquire at least some of the first context information from the first external electronic device 601. For example, referring to FIG. 13B, the electronic device 600 may acquire at least some of the first context information (for example, the user interest information 1332) from the first external electronic device 601. In another example, referring to FIG. 13C, the electronic device 600 may acquire at least some of the first context information (for example, the user interest information 1352) from the first external electronic device 601. According to an embodiment, the first external electronic device 601 may identify information on the first user utterance included in the request for the first context information and transmit user interest information corresponding to the domain or the intent for the first user utterance to the electronic device 600. For example, the first external electronic device 601 may identify information on the first user utterance (for example, “Reserve the hotel”) included in the request for the first context information and transmit the first context information including user interest information (for example, a room having a Wi-Fi connection and a swimming pool) corresponding to the domain (for example, a hotel search app) or the intent (for example, a room search function) for the first user utterance to the electronic device 600. The electronic device 600 may acquire the first context information including user interest information corresponding to a specific domain or a specific intent from the first external electronic device 601. The electronic device 600 may perform operation 1307 through the method described in operation 509 of FIG. 5 or operation 710 of FIG. 7A.

In operation 1309, according to various embodiments, the electronic device 600 (for example, the processor 160 of FIG. 1) may analyze the first user utterance on the basis of at least some of the first context information acquired from the first external electronic device 601. For example, referring to FIG. 13B, the electronic device 600 (for example, a smart speaker) may identify the first task 1340 (for example, outputting news related to economy or health in the form of a voice) using at least some of the first context information (for example, the user interest information 1332) acquired from the first external electronic device 601. In another example, referring to FIG. 13C, the electronic device 600 may identify the first task (for example, preparing to order a pizza in a pizza shop 000) using at least some of the first context information (for example, the user interest information 1352) acquired from the first external electronic device 601. In another example, the electronic device 600 may identify the first task (for example, searching for a room having a Wi-Fi connection and a swimming pool in a hotel search app) corresponding to the first user utterance (for example, “Search for a hotel”) using user interest information (for example, the room having a Wi-Fi connection and a swimming pool) corresponding to at least some of the first context information. According to an embodiment, the user interest information 1332, 1351, 1352, or 1353 may be classified according to a priority, and the electronic device 600 may identify the first task according to the priority of the user interest information 1332, 1351, 1352, or 1353. According to an embodiment, the electronic device 600 may perform operation 1309 through the method described in operation 509 of FIG. 5 or operation 711 of FIG. 7A.

In operation 1311, according to various embodiments, the electronic device 600 (for example, the processor 160 of FIG. 1) may perform the first task corresponding to the first user utterance on the basis of the analysis result of the first user utterance. According to an embodiment, the electronic device 600 may make a request for inquiring about acquisition of an additional parameter to the user through a display or a speaker while performing the first task. For example, referring to FIG. 13C, the electronic device 600 may make the request for inquiring about acquisition of the additional parameter to the user through the display or the speaker while performing the first task 1360.

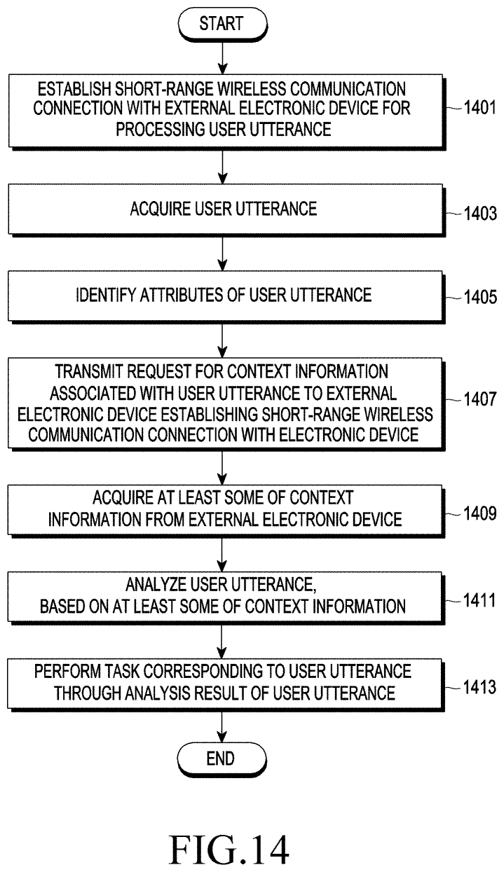

FIG. 14 illustrates a flowchart of a method by which the electronic device analyzes a user utterance on the basis of context information acquired from the external electronic device establishing a short-range wireless communication connection and performs a task corresponding to the user utterance.

In operation 1401, according to various embodiments, the electronic device 600 (for example, the processor 160 of FIG. 1) may establish a short-range wireless communication connection with an external electronic device to process a user utterance. According to an embodiment, the electronic device 600 may establish the short-range wireless communication connection (for example, Bluetooth, Wi-Fi direct, or IrDA) with the external electronic device through a communication interface (for example, the communication interface 110 of FIG. 1) including a short-range wireless communication interface. According to an embodiment, the electronic device 600 may pre-register the external electronic device in the electronic device 600 to establish the short-range wireless communication connection with the external electronic device.

In operation 1403, according to various embodiments, the electronic device 600 (for example, the processor 160 of FIG. 1) may acquire a first user utterance through a microphone (for example, the microphone 120 of FIG. 1) after executing an intelligent agent (for example, the intelligent agent 440 of FIG. 4).

In operation 1405, according to various embodiments, the electronic device 600 (for example, the processor 160 of FIG. 1) may identify attributes of the first user utterance. The electronic device 600 may perform operation 1405 using an operation of identifying attributes of the first user utterance described with reference to FIGS. 5, 6, 7A, 7B, 8, 9, 10A, 10B. 11A, 11B, 12A, 12B, 13A, 13B, and 13C.

In operation 1407, according to various embodiments, the electronic device 600 (for example, the processor 160 of FIG. 1) may transmit a request for context information associated with a user utterance to the external electronic device establishing the short-range wireless communication connection with the electronic device 600. The electronic device 600 may perform operation 1407 using an operation of transmitting the request for context information described with reference to FIGS. 5, 6, 7A, 7B, 8, 9, 10A, 10B. 11A, 11B, 12A, 12B, 13A, 13B, and 13C.

In operation 1409, according to various embodiments, the electronic device 600 (for example, the processor 160 of FIG. 1) may acquire at least some of the context information from the external electronic device. The electronic device 600 may perform operation 1409 using an operation of acquiring at least some of the context information described with reference to FIGS. 5, 6, 7A, 7B, 8, 9, 10A, 10B. 11A, 11B, 12A, 12B, 13A, 13B, and 13C.

In operation 1411, according to various embodiments, the electronic device 600 (for example, the processor 160 of FIG. 1) may analyze a user utterance on the basis of at least some of the context information. The electronic device 600 may perform operation 1411 using an operation of analyzing a user utterance described with reference to FIGS. 5, 6, 7A, 7B, 8, 9, 10A, 10B. 11A, 11B, 12A, 12B, 13A, 13B, and 13C.

In operation 1413, according to various embodiments, the electronic device 600 (for example, the processor 160 of FIG. 1) may perform a task corresponding to a user utterance on the basis of the analysis result of the user utterance. The electronic device 600 may perform operation 1413 using an operation of performing the task corresponding to the user utterance described with reference to FIGS. 5, 6, 7A, 7B, 8, 9, 10A, 10B. 11A, 11B, 12A, 12B, 13A, 13B, and 13C.

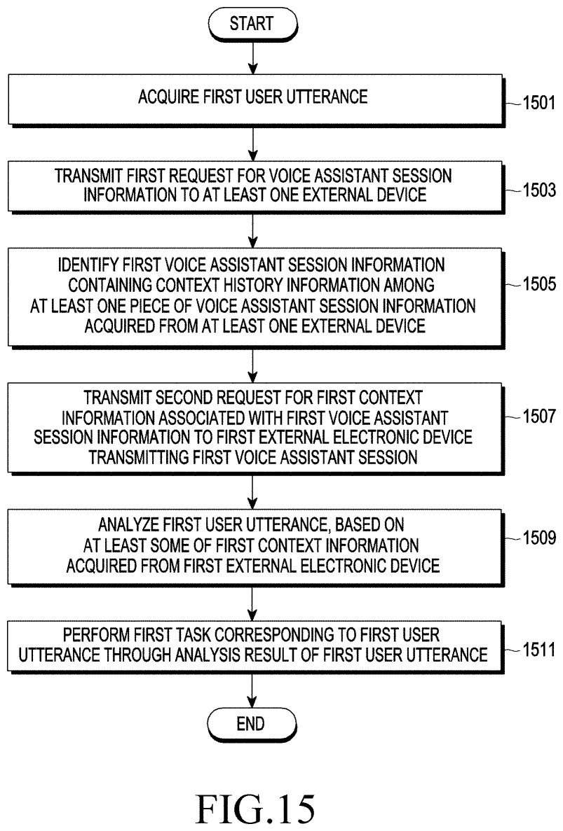

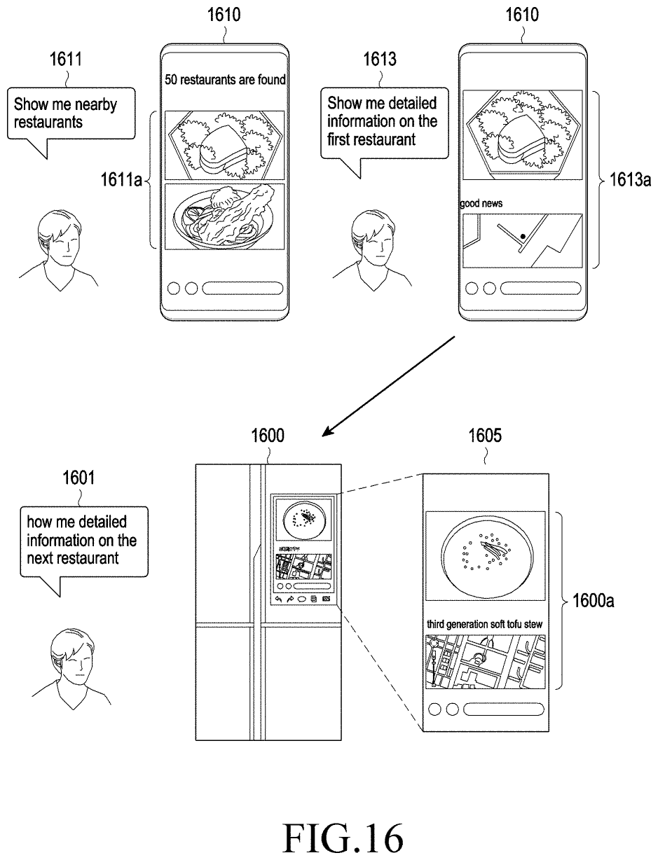

FIG. 15 illustrates a flowchart of a method by which an electronic device (for example, the user terminal 100 of FIG. 1 and/or an electronic device 1600 of FIG. 16) analyzes a first user utterance on the basis of first context information including context history information and performs a first task corresponding to the first user utterance according to various embodiments.

FIG. 16 illustrates an embodiment in which an electronic device (for example, the user terminal 100 of FIG. 1, the electronic device 1600, or/and the processor 160 of FIG. 1) analyzes a first user utterance including first context history information and performs a first task corresponding to the first user utterance according to various embodiments.

In operation 1501, according to various embodiments, after executing an intelligent agent (for example, the intelligent agent 440 of FIG. 4), the electronic device may acquire a first user utterance through a microphone (for example, the microphone 120 of FIG. 1 and/or the input module of FIG. 4). For example, referring to FIG. 16, the electronic device 1600 may acquire a first user utterance 1601 (for example, “Show me detailed information of the next restaurant”).

According to various embodiments, the electronic device may analyze the first user utterance in response to acquisition of the first user utterance. According to an embodiment, the electronic device may identify at least one of the domain, the intent, or the parameter for the first user utterance by analyzing the first user utterance through a natural language platform (for example, the natural language platform 430 of FIG. 4).

According to various embodiments, the electronic device may identify attributes of the first user utterance. According to various embodiments, the electronic device may identify whether the attributes of the first user utterance correspond to an incomplete utterance as the analysis result of the first user utterance. According to various embodiments, the electronic device may identify that the attributes of the first user utterance correspond to the incomplete utterance as the analysis result of the first user utterance on the basis of non-identification of at least one of the domain, the intent, or the mandatory parameter for the first user utterance. According to various embodiments, the electronic device may identify that the attributes of the first user utterance is the incomplete utterance as the analysis result of the first user utterance on the basis of at least some of the first user utterance corresponds to a predetermined expression indicating the incomplete utterance. For example, referring to FIG. 16, the electronic device may identify the domain (for example, a restaurant search application) and the intent (for example, displaying detailed information of a specific number restaurant in a restaurant list) for the first user utterance 1601 and know that the mandatory parameter (for example, a found restaurant list) for the first user utterance 1601 is not identified. In this case, the electronic device may identify that the attributes of the first user utterance 1601 correspond to an incomplete utterance.

According to various embodiments, the electronic device may identify that there were at least two user utterances associated with the first user utterance before the first user utterance as the analysis result of the first user utterance. For example, referring to FIG. 16, the electronic device may identify a second user utterance 1611 (for example, “Search for nearby restaurants”) that is made firstly and makes a request for searching restaurants on the basis of a specific reference and a second user utterance 1613 (for example, “Show me detailed information on a first restaurant) that is made secondly and makes a request for detailed information of a specific restaurant in result information (for example, a restaurant list found by a restaurant search application or a search result API) of a second task 1611a (for example, outputting the restaurant list found by the restaurant search application) corresponding to the second user utterance(611) that is made firstly before the first user utterance 1601 by analyzing the first user utterance 1601 (for example, “Show me detailed information on the next restaurant”).

In operation 1503, according to various embodiments, the electronic device may transmit a first request for voice assistant session information to at least one external electronic device. For example, referring to FIG. 16, the electronic device 1600 may transmit the first request for voice assistant session information to a first external electronic device 1610.

According to various embodiments, the electronic device may acquire voice assistant session information from each of at least one external electronic device through a communication interface (for example, the communication interface 110 of FIG. 1). For example, referring to FIG. 16, the electronic device 1600 may acquire voice assistant session information indicating a voice assistant session executed by the first external electronic device 1610 from the first external electronic device 1610 and acquire voice assistant session information indicating a voice assistant session executed by a second external electronic device (not shown) from the second external electronic device (not shown).

According to various embodiments, the electronic device may perform an operation of identifying attributes of the first user utterance after acquiring the voice assistant session information. According to an embodiment, the electronic device may identify whether the attributes of the first user utterance correspond to an incomplete utterance on the basis of the voice assistant session information acquired from the first external electronic device 1610.

In operation 1505, according to various embodiments, the electronic device may identify first voice assistant session information indicating that context history information is possessed among at least one voice assistant session information acquired from at least one external electronic device.

According to various embodiments, the electronic device may identify voice assistant session information indicating that context history information is possessed as first voice assistant session information that satisfies a predetermined condition among various methods of identifying the first voice assistant session information that satisfies the predetermined condition on the basis of the voice assistant session information. According to an embodiment, the electronic device may determine voice assistant session information indicating context history information is possessed as the first voice assistant session information that satisfies a predetermined condition among various methods of identifying the first voice assistant session information that satisfies the predetermined condition as the result of identification that there were at least two user utterances associated with the first user utterance before the first user utterance on the basis of analysis of the first user utterance. According to an embodiment, the electronic device may determine voice assistant session information indicating that context history information for a plurality of user utterances that matches at least one of the domain, the intent, and the parameter analyzed as the first user utterance is possessed as the first voice assistant session information that satisfies a predetermined condition.

For example, referring to FIG. 16, when the domain is a “restaurant search application” and the intent is “displaying detailed information on a specific number restaurant in a restaurant list according to the restaurant search” on the basis of the analysis of the first user utterance 1601 (for example, “Show me detailed information on the next restaurant”), if context history information indicating that the domain and the intent for the second user utterance 1611 (for example, “Show me nearby restaurants”) are the “restaurant search application” and the “restaurant search” and the domain and the intent for the second user utterance 1613 (for example, “Show me detailed information on the first restaurant”) that is made secondly within a predetermined time from the second user utterance 1611 that is made firstly are the “restaurant search application” and “search for detailed information on a specific number restaurant in a restaurant list” is acquired from the first external electronic device 1610, the electronic device 1600 may identify the voice assistants session information acquired from the first external electronic device 1610 as the first voice assistant session information that satisfies a predetermined condition.

In operation 1507, according to various embodiments, the electronic device may transmit a second request for first context information associated with the first voice assistant session information to the first external electronic device transmitting the first voice assistant session information indicating that context history information is possessed.

According to various embodiments, the electronic device may make a request for first context information corresponding to context history information included in the first voice assistant session information to the first external electronic device 1610 through a communication interface (for example, the communication interface 110 of FIG. 1).

In operation 1509, according to various embodiments, the electronic device may analyze the first user utterance on the basis of at least some of the first context information acquired from the first external electronic device.

According to various embodiments, the electronic device may acquire first context information including information on the result of a task corresponding to each of a plurality of user utterances from the first external device on the basis of context history information possessed in the first voice assistant session. According to an embodiment, the electronic device may identify the first task corresponding to the first user utterance as the analysis result of the first user utterance on the basis of at least some of the first context information. For example, referring to FIG. 16, the electronic device may acquire first context information including information (for example, a restaurant list found by a restaurant search application or a search result API) on the result of the second task 1611a (for example, outputting a restaurant list found by the restaurant search application) that is performed firstly, corresponding to the second user utterance 1611 (“Show me nearby restaurants”) that is made firstly and information (for example, detailed information on the first restaurant in the restaurant list found by the restaurant search application or the search result API) on the result of the second task 1613a (for example, outputting detailed information on the first restaurant in the restaurant list found by the restaurant search application) that is performed secondly, corresponding to the second user utterance 1613 (for example, “Show me detailed information on the first restaurant”) that is made secondly, corresponding to a follow-up utterance of the second user utterance 1611 that is made firstly from the first external electronic device 1610. The electronic device 1600 may identify the first task 1600a (for example, outputting a display of detailed information on the second restaurant in the restaurant list found by the restaurant search application through the display 1605) corresponding to the first user utterance 1601 by applying information (for example, the restaurant list found by the restaurant application or the search result API) of the result of the second task 1611a that is performed firstly and information (for example, detailed information on the first restaurant in the found restaurant list or the search result API) of the result of the second task 1613a that is performed secondly, which are at least some of the first pieces of context information acquired from the first external electronic device 1610, to the first user utterance 1601.

In operation 1511, according to various embodiments, the electronic device may perform the first task corresponding to the first user utterance on the basis of the analysis result of the first user utterance.

According to an embodiment, the electronic device may perform the identified task by applying at least some of the first context information to the first user utterance. According to an embodiment, the electronic device 1600 may perform the first task corresponding to the first user utterance on the basis of the analysis result of the first user utterance. For example, referring to FIG. 16, the electronic device 1600 may perform the first task 1600a corresponding to the first user utterance 1601 on the basis of the analysis result of the first user utterance 1601.

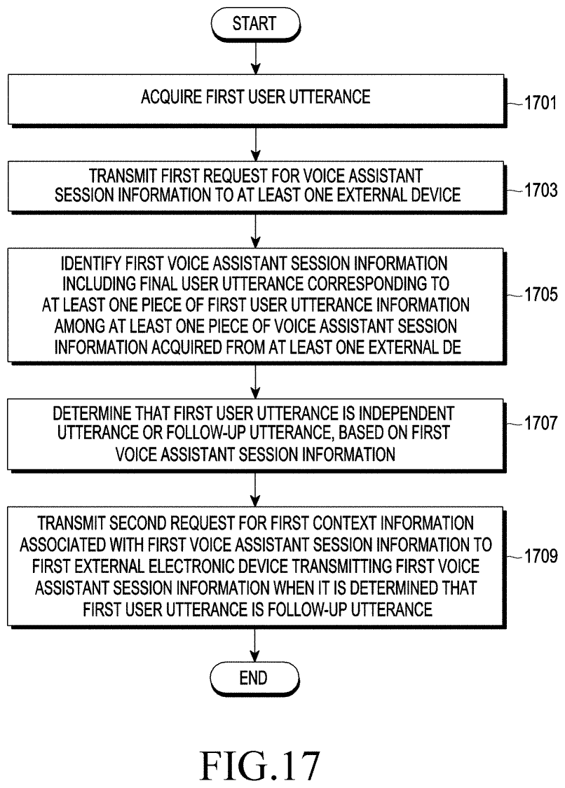

FIG. 17 illustrates a flowchart of a method by which an electronic device (for example, the user terminal 100 of FIG. 1) analyzes a first user utterance on the basis of first context information.

In operation 1701, according to various embodiments, after executing an intelligent agent (for example, the intelligent agent 440 of FIG. 4), the electronic device may acquire a first user utterance through a microphone (for example, the microphone 120 of FIG. 1 and/or the input module of FIG. 4).

According to an embodiment, the electronic device may identify at least one of a domain, an intent, and a parameter for the first user utterance by analyzing the first user utterance.

In operation 1703, according to various embodiments, the electronic device may transmit a first request for voice assistant session information to at least one external electronic device.

According to various embodiments, the electronic device may acquire voice assistant session information from each of at least one external electronic device through a communication interface (for example, the communication interface 110 of FIG. 1).

In operation 1705, according to various embodiments, the electronic device may identify first voice assistant session information including final user utterance information corresponding to at least one piece of the first user utterance information in at least one piece of voice assistant session information acquired from at least one external electronic device.

According to various embodiments, the electronic device may identify voice assistant session information including a final user utterance as first voice assistant session information that satisfies a predetermined condition in at least one piece of voice assistant session information acquired from at least one external electronic device on the basis of at least one of the domain, the intent, and the parameter for the first user utterance corresponding to at least one of a domain, an intent, or a parameter for the final user utterance.

In operation 1707, according to various embodiments, the electronic device may determine whether the first user utterance is an independent utterance or a follow-up utterance on the basis of the first voice assistant session information.

According to various embodiments, when at least one of the domain, the intent, and the parameter for the first user utterance corresponds to at least one of the domain, the intent, and the parameter for the final user utterance on the basis of the first voice assistant session information, the electronic device may determine the first user utterance as the follow-up utterance. For example, when the domain for the first user utterance is a “restaurant search application” and the domain included in the first voice assistant session is a “restaurant search application”, the electronic device may determine the first user utterance as the follow-up utterance.

In operation 1709, according to various embodiments, when it is determined that the first user utterance is the follow-up utterance on the basis of the first voice assistant session information, the electronic device may transmit a second request for first context information associated with the first voice assistant session information to a first external electronic device transmitting the first voice assistant session information.

According to various embodiments, the electronic device may make a request for first context information associated with the first voice assistant session information to the first external electronic device through a communication interface (for example, the communication interface 110 of FIG. 1). The following operations may be performed equally to operations 1509 and 1511 of FIG. 15.

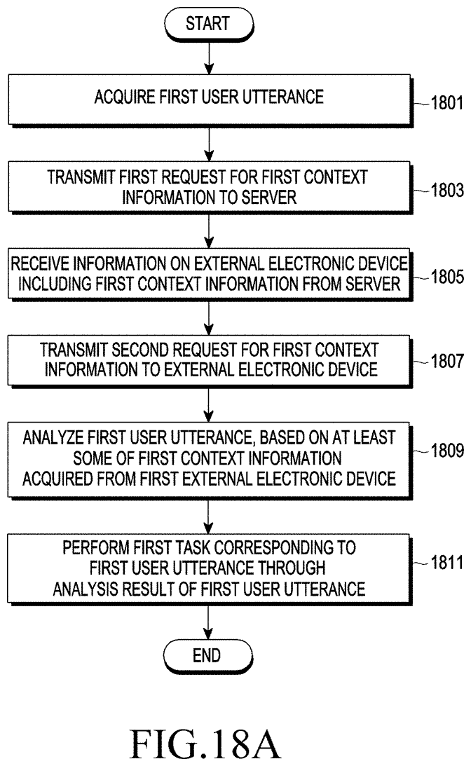

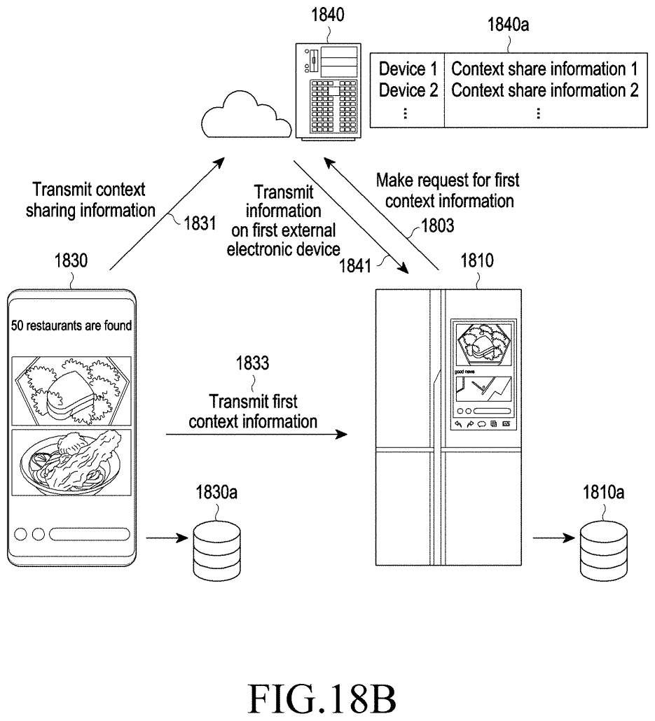

FIG. 18A illustrates a flowchart of a method by which an electronic device (for example, the user terminal 100 of FIG. 1 and/or an electronic device 1810 of FIG. 18B) performs a first task corresponding to a first user utterance on the basis of a context sharing list of a server according to various embodiments.

FIG. 18B illustrates an embodiment in which an electronic device (for example, the user terminal 100 of FIG. 1, the electronic device 1810, and/or the processor 160 of FIG. 1) performs a first task corresponding to a first user utterance on the basis of a context sharing list of a server according to various embodiments.

In operation 1801, according to various embodiments, the electronic device 1810 may acquire a first user utterance through a microphone (for example, the microphone 120 of FIG. 1 and/or the input module of FIG. 4) after executing an intelligent agent (for example, the intelligent agent 440 of FIG. 4).

According to various embodiments, the electronic device 1810 may analyze the first user utterance in response to acquisition of the first user utterance. According to an embodiment, the electronic device 1810 may identify at least one of a domain, an intent, or a parameter for the first user utterance by analyzing the first user utterance through a natural language platform (for example, the natural language platform 430 of FIG. 4).

According to various embodiments, the electronic device 1810 may identify attributes of the first user utterance. According to an embodiment, the electronic device 1810 may identify whether the attributes of the first user utterance correspond to an incomplete utterance as the analysis result of the first user utterance. According to an embedment, the electronic device 1810 may identify that the attributes of the first user utterance correspond to the incomplete utterance as the analysis result of the first user utterance on the basis of non-identification of at least one of the domain, the intent, or the parameter for the first user utterance. According to an embodiment, the electronic device 1810 may identify that the attributes of the first user utterance correspond to the incomplete utterance as the analysis result of the first user utterance on the basis of at least some of the first user utterance corresponding to a predetermined expression indicating the incomplete utterance.

In operation 1803, according to various embodiments, the electronic device 1810 may transmit a first request for first context information to a server (for example, a server 1840 of FIG. 18B).

According to various embodiments, the electronic device 1810 may transmit a first request for first context information associated with the first user utterance to the server 1840. According to an embodiment, the electronic device 1810 may transmit a first request for first context information including at least one of the domain, the intent, or the parameter for the first user utterance.

According to various embodiments, a database (DB) of the server 1840 may include a context sharing list 1840a, and the context sharing list 1840a may include context sharing information for each of a plurality of electronic devices 1810, 1830, . . . existing within a predetermined range or a plurality of pre-registered electronic devices 1810, 1830, . . . existing within a predetermined range. According to an embodiment, when a task corresponding to a second user utterance is performed, the first external electronic device 1830 may store first context information corresponding to actual result information for the task corresponding to at last one of the domain, the intent, or the parameter for the second user utterance or/and to the second user utterance in the DB 1830a included in the first external electronic device 1830 and transmit the context sharing information for the first context information to the server 1840 as indicated by reference numeral 1831. According to an embodiment, the first external electronic device 1830 may store actual context information in the DB 1830a of the first external electronic device 1830 and transmit the context sharing information indicating storage of the context information in the first external electronic device 1830 to the server 1840 as indicated by reference numeral 1831 so as to update the context sharing list 1840a.

According to an embodiment, when the task corresponding to the first user utterance is performed as the operation of the first external electronic device 1830, the electronic device 1810 may store context information corresponding to actual result information for the task corresponding to at least one of the domain, intent, or the parameter for the first user utterance and/or to the first user utterance in the DB 1810a included in the electronic device 1810, transmit context sharing information for the context information to the server 1840, and update the context sharing list 1840a.

According to various embodiments, the server 1840 may detect information on the first external electronic device having context sharing information corresponding to the first context information from a context sharing list 1840a and transmit the information on the first external electronic device to the electronic device 1810 in response to the first request for the first context information from the electronic device 1810. According to an embodiment, when the domain for the first user utterance of the electronic device 1810 corresponds to the domain for the second user utterance of the first external electronic device 1830, the server 1840 may transmit information on the first external electronic device having context sharing information corresponding to the first context information to the electronic device 1810 as indicated by reference numeral 1841 in response to the first request for the first context information from the electronic device 1810.

In operation 1805, according to various embodiments, the electronic device 1810 may receive information on the external electronic device including first context information from the server 1840.

According to various embodiments, the electronic device 1810 may receive information on the first external electronic device storing first context information from the server 1840.

In operation 1807, according to various embodiments, the electronic device 1810 may transmit a second request for first context information to the external electronic device.

According to various embodiments, the electronic device 1810 may transmit the request for the first context information to the first external electronic device 1830. For example, the electronic device 1810 may transmit the request for the first context information to the first external electronic device 1830 in a broadcast, multicast, or unicast type.

According to various embodiments, the electronic device 1810 may establish a short-range wireless communication connection with the first external electronic device 1830 on the basis of information on the first external electronic device (for example, identification information and/or connection information of the external electronic device). According to an embodiment, the electronic device 1810 may establish a short-range wireless communication connection (for example, Bluetooth, Wi-Fi direct, or IrDA) with the first external electronic device 1830 through a communication interface (for example, the communication interface 110 of FIG. 1) including a short-range wireless communication interface.

In operation 1809, according to various embodiments, the electronic device 1810 may analyze the first user utterance on the basis of at least a part of the first context information acquired from the external electronic device.

According to various embodiments, the electronic device 1810 may acquire first context information from the first external electronic device 1830 as indicated by reference numeral 1833 in the state in which the short-range wireless communication connection with the first external electronic device 1830 is established.

According to various embodiments, the electronic device 1810 may analyze the first user utterance on the basis of the first context information acquired from the first external electronic device 1830, and the operation of analyzing the first user utterance on the basis of the first context information may be performed equally to operation 1509 of FIG. 15.

According to various embodiments, when the information on the first external electronic device 1830 is detected on the basis of the context sharing list 1840a according to the request from the electronic device 1810, the server 1840 may make a request for the first context information to the first external electronic device 1830 and directly transmit the first context information acquired from the first external electronic device 1830 to the electronic device 1810. According to an embodiment, the electronic device 1810 may analyze the first user utterance on the basis of the first context information acquired from the server 1840, and the operation of analyzing the first user utterance on the basis of the first context information may be performed equally to operation 1509 of FIG. 15.

In operation 1811, according to various embodiments, the electronic device 1810 may perform the first task corresponding to the first user utterance on the basis of the analysis result of the first user utterance, and the operation of performing the first task corresponding to the first user utterance may be performed equally to operation 1511 of FIG. 15.

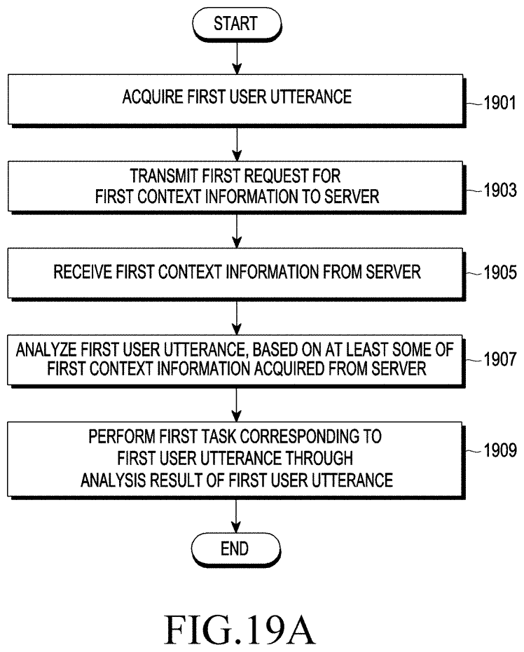

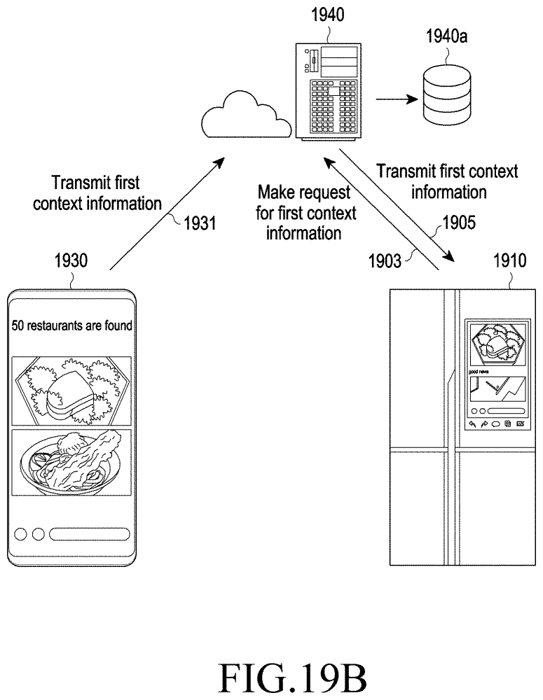

FIG. 19A illustrates a flowchart of a method by which an electronic device (for example, the user terminal 100 of FIG. 1 and/or an electronic device 1910 of FIG. 19B) performs a first task corresponding to a first user utterance on the basis of context information of a server according to various embodiments.

FIG. 19B illustrates an embodiment in which an electronic device (for example, the user terminal 100 of FIG. 1, the electronic device 1910, and/or the processor 160 of FIG. 1) performs a first task corresponding to a first user utterance on the basis of context information of a server according to various embodiments.

In operation 1901, according to various embodiments, the electronic device 1910 may acquire a first user utterance through a microphone (for example, the microphone 120 of FIG. 1 and/or the input module of FIG. 4) after executing an intelligent agent (for example, the intelligent agent 440 of FIG. 4).

According to various embodiments, the electronic device 1910 may analyze the first user utterance in response to acquisition of the first user utterance. According to an embodiment, the electronic device 1910 may identify at least one of a domain, an intent, or a parameter for the first user utterance by analyzing the first user utterance through a natural language platform (for example, the natural language platform 430 of FIG. 4).

According to various embodiments, the electronic device 1910 may identify attributes of the first user utterance. According to an embodiment, the electronic device 1910 may identify whether the attributes of the first user utterance correspond to an incomplete utterance. According to an embedment, the electronic device 1910 may identify that the attributes of the first user utterance correspond to the incomplete utterance as the analysis result of the first user utterance on the basis of non-identification of at least one of the domain, the intent, or the parameter for the first user utterance. According to an embodiment, the electronic device 1910 may identify that the attributes of the first user utterance correspond to the incomplete utterance as the analysis result of the first user utterance on the basis of at least some of the first user utterance corresponding to a predetermined expression indicating the incomplete utterance.

In operation 1903, according to various embodiments, the electronic device 1910 may transmit a first request for first context information to a server 1940.

According to various embodiments, the electronic device 1910 may transmit a first request for first context information associated with the first user utterance to the server 1940. According to an embodiment, the electronic device 1910 may transmit a first request for first context information including at least one of the domain, the intent, or the parameter for the first user utterance.

According to various embodiments, the server 1940 may store context information for a plurality of electronic devices 1910, 1930, . . . existing within a predetermined range or a plurality of pre-registered electronic devices 1910, 1930, . . . existing within a predetermined range in the DB 1940a included in the server. According to an embodiment, when a task corresponding to a second user utterance is performed, the first external electronic device 1930 may transmit context information corresponding to actual result information for the task corresponding to at least one of a domain, an intent, or a parameter for the second user utterance and/or to the second user utterance to the server 1940 as indicated by reference numeral 1931 and store the context information in the DB 1940a included in the server. According to an embodiment, the first external electronic device 1930 may store the context information on a DB (not shown) included in the first external electronic device 1930 while storing the context information in the DB 1940a of the server 1940. According to an embodiment, when the first task corresponding to the first user utterance is performed as the operation of the first external electronic device 1930, the electronic device 1910 may transmit context information corresponding to actual result information for the task corresponding to at least one of the domain, the intent, or the parameter for the first user utterance or to the first user utterance to the server 1940 and store the context information to the DB 1940a included in the server.

According to various embodiment, the server 1940 may detect context information of the first external electronic device 1930 corresponding to the first context information in the DB 1940a included in the server 1940 and transmit the context information to the electronic device 1910 in response to the first request for the first context information from the electronic device 1910. According to an embodiment, the server 1940 may transmit the context information of the first external electronic device 1930 corresponding to the first context information to the electronic device 1910 as the first context information.

In operation 1905, according to various embodiments, the electronic device 1910 may receive the first context information from the server 1940.

In operation 1907, according to various embodiments, the electronic device 1910 may analyze the first user utterance on the basis of at least some of the first context information acquired from the server 1940.

According to various embodiments, the electronic device 1910 may analyze the first user utterance on the basis of the first context information acquired from the server, and the operation of analyzing the first user utterance on the basis of the first context information may be performed equally to operation 1509 of FIG. 15.

In operation 1909, according to various embodiments, the electronic device 1910 may perform the first task corresponding to the first user utterance on the basis of the analysis result of the first user utterance, and the operation of performing the first task corresponding to the first user utterance may be performed equally to operation 1511 of FIG. 15.

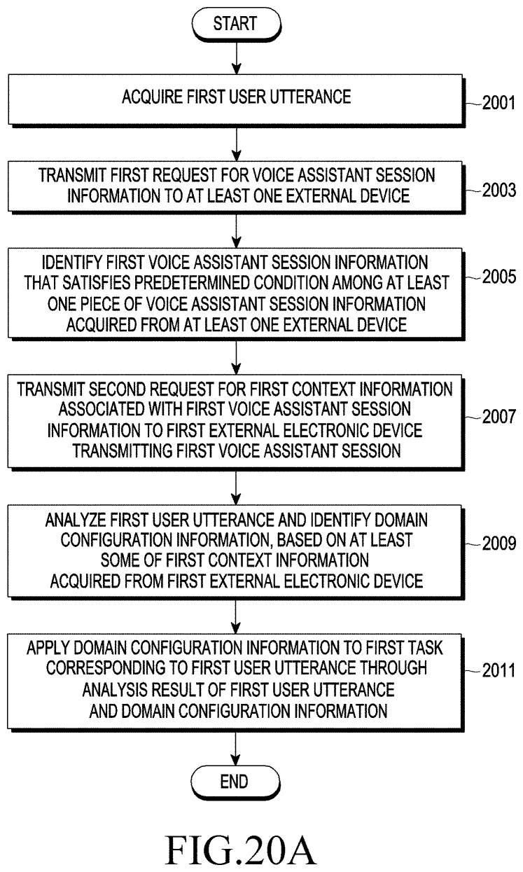

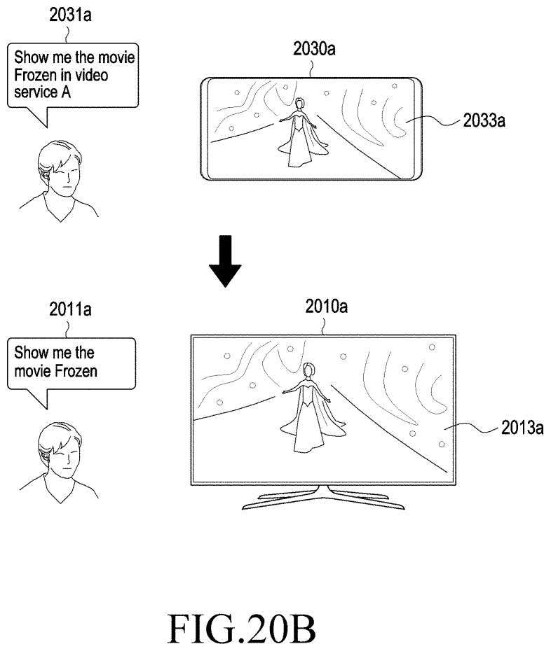

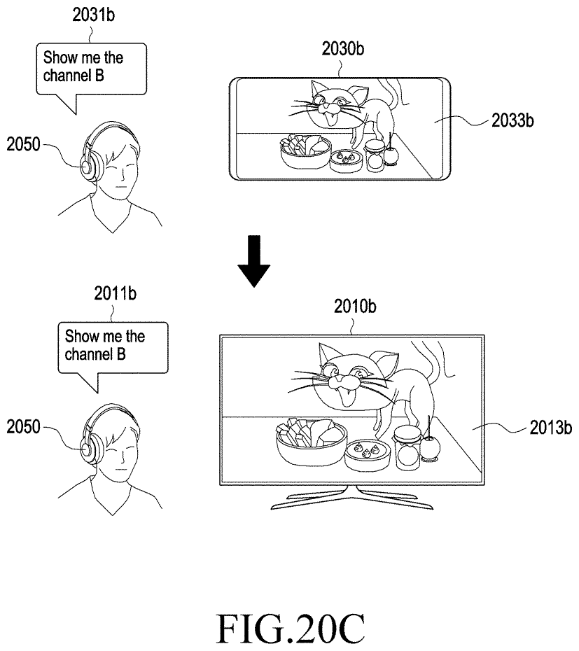

FIG. 20A illustrates a flowchart of a method by which an electronic device (for example, the user terminal 100 of FIG. 1, an electronic device 2010a of FIG. 20B, and/or an electronic device 2010b of FIG. 20C) performs a first task corresponding to a first user utterance and domain configuration information on the basis of first context information according to various embodiments.

FIGS. 20B and 20C illustrate embodiments in which an electronic device (for example, the user terminal 100 of FIG. 1, the electronic device 2010a, the electronic device 2010b, and/or the processor 160 of FIG. 1) performs a first task corresponding to a first user utterance and domain configuration information on the basis of first context information according to various embodiments.

In operation 2001, according to various embodiments, the electronic device may acquire a first user utterance through a microphone (for example, the microphone 120 and/or the input module of FIG. 1) after executing an intelligent agent (for example, the intelligent agent 440 of FIG. 4).

According to various embodiments, the electronic device may analyze the first user utterance in response to acquisition of the first user utterance. According to an embodiment, the electronic device may identify at least one of the domain, the intent, or the parameter for the first user utterance by analyzing the first user utterance through a natural language platform (for example, the natural language platform 430 of FIG. 4).

According to various embodiments, the electronic device may identify attributes of the first user utterance. According to various embodiments, the electronic device may identify whether the attributes of the first user utterance correspond to an incomplete utterance as the analysis result of the first user utterance. According to various embodiments, the electronic device may identify that the attributes of the first user utterance correspond to the incomplete utterance as the analysis result of the first user utterance on the basis of non-identification of at least one of the domain, the intent, or the mandatory parameter for the first user utterance. According to various embodiments, the electronic device may identify that the attributes of the first user utterance is an incomplete utterance as the analysis result of the first user utterance on the basis of at least some of the first user utterance corresponds to a predetermined expression indicating an incomplete utterance.

For example, referring to FIG. 20B, the electronic device 2010a may identify an intent (for example, watching a movie) and a mandatory parameter (for example, Frozen as a movie title to be watched) for a first user utterance 2011a and may know that a domain (for example, a type of a video service application) for the first user utterance 2011a is not identified by analyzing the first user utterance 2011a (for example, Show me the movie “Frozen”). In this case, the electronic device may identify that attributes of the first user utterance 2011a correspond to an incomplete utterance. For example, referring to FIG. 20C, the electronic device 2010b may identify a domain (for example, a TV application), and intent (for example, watching a TV), and a mandatory parameter (for example, watching a channel B) for a first user utterance 2011b by analyzing the first user utterance 2011b (for example, “Show me the channel B”). According to an embodiment, when the electronic device 2010b identifies that an additional parameter is not needed and a first task corresponding to the first user utterance 2011b can be performed using only the first user utterance 2011b, the electronic device 2010b may identify that the attributes of the first user utterance 2011b correspond to a complete utterance on the basis of the analysis of the first user utterance 2011b. In this case, the electronic device 2010b may identify that the attributes of the first user utterance 2011b is an independent complete utterance.

In operation 2003, according to various embodiments, the electronic device may transmit a first request for voice assistant session information to at least one external electronic device.

According to an embodiment, the electronic device may transmit a first request for voice assistant session information to at least one external electronic device in order to additionally acquire information even when the first user utterance is not only an incomplete utterance but also an independent complete utterance.

For example, referring to FIG. 20B, the electronic device 2010a may transmit the first request for the voice assistant session information to a first external electronic device 2030a. For example, referring to FIG. 20C, the electronic device 2010b may transmit the first request for the voice assistant session information to a first external electronic device 2030b.

According to various embodiments, the electronic device may acquire voice assistant session information from each of at least one external electronic device through a communication interface (for example, the communication interface 110 of FIG. 1). For example, referring to FIG. 20B, the electronic device 2010a may acquire voice assistant session information indicating a voice assistant session executed by the first external electronic device 2030a from the first external electronic device 2030a and acquire voice assistant session information indicating a voice assistant session from a second external electronic device (not shown) from the second external electronic device (not shown). For example, referring to FIG. 20C, the electronic device 2010b may acquire voice assistant session information indicating a voice assistant session executed by the first external electronic device 2030b from the first external electronic device 2030b and acquire voice assistant session information indicating a voice assistant session from a second external electronic device (not shown) from the second external electronic device (not shown).

In operation 2005, according to various embodiments, the electronic device may identify first voice assistant session information that satisfies a predetermined condition among at least one piece of voice assistant session information acquired from at least one external electronic device.

According to various embodiments, the electronic device may identify first voice assistant session information among at least one piece of the voice assistant session information acquired from at least one external electronic device through at least one of the various methods of identifying the first voice assistant session information that satisfies the predetermined condition.

In operation 2007, according to various embodiments, the electronic device may transmit a second request for first context information associated with the first voice assistant session information to the first external electronic device transmitting the first voice assistant session information.

According to various embodiments, the electronic device may make a request for the first context information associated with the first voice assistant session information to the first external electronic device through a communication interface (for example, the communication interface 110 of FIG. 1).

In operation 2009, according to various embodiments, the electronic device may analyze the first user utterance on the basis of at least some of the first context information acquired from the first external electronic device and identify domain configuration information of the first external electronic device.

According to various embodiments, the electronic device may analyze the first user utterance on the basis of at least some of the first context information and identify domain configuration information of the first external electronic device. According to an embodiment, the domain configuration information may include at least one piece of screen information (for example, reproduction mode information), reproduction information (for example, final watching location information), subtitle information (for example, a subtitle type or/and a subtitle location), and/or connection information (for example, information on a connection with another external device). For example, referring to FIG. 20B, the electronic device 2010a may acquire first context information including information (for example, a screen for reproducing the movie Frozen found by a video service application A) on the result of a second task 2033a (for example, reproducing the movie Frozen in a video service A) corresponding to a second user utterance 2031a (for example, “Show me the movie Frozen in the video service A”) from the first external electronic device 2030a. The electronic device 2010a may acquire first context information including the configured domain configuration information from the first external electronic device 2030a while the movie Frozen is reproduced in the video service A. For example, in FIG. 20B, the domain configuration information of the first external electronic device 2030a included in the first context information may include at least one piece of screen information (for example, a movie theater mode), reproduction information (for example, watching for 1 hour among the running time of 2 hours and 30 minutes), and/or subtitle information (for example, English subtitles and Korean subtitles, and displaying English subtitles on the central lower part and Korean subtitles under English subtitles). For example, referring to FIG. 20C, the electronic device 2010b may acquire first context information including information (for example, a screen of outputting a channel B) on the result of a second task 2033b corresponding to a second user utterance 2031b (for example, “Show me the channel B”) from the first external electronic device 2030b. The electronic device 2010b may acquire first context information including domain configuration information corresponding to configuration information of another external electronic device 2050 (for example, a BT headset) connected to the first external electronic device 2030b from the first external electronic device 2030b while the first external electronic device 2030b outputs the channel B. For example, in FIG. 20C, the domain configuration information of the first external electronic device 2030b included in the first context information may include connection information (for example, identification information and/or connection information of another external device connected to the first external electronic device).

According to various embodiments, the electronic device may include a device handler (not shown) for identifying whether domain configuration information included in the first context information acquired from the external electronic device can be applied to the electronic device, and the device handler (not shown) may identify whether the domain configuration information received from the external electronic device is information that can be applied to the electronic device or is required to be changed. According to an embodiment, the context handler 453 of FIG. 4 may include the device handler module and, when receiving first context information from the external electronic device, identify whether the domain configuration information included in the received first context information is information that can be applied to the electronic device or is required to be changed and perform a corresponding function. For example, referring to FIG. 20B, when the screen information is configured as the “movie theater mode” on the basis of the domain configuration information received from the first external electronic device 2030a, the device handler (not shown) may determine whether the screen configuration information is screen configuration information that can be applied to the electronic device 2010a. When the electronic device 2010a has screen information such as the “movie theater mode”, the device handler (not shown) may change the screen information state of the electronic device 2010a to the “movie theater mode” when performing the first task 2013a corresponding to the first user utterance 2011a. Alternatively, when the electronic device 2010a does not have the screen information such as the “movie theater mode”, the device handler (not shown) may perform a similar function supported by the electronic device 2010a. For example, when the electronic device 2010a does not have the “movie theater mode” but has a first mode for controlling settings of the display to reproduce a video, the device handler (not shown) may execute the first mode, and confirm the execution of the first mode by the user and then execute the first mode.

In operation 2011, according to various embodiments, the electronic device may apply domain configuration information to the first task corresponding to the first user utterance on the basis of the analysis result of the first user utterance and the domain configuration information.

According to an embodiment, the electronic device may apply domain configuration information to the first task corresponding to the first user utterance through the analysis result of the analyzed first user utterance and the identified domain configuration information on the basis of at least some of the first context information. For example, referring to FIG. 20B, when performing the first task 2013a corresponding to the first user utterance 2011a on the basis of the analysis result of the first user utterance 2011a, the electronic device 2010a may apply the domain configuration information (for example, outputting English subtitles and Korean subtitles during reproduction after a final reproduction location time in the movie theater mode) to the first task 2013a. For example, referring to FIG. 20C, when performing the first task 2013b corresponding to the first user utterance 2011b on the basis of the analysis result of the first user utterance 2011b, the electronic device 2010b may apply the domain configuration information (for example, BT headset connection) to the first task 2013b. The connection with another external electronic device 2050 (for example, the BT headset) connected to the first external electronic device 2030b may be released, and first context information including domain configuration information corresponding to connection information of another external electronic device 2050 (for example, BT headset connection information) may be transmitted to the electronic device 2010b. The electronic device 2010b may be connected to the other external electronic device 2050 on the basis of the first context information and may output audio data of content corresponding to the first task 2013b through the other external electronic device 2050 (for example, the BT headset).

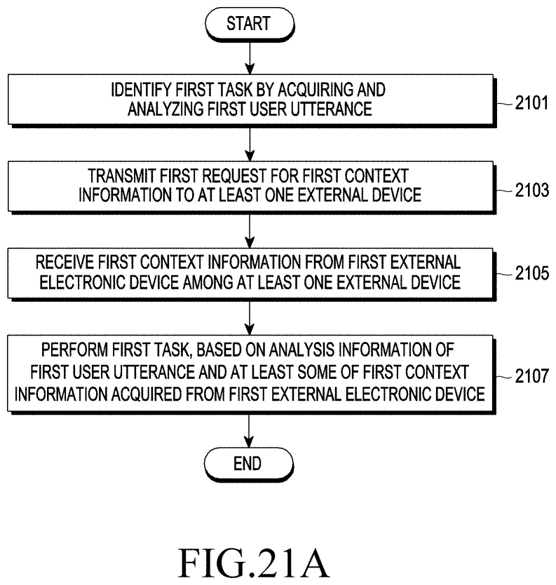

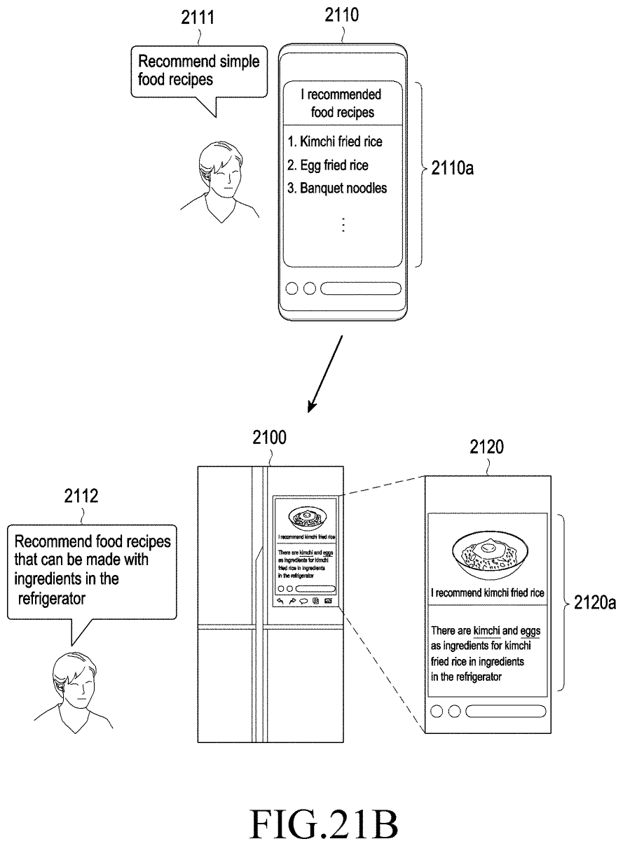

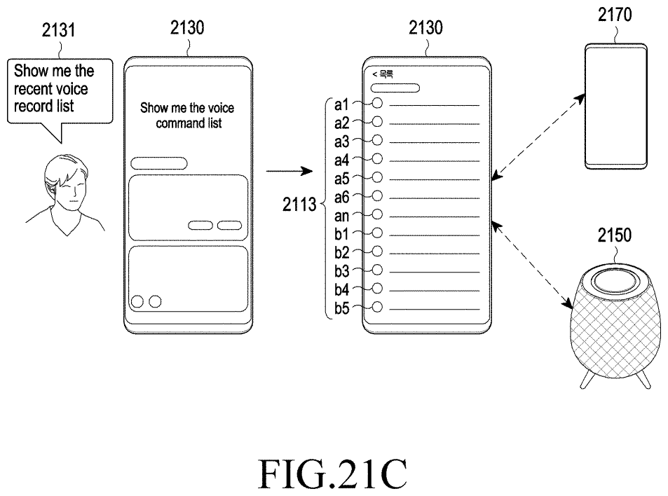

FIG. 21A illustrates a flowchart of a method by which an electronic device (for example, the user terminal 100 of FIG. 1 and/or an electronic device 2110 of FIG. 21B) performs a first task on the basis of analysis information of a first user utterance and first context information according to various embodiments.

FIGS. 21B and 21C illustrate embodiments in which an electronic device (for example, the user terminal 100 of FIG. 1, the electronic device 2110, and/or the processor 160 of FIG. 1) performs a first task on the basis of analysis information of a first user utterance and first context information according to various embodiments.

In operation 2101, according to various embodiments, after executing an intelligent agent (for example, the intelligent agent 440 of FIG. 4), the electronic device may acquire a first user utterance through a microphone (for example, the microphone 120 of FIG. 1) and identify a first task by analyzing the acquired first user utterance.

According to various embodiments, the electronic device may analyze the first user utterance in response to acquisition of the first user utterance. According to an embodiment, the electronic device may identify at least one of the domain, the intent, or the parameter for the first user utterance by analyzing the first user utterance through a natural language platform (for example, the natural language platform 430 of FIG. 4). According to an embodiment, the electronic device may identify the first task corresponding to the first user utterance according to the analysis of the first utterance. For example, referring to FIG. 21B, the electronic device 2100 may identify a domain (for example, a food recipe search application), an intent (for example, a food recipe search), and a mandatory parameter (for example, a food that can be made with ingredients in a refrigerator) for the first user utterance 2112 and identify that attributes of a first user utterance 2112 correspond to an independent complete utterance by analyzing the first user utterance 2112 (for example, “Recommend food recipes that can be made with ingredients in a refrigerator”).

In another example, referring to FIG. 21C, the electronic device 2130 may identify a domain (for example, a voice record application), an intent (for example, a voice record search), and a mandatory parameter (for example, a recent voice record list) for a first user utterance 2131 and identify that attributes of the first user utterance 2131 correspond to an independent complete utterance by analyzing the first user utterance 2131 (for example, “Show me the recent voice record list”).

In operation 2103, according to various embodiments, the electronic device may transmit a first request for first context information to at least one external electronic device.

According to various embodiments, the electronic device may transmit the first request for first context information including at least one of the domain, the intent, and the parameter for the first user utterance to at least one external electronic device.

In operation 2105, according to various embodiments, the electronic device may receive first context information from the first external electronic device among at least one external electronic device.

According to various embodiments, the electronic device may receive the first context information from the first external electronic device including at least one of the domain, the intent, and the parameter for the first user utterance among at least one external electronic device.

For example, referring to FIG. 21B, the electronic device may identify that domain information (for example, a food recipe search application) of the first user utterance 2112 is the same as domain information (for example, a food recipe search application) of the first context information on the basis of result information of the second task 2110a (for example, a food recipe list recommended by the food recipe search application or a recommended result API) corresponding to the second user utterance 2111 (“Recommend simple food recipes”) that is an utterance before the first user utterance 2112 among the first context information received from the first external electronic device 2110 among at least one external electronic device.

For example, referring to FIG. 21C, first context information may be received from the first external electronic device 2150 having the same domain (for example, a voice record application) as the domain (for example, a voice record application) for the first user utterance 2131 among at least one external electronic device 2150 and 2170.

In operation 2107, according to various embodiments, the electronic device may perform the first task on the basis of analysis information of the first user utterance and at least some of the first context information acquired from the first external electronic device.

According to various embodiments, when performing the first task corresponding to the first user utterance, the electronic device may perform the first task with reference to first context information received from the first external electronic device. For example, as illustrated in FIG. 21B, the electronic device 2100 may identify food ingredient information stored in the electronic device 2100 on the basis of analysis information of the first user utterance 2112 (for example, “Recommend food recipes that can be made with ingredients in a refrigerator”). The electronic device 2100 may identify parameter information (for example, a food recipe list) on the basis of result information of the second task 2110a (for example, a food recipe list recommended by a food recipe search application or a recommended result API) corresponding to the second user utterance 2111 (“Recommended simple food recipes”) among the first context information received from the first external electronic device 2110. The electronic device 2100 may identify a first food (for example, “kimchi fried rice”) that can be made with ingredients stored in the electronic device 2100 on the basis of parameter information (for example, the food recipe list) included in the first context information. The electronic device 2100 may perform the first task 2120a for providing ingredient information that can be used for the first food among ingredients stored in the electronic device 2100 and a recipe of the first food along with recommendation of the first food (for example, “kimchi fried rice”) on the display 2120.

According to an embodiment, when performing the first task 2120a, the electronic device 2100 may provide a food recipe list including at least one food recipe that can be made through ingredient information stored in the electronic device 2100 on the basis of the analysis information of the first user utterance and the first context information received from the first external electronic device 2110.

According to an embodiment, when performing the first task 2120a, the electronic device 2100 may provide ingredients stored in the electronic device 2100 and a recipe list including at least one food recipe that can be made with the ingredients stored in at least one external electronic device (not shown) on the basis of the analysis information of the first user utterance, the first context information received from the first external electronic device 2110, and second context information including ingredient information received from the at least one external electronic device (not shown) for storing food ingredients. The electronic device may provide divided types of devices (for example, the electronic device and at least one external electronic device) that store ingredients required for each food recipe.

According to various embodiments, when performing the first task corresponding to the first user utterance, the electronic device may perform the first task for providing information on the first external electronic device in addition to information on the electronic device on the basis of first context information received from the first external electronic device. For example, as shown in FIG. 21C, the electronic device 2130 may receive first context information from the first external electronic device 2150 among at least one external electronic device 2150 and 2170 and compare a voice record list of the first external electronic device 2150 corresponding to parameter information in the first context information with a voice record list stored in the electronic device 2130 corresponding to parameter information for the first user utterance 2131. The electronic device 2130 may identify whether there is at least one voice record item that does not exist in the voice record list stored in the electronic device 2130 in the voice record list of the first external electronic device 2150. According to an embodiment, at least one voice record item of the first external electronic device 2150 that does not exist in the voice record list of the electronic device 2130 may include weather information (for example, latest date information) after weather information of voice record files stored in the voice record list of the electronic device 2130. The electronic device 2130 may perform the first task 2113 for providing a voice record list generated by adding at least one voice record item b1, b2, b3, b4, and b5 of the first external electronic device 2150 that does not exist in the voice record list of the electronic device 2130 is added to voice record items a1, a2, a3, a4, a5, a6, a7 of the electronic device. According to an embodiment, when receiving an execution command for a first voice record item provided by the first external electronic device 2150 while the first task 2113 for providing the voice record list is performed, the electronic device 2130 may acquire a first voice record file corresponding to the first voice record item from the first external electronic device 2150 and reproduce the first voice record file. Alternatively, the electronic device 2110 may reproduce the first voice record file corresponding to the first voice record item among at least one voice record file corresponding to the at least one voice record item pre-stored in the electronic device 2110 on the basis of first context information received from the first external electronic device 2150.

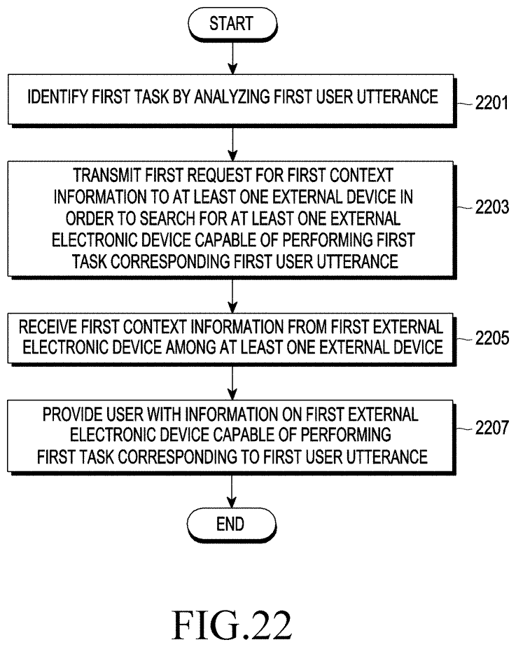

FIG. 22 illustrates a flowchart of a method by which an electronic device (for example, the user terminal 100 of FIG. 1) provides information on an external electronic device for performing a first task corresponding to a first user utterance on the basis of first context information.

In operation 2201, according to various embodiments, after executing an intelligent agent (for example, the intelligent agent 440 of FIG. 4), the electronic device may acquire a first user utterance through a microphone (for example, the microphone 120 and/or the input module of FIG. 1) and analyze the first user utterance to identify a first task.

According to various embodiments, the electronic device may analyze the first user utterance in response to acquisition of the first user utterance. According to an embodiment, the electronic device may identify at least one of the domain, the intent, or the parameter for the first user utterance by analyzing the first user utterance through a natural language platform (for example, the natural language platform 430 of FIG. 4). According to an embodiment, the electronic device may identify the first task corresponding to the first user utterance according to the analysis of the first utterance. For example, the electronic device may analyze the first user utterance (for example, “Cancel an alarm set at 3 o'clock”) so as to identify a domain (for example, an alarm application), and intent (for example, alarm release), and a mandatory parameter (for example, an alarm release time) (3 o'clock) for the first user utterance and identify that attributes of the first user utterance correspond to an independent complete utterance.

In operation 2203, according to various embodiments, the electronic device may transmit a first request for first context information to at least one external electronic device in order to search for the at least one external electronic device capable of performing the first task corresponding to the first user utterance.

According to various embodiments, the electronic device may transmit the first request for the first context information including the domain (for example, the alarm application), the intent (for example, alarm release), and the parameter (for example, the alarm release time (3 o'clock)) for the first user utterance to at least one external electronic device.

In operation 2205, according to various embodiments, the electronic device may receive the first context information from the first external electronic device among at least one external electronic device.

According to various embodiments, the electronic device may receive the first context information including the domain (for example, the alarm application), the intent (for example, alarm release), and the parameter (for example, the alarm release time (3 o′clock)) for the first user utterance (for example, “Cancel an alarm set at 3 o'clock”) from the first external electronic device among at least one external electronic device.

In operation 2207, according to various embodiments, the electronic device may provide the user with information on the first external electronic device capable of performing the first task corresponding to the first user utterance.

According to various embodiments, the electronic device may identify the first external electronic device capable of performing the first task corresponding to the first user utterance on the basis of first context information received from the first external electronic device and inform the user of the presence of the first external electronic device capable of performing the first task corresponding to the first user utterance. According to an embodiment, the electronic device may inquire to the user about whether to perform the first task in the first external electronic device and, when a user utterance indicating execution of the first task in the first external electronic device is acquired and analyzed, transmit information indicating execution of the first task to the first external electronic device.

According to various embodiments, when there is at least one external electronic device having already performed the first task corresponding to the first user utterance, the electronic device may inform the user of the presence of at least one external electronic device having already performed the first task. For example, the electronic device may identify the first task corresponding to the first user utterance (for example, “Set an alarm at 7 a.m. through a waking-up helper”) and transmit a request for first context information including a domain (for example, a waking-up helper application), an intent (for example, alarm setting), and a parameter (for example, an alarm setting time at 7 a.m.) corresponding to the first user utterance to at least one external electronic device. When receiving first context information including the domain (for example, the waking-up helper application), the intent (for example, alarm setting), and the parameter (for example, the alarm setting time at 7 a.m.) corresponding to the first user utterance from the first external electronic device among the at least one external electronic device, the electronic device may inform the user of the presence of the first external electronic device having already performed the first task corresponding to the first user utterance (for example, “Set an alarm at 7 a.m. through a waking-up helper”) on the basis of the first context information.

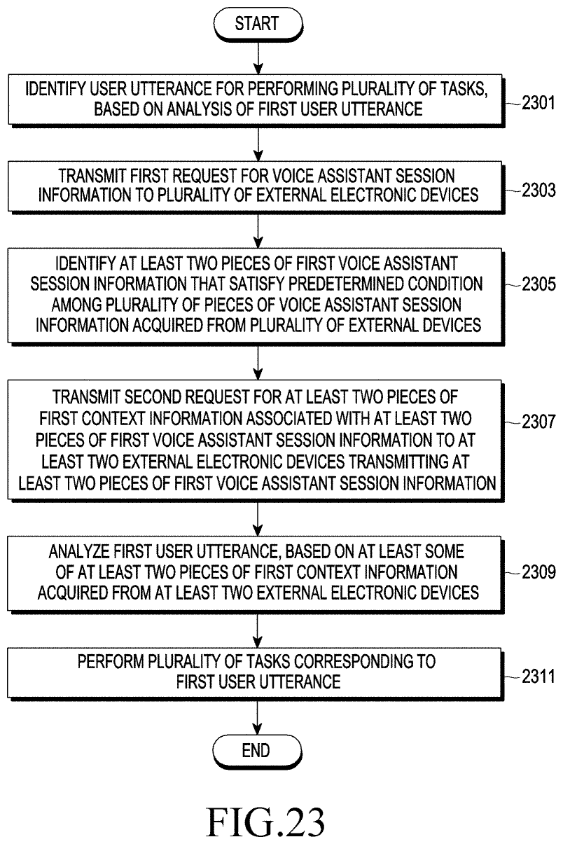

FIG. 23 illustrates a flowchart of a method by which an electronic device (for example, the user terminal 100 of FIG. 1) performs a plurality of tasks corresponding to a first user utterance on the basis of at least two pieces of first context information.

In operation 2301, according to various embodiments, the electronic device may acquire a first user utterance and identify that the first user utterance is an utterance for performing a plurality of tasks on the basis of analysis of the acquired first user utterance.

According to various embodiments, the electronic device may analyze the first user utterance in response to acquisition of the first user utterance. According to an embodiment, the electronic device may identify at least one of the domain, the intent, or the parameter for the first user utterance by analyzing the first user utterance through a natural language platform (for example, the natural language platform 430 of FIG. 4).

According to various embodiments, the electronic device may identify attributes of the first user utterance. According to an embodiment, the electronic device may identify whether the attributes of the first user utterance correspond to an incomplete utterance or a complete utterance on the basis of the analysis result of the first user utterance. According to various embodiments, the electronic device may identify that the attributes of the first user utterance correspond to the incomplete utterance as the analysis result of the first user utterance on the basis of non-identification of at least one of the domain, the intent, or the mandatory parameter for the first user utterance.

According to various embodiments, the electronic device may identify that the first user utterance is a user utterance for performing a plurality of tasks by analyzing the first user utterance. According to an embodiment, when the first user utterance includes a predetermined word expression, the electronic device may identify that the first user utterance is a user utterance for performing a plurality of tasks. For example, as the analysis result of the first user utterance (for example, “How about Busan? and Play a previously found song”), the electronic device may analyze an incomplete first user utterance A (for example, “How about Busan?”) for performing a first task and an incomplete first user utterance B (for example, “Play a previously found song”) for performing a second task on the basis of the predetermined word expression (for example, “and”).

In operation 2303, according to various embodiments, the electronic device may transmit a first request for voice assistant session information to a plurality of external electronic devices through a communication interface (for example, the communication interface 110 of FIG. 1).

In operation 2305, according to various embodiments, the electronic device may identify at least two pieces of first voice assistant session information that satisfy a predetermined condition among a plurality of pieces of voice assistant session information acquired from a plurality of external electronic devices.

According to various embodiments, the electronic device may identify voice assistant session information including final user utterance information corresponding to at least one of the domain, the intent, or the mandatory parameter for the first user utterance as the first voice assistant session information that satisfies the predetermined condition. According to an embodiment, the electronic device may identify voice assistant session information including a final user utterance as first voice assistant session information A that satisfies a predetermined condition on the basis of at least one of the domain, the intent, or the parameter for the first user utterance A of the first user utterance corresponding to at least one of the domain, the intent, or the parameter for the final user utterance. According to an embodiment, the electronic device may identify voice assistant session information including the corresponding final user utterance as first voice assistant session information B that satisfies a predetermined condition on the basis of at least one of the domain, the intent, or the parameter for the first user utterance B of the first user utterance corresponding to at least one of the domain, the intent, or the parameter for the final user utterance. For example, the electronic device may identify first voice assistant information A for the first user utterance A (for example, “How about Busan?”) and first voice assistant session information B for the first user utterance B (for example, “Play a previously found song”) that satisfy a predetermined condition among a plurality of pieces of voice assistant session information acquired from a plurality of external electronic devices.

In operation 2307, according to various embodiments, the electronic device may transmit a second request for at least two pieces of first context information associated with at least two pieces of first voice assistant session information to at least two external electronic devices transmitting the at least two pieces of first voice assistant session information through a communication interface (for example, the communication interface 110 of FIG. 1).

According to various embodiments, the electronic device may transmit a second request for first context information A associated with first voice assistant session information A to the first external electronic device transmitting the first voice assistant session information A that satisfies a predetermined condition and transmit a second request for first context information B associated with first voice assistant session information B to the second external electronic device transmitting the first voice assistant session information B that satisfies a predetermined condition.

In operation 2309, according to various embodiments, the electronic device may analyze the first user utterance on the basis of at least some of at least two pieces of first context information acquired from at least two external electronic devices.

According to various embodiments, the electronic device may identify a first task A corresponding to the first user utterance A of the first user utterance on the basis of first context information A received from the first external electronic device and identify a first task B corresponding to the first user utterance B of the first user utterance on the basis of first context information B received from the second external electronic device. For example, the electronic device may identify the first task A (for example, executing a weather application and outputting weather information in Busan) of the first user utterance (for example, “How about Busan? and play a previously found song”) corresponding to the first user utterance A (for example, “How about Busan?”) on the basis of at least one of the domain (for example, a weather application), an intent (for example, a weather search), and a parameter (for example, information on weather in Seoul today) corresponding to the second user utterance (for example, How is the weather in Seoul today?”) included in the first context information A acquired from the first external electronic device.

For example, the electronic device may identify a first task B (for example, executing a music application and playing a song finally executed by the second external electronic device in a good music list during preparation for work) corresponding to the first user utterance B (for example, “Play a previously found song”) of the first user utterance (for example, “How about Busan? and play a previously found song”) on the basis of at least one of a domain (for example, a music application), and intent (for example, a music search), and a parameter (for example, good songs for preparation for work) corresponding to the second user utterance (for example, “Search for good songs for preparation for work”) included in first context information B acquired from the second external electronic device.

In operation 2311, according to various embodiments, the electronic device may perform a plurality of tasks corresponding to the first user utterance.

According to various embodiments, the electronic device may execute the first task A corresponding to the first user utterance A of the first user utterance on the basis of the first context information A received from the first external electronic device and execute the first task B corresponding to the first user utterance B of the first user utterance on the basis of the first context information B received from the second external electronic device. For example, the electronic device may execute the first task A (for example, executing a weather application and displaying Busan weather information or outputting Busan weather information through an audio signal) corresponding to the first user utterance A (for example, “How about Busan?”) of the first user utterance (for example, “How about Busan? and play a previously found song”) on the basis of the first context information A acquired from the first external electronic device. For example, the electronic device may execute the first task B (for example, executing a music application and playing a song finally executed by the second external electronic device in a good song list for preparation for work) corresponding to the first user utterance B (for example, “Play a previously found song”) on the basis of the first context information B acquired from the second external electronic device.

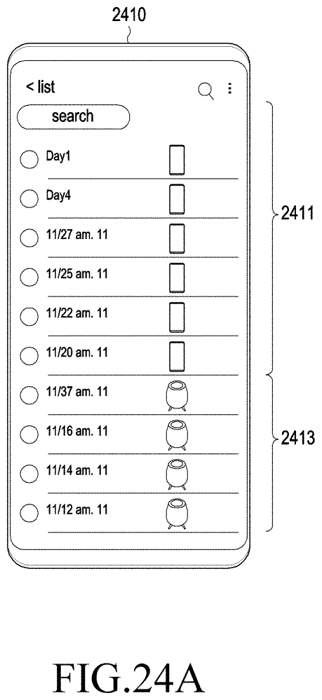

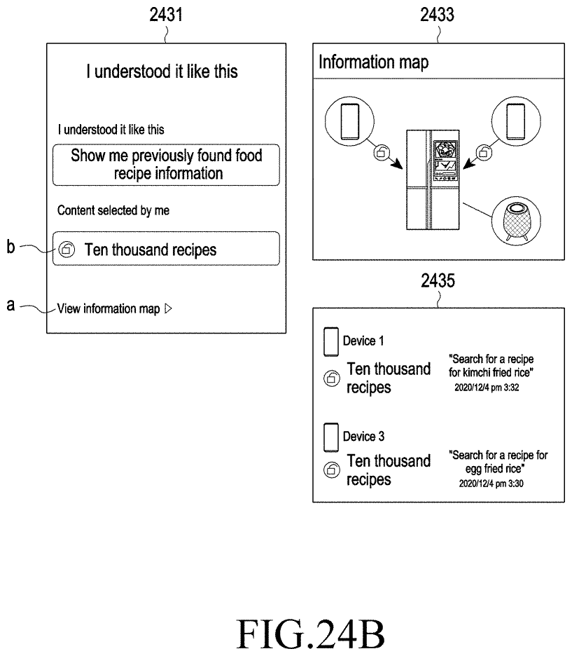

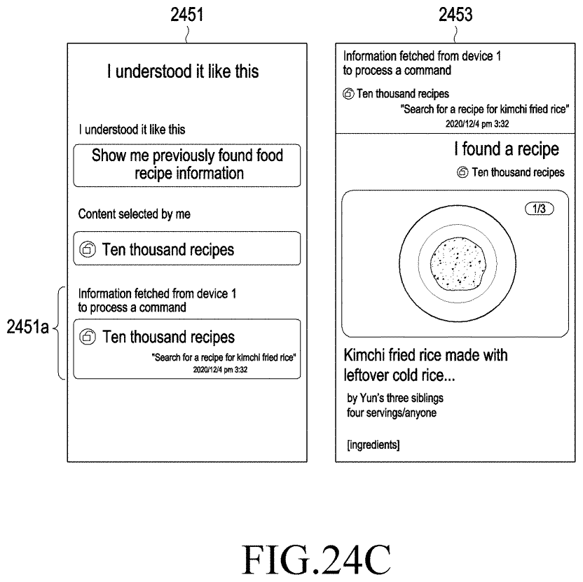

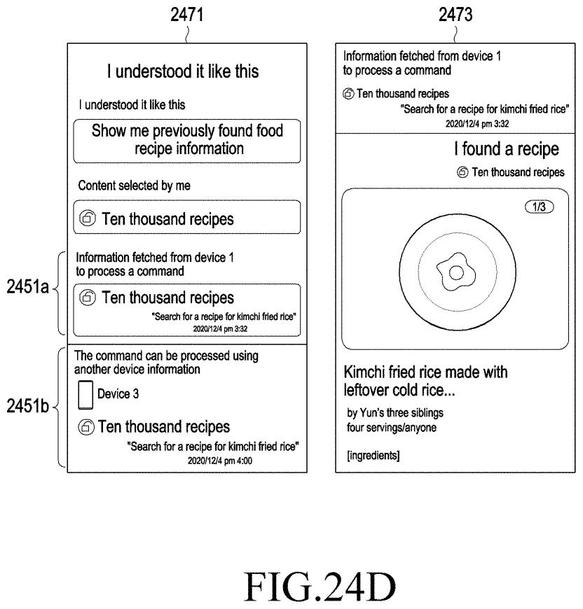

FIG. 24A illustrates an embodiment in which an electronic device (for example, the user terminal 100 of FIG. 1, an electronic device 2410, or/and the processor 160 of FIG. 1) provides divided information received from external electronic devices according to various embodiments, FIG. 24B illustrates an embodiment in which an electronic device (for example, the user terminal 100 of FIG. 1, an electronic device 2410, or/and the processor 160 of FIG. 1) provides divided information received from external electronic devices according to various embodiments, FIG. 24C illustrates an embodiment in which an electronic device (for example, the user terminal 100 of FIG. 1, an electronic device 2410, or/and the processor 160 of FIG. 1) provides divided information received from external electronic devices according to various embodiments, and FIG. 24D illustrates an embodiment in which an electronic device (for example, the user terminal 100 of FIG. 1, an electronic device 2410, or/and the processor 160 of FIG. 1) provides divided information received from external electronic devices according to various embodiments.

Referring to FIG. 24A, according to various embodiments, when displaying the result of a first task corresponding to a first utterance through the display, the electronic device 2410 may separately display information 2411 on the electronic device (for example, a voice record list) and context information 2413 (for example, a voice record list) received from a first external electronic device (for example, the first external electronic device 2130 of FIG. 21B) through a UI. According to an embodiment, when displaying the voice record list through the display of the electronic device 2410, the electronic device 2410 may inform that a task that is the same as the first task is performed (for example, displaying the voice record list) in the first external electronic device before the first task is performed (for example, displaying the voice record list) in the electronic device 2410 as the voice record list is displayed separately from the context information 2413 (for example, the voice record list) received from the first external electronic device. According to an embodiment, the electronic device 2410 may edit (add, change, or/and delete) the order of the voice record list.

Referring to FIG. 24B, according to various embodiments, the electronic device may provide information on the external electronic device making a request for voice assistant session information to execute the first task corresponding to the first user utterance and/or the external electronic device transmitting first context information associated with first voice assistant session information that satisfies a predetermined condition. For example, the electronic device may perform the first task corresponding to the first user utterance (for example, “Show me previously found food recipe information”) and provide a first screen 2413 for displaying result information of the first task on the display. When a first option (a) (for example, viewing an information map) is selected in the first screen 2431, a second screen 2433 for displaying a plurality of external electronic devices (device 1, device 3, and device 4) transmitting voice assistant session information through an information map (context map) may be provided on the display to perform the first task corresponding to the first user utterance. Alternatively, when a second option (b) (for example, ten thousand recipes) is selected in the first screen 2431, a third screen 2432 for displaying at least one external electronic device (device 1 and device 3) transmitting first context information associated with first voice assistant session information that satisfies a predetermined condition among the plurality of external electronic devices and the first context information (for example, “Search for a recipe for kimchi fried rice” and “Search for a recipe of egg fried rice”) may be provided on the display.

Referring to FIG. 24C, according to various embodiments, the electronic device may provide execution of the first task corresponding to the first user utterance through a UI on the basis of first context information of the external electronic device. For example, the electronic device may provide a first item 2451a for displaying information on the external electronic device (for example, device 1) used for performing the first task and first context information (for example, “Search for a recipe for kimchi fried rice”) of the external electronic device through a UI in the first screen 2451 for displaying result information of the first task corresponding to the first user utterance (for example, “Show me previously found food recipe information”). When the first item 2451a is selected in the first screen 2451, a second screen 2453 including result information of the first task performed using the first context information (for example, “Search for a recipe for kimchi fried rice”) may be provided on the display.

Referring to FIG. 24D, according to various embodiments, the electronic device may provide execution of the first task corresponding to the first user utterance through a UI on the basis of the first context information of the external electronic device included in a candidate list. According to an embodiment, the electronic device may provide a candidate list which can be selected by the user to perform the first task, and the candidate list may include a plurality of pieces of first context information from a plurality of external electronic devices. For example, the electronic device may provide a first item 2451a for displaying information on the external electronic device (for example, device 1) used for performing the first task and first context information (for example, “Search for a recipe for kimchi fried rice”) of the external electronic device through a UI in the first screen 2471 for displaying result information of the first task corresponding to the first user utterance (for example, “Show me previously found food recipe information”) and a second item 2451b for displaying information on a candidate external electronic device (for example, device 3) for providing candidate context information that has not been used for performing the first task but has the next priority from the first context information and candidate context information (for example, “Search for a recipe of egg fried rice”) through a UI. When the second item 2451b is selected in the first screen 2471, the first task may be performed using the candidate context information, and the second screen 2473 including result information of the first task performed using the candidate context information of the candidate external electronic device (for example, “Search for a recipe of egg fried rice”) may be provided on the display.

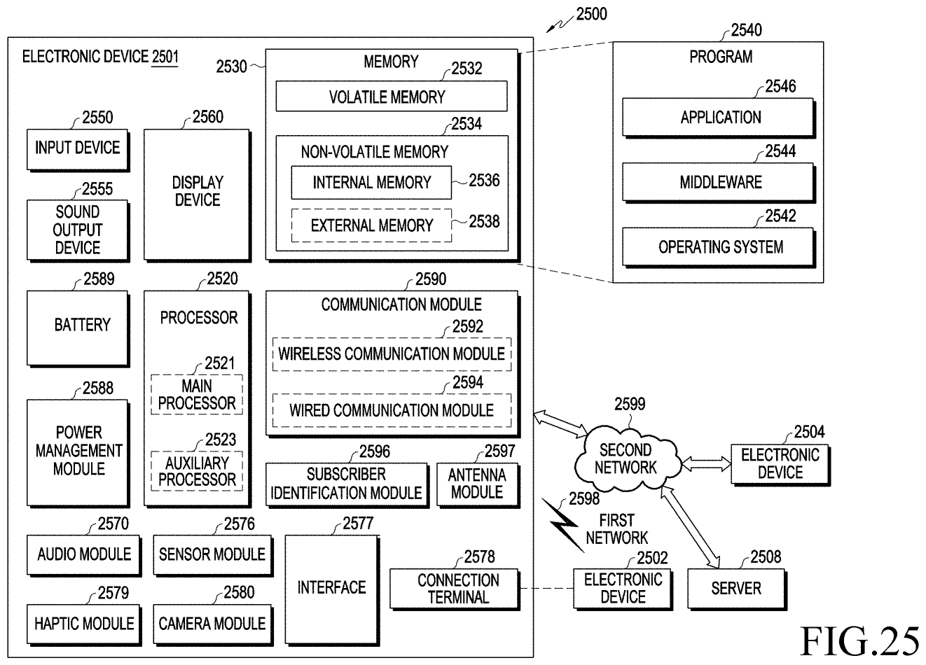

FIG. 25 is a block diagram illustrating an electronic device 2501 (e.g., the user terminal 100 of FIG. 1) in a network environment 2500 according to various embodiments. Referring to FIG. 25, the electronic device 2501 in the network environment 2500 may communicate with an electronic device 2502 via a first network 2598 (e.g., a short-range wireless communication network), or an electronic device 2504 or a server 2508 via a second network 2599 (e.g., a long-range wireless communication network). According to an embodiment, the electronic device 2501 may communicate with the electronic device 2504 via the server 2508. According to an embodiment, the electronic device 2501 may include a processor 2520, memory 2530, an input device 2550, a sound output device 2555, a display device 2560, an audio module 2570, a sensor module 2576, an interface 2577, a haptic module 2579, a camera module 2580, a power management module 2588, a battery 2589, a communication module 2590, a subscriber identification module (SIM) 2596, or an antenna module 2597. In some embodiments, at least one (e.g., the display device 2560 or the camera module 2580) of the components may be omitted from the electronic device 2501, or one or more other components may be added in the electronic device 2501. In some embodiments, some of the components may be implemented as single integrated circuitry. For example, the sensor module 2576 (e.g., a fingerprint sensor, an iris sensor, or an illuminance sensor) may be implemented as embedded in the display device 2560 (e.g., a display).

The processor 2520 may execute, for example, software (e.g., a program 2540) to control at least one other component (e.g., a hardware or software component) of the electronic device 2501 coupled with the processor 2520, and may perform various data processing or computation. According to one embodiment, as at least part of the data processing or computation, the processor 2520 may load a command or data received from another component (e.g., the sensor module 2576 or the communication module 2590) in volatile memory 2532, process the command or the data stored in the volatile memory 2532, and store resulting data in non-volatile memory 2534. According to an embodiment, the processor 2520 may include a main processor 2521 (e.g., a central processing unit (CPU) or an application processor (AP)), and an auxiliary processor 2523 (e.g., a graphics processing unit (GPU), an image signal processor (ISP), a sensor hub processor, or a communication processor (CP)) that is operable independently from, or in conjunction with, the main processor 2521. Additionally or alternatively, the auxiliary processor 2523 may be adapted to consume less power than the main processor 2521, or to be specific to a specified function. The auxiliary processor 2523 may be implemented as separate from, or as part of the main processor 2521.

The auxiliary processor 2523 may control, for example, at least some of functions or states related to at least one component (e.g., the display device 2560, the sensor module 2576, or the communication module 2590) among the components of the electronic device 2501, instead of the main processor 2521 while the main processor 2521 is in an inactive (e.g., sleep) state, or together with the main processor 2521 while the main processor 2521 is in an active (e.g., executing an application) state. According to an embodiment, the auxiliary processor 2523 (e.g., an image signal processor or a communication processor) may be implemented as part of another component (e.g., the camera module 2580 or the communication module 2590) functionally related to the auxiliary processor 2523.

The memory 2530 may store various data used by at least one component (e.g., the processor 2520 or the sensor module 2576) of the electronic device 2501. The various data may include, for example, software (e.g., the program 2540) and input data or output data for a command related thereto. The memory 2530 may include the volatile memory 2532 or the non-volatile memory 2534.

The program 2540 may be stored in the memory 2530 as software, and may include, for example, an operating system (OS) 2542, middleware 2544, or an application 2546.

The input device 2550 may receive a command or data to be used by other component (e.g., the processor 2520) of the electronic device 2501, from the outside (e.g., a user) of the electronic device 1012501. The input device 2550 may include, for example, a microphone, a mouse, a keyboard, or a digital pen (e.g., a stylus pen).

The sound output device 2555 may output sound signals to the outside of the electronic device 2501. The sound output device 2555 may include, for example, a speaker or a receiver. The speaker may be used for general purposes, such as playing multimedia or playing record, and the receiver may be used for incoming calls. According to an embodiment, the receiver may be implemented as separate from, or as part of the speaker.

The display device 2560 may visually provide information to the outside (e.g., a user) of the electronic device 2501. The display device 2560 may include, for example, a display, a hologram device, or a projector and control circuitry to control a corresponding one of the display, hologram device, and projector. According to an embodiment, the display device 2560 may include touch circuitry adapted to detect a touch, or sensor circuitry (e.g., a pressure sensor) adapted to measure the intensity of force incurred by the touch.

The audio module 2570 may convert a sound into an electrical signal and vice versa. According to an embodiment, the audio module 2570 may obtain the sound via the input device 2550, or output the sound via the sound output device 2555 or an external electronic device (e.g., an electronic device 2502 (e.g., a speaker or a headphone)) directly or wirelessly coupled with the electronic device 2501.

The sensor module 2576 may detect an operational state (e.g., power or temperature) of the electronic device 2501 or an environmental state (e.g., a state of a user) external to the electronic device #01, and then generate an electrical signal or data value corresponding to the detected state. According to an embodiment, the sensor module 2576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2577 may support one or more specified protocols to be used for the electronic device 2501 to be coupled with the external electronic device (e.g., the electronic device 2502) directly or wirelessly. According to an embodiment, the interface 2577 may include, for example, a high definition multimedia interface (HDMI), a universal serial bus (USB) interface, a secure digital (SD) card interface, or an audio interface.

A connecting terminal 2578 may include a connector via which the electronic device 2501 may be physically connected with the external electronic device (e.g., the electronic device 2502). According to an embodiment, the connecting terminal 2578 may include, for example, a HDMI connector, a USB connector, a SD card connector, or an audio connector (e.g., a headphone connector).

The haptic module 2579 may convert an electrical signal into a mechanical stimulus (e.g., a vibration or a movement) or electrical stimulus which may be recognized by a user via his tactile sensation or kinesthetic sensation. According to an embodiment, the haptic module 2579 may include, for example, a motor, a piezoelectric element, or an electric stimulator.

The camera module 2580 may capture a still image or moving images. According to an embodiment, the camera module 2580 may include one or more lenses, image sensors, image signal processors, or flashes.

The power management module 2588 may manage power supplied to the electronic device 2501. According to one embodiment, the power management module 2588 may be implemented as at least part of, for example, a power management integrated circuit (PMIC).

The battery 2589 may supply power to at least one component of the electronic device 2501. According to an embodiment, the battery 2589 may include, for example, a primary cell which is not rechargeable, a secondary cell which is rechargeable, or a fuel cell.

The communication module 2590 may support establishing a direct (e.g., wired) communication channel or a wireless communication channel between the electronic device 2501 and the external electronic device (e.g., the electronic device 2502, the electronic device 2504, or the server 2508) and performing communication via the established communication channel. The communication module 2590 may include one or more communication processors that are operable independently from the processor 2520 (e.g., the application processor (AP)) and supports a direct (e.g., wired) communication or a wireless communication. According to an embodiment, the communication module 2590 may include a wireless communication module 2592 (e.g., a cellular communication module, a short-range wireless communication module, or a global navigation satellite system (GNSS) communication module) or a wired communication module 2594 (e.g., a local area network (LAN) communication module or a power line communication (PLC) module). A corresponding one of these communication modules may communicate with the external electronic device via the first network 2598 (e.g., a short-range communication network, such as BLUETOOTH, wireless-fidelity (Wi-Fi) direct, or infrared data association (IrDA)) or the second network 2599 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 2592 may identify and authenticate the electronic device 2501 in a communication network, such as the first network 2598 or the second network 2599, using subscriber information (e.g., international mobile subscriber identity (IMSI)) stored in the subscriber identification module 2596.

The antenna module 2597 may transmit or receive a signal or power to or from the outside (e.g., the external electronic device) of the electronic device 2501. According to an embodiment, the antenna module may include an antenna including a radiating element composed of a conductive material or a conductive pattern formed in or on a substrate (e.g., PCB). According to an embodiment, the antenna module 2597 may include a plurality of antennas. In such a case, at least one antenna appropriate for a communication scheme used in the communication network, such as the first network 2598 or the second network 2599, may be selected, for example, by the communication module 2590 from the plurality of antennas. The signal or the power may then be transmitted or received between the communication module 2590 and the external electronic device via the selected at least one antenna. According to an embodiment, another component (e.g., a radio frequency integrated circuit (RFIC)) other than the radiating element may be additionally formed as part of the antenna module 2597.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 2501 and the external electronic device 2504 via the server 2508 coupled with the second network 2599. Each of the electronic devices 2502 and 2504 may be a device of a same type as, or a different type, from the electronic device 2501. According to an embodiment, all or some of operations to be executed at the electronic device 2501 may be executed at one or more of the external electronic devices 2502, 2504, or 2508. For example, if the electronic device 2501 should perform a function or a service automatically, or in response to a request from a user or another device, the electronic device 2501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 2501. The electronic device 2501 may provide the outcome, with or without further processing of the outcome, as at least part of a reply to the request. To that end, a cloud computing, distributed computing, or client-server computing technology may be used, for example.

According to various embodiments, an electronic device (for example, the user terminal 100 of FIG. 1) for analyzing a user utterance may include a microphone 120, a display 140, a communication interface 110, a processor 160 operatively connected to the microphone 120 and the communication interface 110, and a memory 150 operatively connected to the processor 160, wherein the memory 150 may store instructions configured to cause the processor 160 to, when executed, acquire a first user utterance through the microphone 120, identify a first task, based on analysis information of the first user utterance, transmit a first request for first context information to at least one external electronic device through the communication interface 110, and perform the first task, based on the first context information acquired from a first external electronic device among the at least one external electronic device and the analysis information of the first user utterance.

According to various embodiments, the instructions are configured to cause the processor to identify first information associated with the analysis information of the first user utterance in the first context information acquired from the first external electronic device and perform the first task, based on the analysis information of the first user utterance and the first information.

According to various embodiments, the instructions are configured to cause the processor to perform the first task by combining the analysis information of the first user utterance and the first context information acquired from the first external electronic device.

According to various embodiments, the instructions are configured to cause the processor to, when the first context information is not included in the analysis information of the first user utterance, based on a result of the comparison between the analysis information of the first user utterance and the first context information, perform the first task by adding the first context information to the analysis information of the first user utterance and display the analysis information of the first user utterance separately from the first context information on the display while the first task is performed.

According to various embodiments, the instructions are configured to cause the processor to identify that the first external electronic device is capable of performing the first task, based on the first context information acquired from the first external electronic device and provide information on the first external electronic device capable of performing the first task.

According to various embodiments, the instructions are configured to cause the processor to display, on the display, an information map for at least one external electronic device that is capable of providing context information to the electronic device and connected to the electronic device through communication.

According to various embodiments, the first context information acquired from the first external electronic device may include second context history information of a second user utterance processed by the first external electronic device or information on a result of a second task corresponding to the second user utterance.

According to various embodiments, the instructions are configured to cause the processor to receive the first context information of the first external electronic device including at least one of a domain, an intent, or a mandatory parameter for the first user utterance of the at least one external electronic device through the communication interface.

According to various embodiments, the at least one external electronic device may include at least one of an external electronic device establishing a short-range wireless communication connection with the electronic device or an external electronic device associated with a user account of the electronic device.

According to various embodiments, the instructions are configured to cause the processor to generate second context information, based on a result of the first task corresponding to the first user utterance and transmit the second context information to a second external electronic device through the communication interface, based on acquisition of a second request for the second context information from the second external electronic device.

According to various embodiments, a method of processing a user utterance by an electronic device may include an operation of acquiring a first user utterance through a microphone 120, an operation of identifying a first task, based on analysis information of the first user utterance, an operation of transmitting a first request for first context information to at least one external electronic device through the communication interface 110, and an operation of performing the first task, based on the first context information acquired from a first external electronic device among the at least one external electronic device and the analysis information of the first user utterance.

According to various embodiments, the operation of performing the first task may include an operation of identifying first information associated with the analysis information of the first user utterance in the first context information acquired from the first external electronic device and an operation of performing the first task, based on the analysis information of the first user utterance and the first information.

According to various embodiments, the operation of performing the first task may include an operation of performing the first task by combining the analysis information of the first user utterance and the first context information acquired from the first external electronic device.

According to various embodiments, the method may further include an operation of, when the first context information is not included in the analysis information of the first user utterance, based on a result of the comparison between the analysis information of the first user utterance and the first context information, performing the first task by adding the first context information to the analysis information of the first user utterance and an operation of displaying the analysis information of the first user utterance separately from the first context information while the first task is performed.

According to various embodiments, the method may further include an operation of identifying that the first external electronic device is capable of performing the first task, based on the first context information acquired from the first external electronic device and an operation of providing information on the first external electronic device capable of performing the first task.

According to various embodiments, the method may further include an operation of displaying an information map for at least one external electronic device that is capable of providing context information to the electronic device and connected to the electronic device through communication.

According to various embodiments, the first context information acquired from the first external electronic device may include second context history information of a second user utterance processed by the first external electronic device or information on a result of a second task corresponding to the second user utterance.

According to various embodiments, the first context information of the first external electronic device including at least one of a domain, an intent, or a mandatory parameter for the first user utterance of the at least one external electronic device may be received through the communication interface.

According to various embodiments, the at least one external electronic device may include at least one of an external electronic device establishing a short-range wireless communication connection with the electronic device or an external electronic device associated with a user account of the electronic device.

According to various embodiments, the method may further include an operation of generating second context information, based on a result of the first task corresponding to the first user utterance and an operation of transmitting the second context information to a second external electronic device through the communication interface, based on acquisition of a second request for the second context information from the second external electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element. As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 2540) including one or more instructions that are stored in a storage medium (e.g., internal memory 2536 or external memory 2538) that is readable by a machine (e.g., the electronic device 2501). For example, a processor (e.g., the processor 160) of the machine (e.g., the electronic device 2501) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PLAYSTORE), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

A method of processing a user utterance according to the disclosure is a method of recognizing a user voice and analyzing an intent in order to prevent an operation by a voice output from a media device, and may receive a voice signal corresponding to an analog signal through, for example, a microphone and convert a voice part into computer-readable text through an Automatic Speech Recognition (ASR) model. An intent of the user utterance may be acquired by analyzing text converted using a Natural Language Understanding (NLU) model. The ASR model or the NLU model may be an artificial intelligence model. The intelligence model may be processed by an artificial intelligence-dedicated processor designated in a hardware structure specified for processing the artificial intelligence model. The artificial intelligence model may be made through learning. Being made through learning means that a predefined operation rule or an artificial intelligence model configured to perform a desired characteristic (or purpose) is made through learning using a plurality of pieces of learning data on the basis of a learning algorithm. The artificial intelligence model may include a plurality of neural network layers. Each of the plurality of neural network layers has a plurality of weight values and performs a neural network operation through the operation result of a previous layer and an operation between the plurality of weight values.

Linguistic understanding is a technology for recognizing and applying/processing a human language/character and includes natural language processing, machine translation, dialogue system, question and answering, and speech recognition/synthesis.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device for analyzing a user utterance, the electronic device comprising:
a microphone;
a display;
a communication interface;
a processor operatively connected to the microphone and the communication interface; and
a memory operatively connected to the processor and configured to store instructions,
wherein the processor is configured to:
acquire a first user utterance through the microphone,
identify a first task, based on analysis information of the first user utterance,
transmit a first request for first context information to at least one external electronic device through the communication interface, and
perform the first task, based on the first context information acquired from a first external electronic device among the at least one external electronic device and the analysis information of the first user utterance.

2. The electronic device of claim 1, wherein the processor is further configured to:
identify first information associated with the analysis information of the first user utterance in the first context information acquired from the first external electronic device; and
perform the first task, based on the analysis information of the first user utterance and the first information.

3. The electronic device of claim 1, wherein the processor is further configured to perform the first task by combining the analysis information of the first user utterance and the first context information acquired from the first external electronic device.

4. The electronic device of claim 3, wherein the processor is further configured to:
when the first context information is not included in the analysis information of the first user utterance, based on a result of the comparison between the analysis information of the first user utterance and the first context information, perform the first task by adding the first context information to the analysis information of the first user utterance; and
display the analysis information of the first user utterance separately from the first context information on the display while the first task is performed.

5. The electronic device of claim 1, wherein the processor is further configured to:
identify that the first external electronic device is capable of performing the first task, based on the first context information acquired from the first external electronic device; and
provide information on the first external electronic device capable of performing the first task.

6. The electronic device of claim 1, wherein the processor is further configured to display, on the display, an information map for at least one external electronic device that is capable of providing context information to the electronic device and connected to the electronic device through communication.

7. The electronic device of claim 1, wherein the first context information acquired from the first external electronic device includes:
second context history information of a second user utterance processed by the first external electronic device, or
information on a result of a second task corresponding to the second user utterance.

8. The electronic device of claim 1, wherein the processor is further configured to receive the first context information of the first external electronic device including at least one of a domain, an intent, or a mandatory parameter for the first user utterance of the at least one external electronic device through the communication interface.

9. The electronic device of claim 1, wherein the at least one external electronic device includes at least one of:
an external electronic device that is connected via a short-range wireless communication connection with the electronic device, or
an external electronic device associated with a user account of the electronic device.

10. The electronic device of claim 1, wherein the processor is further configured to:
generate second context information, based on a result of the first task corresponding to the first user utterance; and
transmit the second context information to a second external electronic device through the communication interface, based on acquisition of a second request for the second context information from the second external electronic device.

11. A method of processing a user utterance by an electronic device, the method comprising:
acquiring a first user utterance through a microphone;
identifying a first task, based on analysis information of the first user utterance;
transmitting a first request for first context information to at least one external electronic device through a communication interface; and
performing the first task, based on the first context information acquired from a first external electronic device among the at least one external electronic device and the analysis information of the first user utterance.

12. The method of claim 11, wherein the performing of the first task comprises:
identifying first information associated with the analysis information of the first user utterance in the first context information acquired from the first external electronic device; and
performing the first task, based on the analysis information of the first user utterance and the first information.

13. The method of claim 11, wherein the performing of the first task comprises performing the first task by combining the analysis information of the first user utterance and the first context information acquired from the first external electronic device.

14. The method of claim 13, further comprising:
when the first context information is not included in the analysis information of the first user utterance, based on a result of the comparison between the analysis information of the first user utterance and the first context information, performing the first task by adding the first context information to the analysis information of the first user utterance; and
displaying, on a display of the electronic device, the analysis information of the first user utterance separately from the first context information while the first task is performed.

15. The method of claim 11, further comprising:
identifying that the first external electronic device is capable of performing the first task, based on the first context information acquired from the first external electronic device; and
providing information on the first external electronic device capable of performing the first task.

16. The method of claim 11, further comprising displaying an information map for at least one external electronic device that is capable of providing context information to the electronic device and connected to the electronic device through communication.

17. The method of claim 11, wherein the first context information acquired from the first external electronic device includes:
second context history information of a second user utterance processed by the first external electronic device, or
information on a result of a second task corresponding to the second user utterance.

18. The method of claim 11, wherein the first context information of the first external electronic device including at least one of a domain, an intent, or a mandatory parameter for the first user utterance of the at least one external electronic device is received through the communication interface.

19. The method of claim 11, wherein the at least one external electronic device includes at least one of:
an external electronic device that is connected via a short-range wireless communication connection with the electronic device, or
an external electronic device associated with a user account of the electronic device.

20. The method of claim 11, further comprising:
generating second context information, based on a result of the first task corresponding to the first user utterance; and
transmitting the second context information to a second external electronic device through the communication interface of the electronic device, based on acquisition of a second request for the second context information from the second external electronic device.
